(19) United States
(12) Patent Application Publication
(10) Pub. No.: US 2026/0366370 A1
(43) Pub. Date: Nov. 19, 2026

(54) SOLAR-POWERED COVERING SYSTEM

(71) Applicant: Lutron Technology Company LLC, Coopersburg, PA (US)

(72) Inventor: Ben Matzke, Doylestown, PA (US)

(73) Assignee: Lutron Technology Company LLC, Coopersburg, PA (US)

(21) Appl. No.: 19/679,658

(22) Filed: May 16, 2026

Related U.S. Application Data
(60) Provisional application No. 63/807,374, filed on May 16, 2025.
(60) Provisional application No. 63/839,912, filed on Jul. 7, 2025.
(60) Provisional application No. 63/961,646, filed on Jan. 16, 2026.

(51) Int. Cl. E06B 9/42; E06B 9/24; E06B 9/72; H02S 20/30

(52) U.S. Cl. CPC E06B 9/42; E06B 9/72; H02S 20/30; E06B 2009/2476

(57) ABSTRACT

A bottom bar for a covering system may include a covering material. The bottom bar may include a housing that includes a first housing portion configured to be attached to the covering material and a second housing portion configured to be attached to the first housing portion. The bottom bar may include one or more solar cell modules that each include one or more solar cells mounted to a substrate. The one or more solar cell modules may be configured to be supported by the second housing portion. The bottom bar may include one or more energy storage elements that are configured to be supported by the second housing portion. The second housing portion may be configured to be detached from the first housing portion while supporting the one or more solar cell modules and the one or more energy storage elements.

### CROSS-REFERENCE TO RELATED APPLICATIONS

This application claims the benefit of Provisional U.S. Patent Application No. 63/807,374, filed May 16, 2025, and Provisional U.S. Patent Application No. 63/839,912, filed Jul. 7, 2025, and Provisional U.S. Patent Application No. 63/961,646, filed Jan. 16, 2026, the entire disclosures of which are hereby incorporated by reference herein in their entireties.

### BACKGROUND

A user environment, such as a residence or an office building for example, may be configured using various types of load control systems. A lighting control system may be used to control the lighting loads in the user environment. A motorized window treatment control system may be used to control the natural light provided to the user environment. A heating, ventilation, and cooling (HVAC) system may be used to control the temperature in the user environment. Each load control system may include various control devices, including control-source devices and control-target devices. The control-target devices may receive messages (e.g., digital messages), which may include load control instructions, for controlling an electrical load from one or more of the control-source devices. The control-target devices may be capable of directly controlling an electrical load. The control-source devices may be capable of indirectly controlling the electrical load via the control-target device. Examples of control-target devices may include lighting control devices (e.g., a dimmer switch, an electronic switch, a ballast, or a light-emitting diode (LED) driver), a motorized window treatment, a temperature control device (e.g., a thermostat), a plug-in load control device, and/or the like. Examples of control-source devices may include remote control devices, occupancy sensors, daylight sensors, temperature sensors, and/or the like.

A window treatment may be mounted in front of one or more windows, for example to prevent sunlight from entering a space and/or to provide privacy. Window treatments may include, for example, roller shades, roman shades, venetian blinds, or draperies. A roller shade may include a flexible shade fabric wound onto an elongated roller tube. Such a roller shade may include a weighted hembar located at a lower end of the shade fabric. The hembar may cause the shade fabric to hang in front of one or more windows over which the roller shade is mounted.

A window treatment may be mounted to a structure surrounding a window, such as a window frame. Such a window treatment may include at least one bracket, for example two brackets at opposing ends thereof. The brackets may be configured to operably support a roller tube, such that the flexible material may be raised and lowered. For example, the brackets may be configured to support respective ends of the roller tube. The brackets may be attached to a structure, such as a wall, ceiling, window frame, or other structure. Such a window treatment may be motorized.

### SUMMARY

In one example, a covering system (e.g., such as a motorized window treatment) may be configured to be mounted to a structure. The covering system may include first and second mounting brackets configured to be mounted to the structure. The covering system may include a covering assembly supported by the first and second mounting brackets. The covering assembly may include a covering material that extends from a top end to a bottom end and is operable between a docked position and a lowered position. The covering assembly may include a bottom bar comprising a main housing element attached to the bottom end of the covering material and a bottom bar module removably attached to the main housing element. The bottom bar module may include one or more solar cells and one or more first energy storage elements configured to be charged from the one or more solar cells.

A covering system may comprise a covering assembly comprising a covering material that may extend from a top end to a bottom end. The covering assembly may comprise a bottom bar comprising a main housing element attached to the bottom end of the covering material and attached to a bottom bar module. The bottom bar module may be configured to be removably detached from the main housing element. The bottom bar module may comprise one or more solar cells and one or more first energy storage elements configured to be charged from the one or more solar cells. The covering system may comprise a motor drive unit comprising a motor configured to adjust the covering material. The covering system may comprise one or more second energy storage elements for powering the motor. The covering system may comprise a dock comprising a base portion electrically coupled to the one or more second energy storage elements.

The bottom bar may be configured to be positioned adjacent to the base portion of the dock when the bottom bar may be in a docked position, such that the one or more first energy storage elements may discharge through the base portion of the dock into the one or more second energy storage elements.

The bottom bar module may comprise a support element to support the one or more solar cells and the one or more first energy storage elements. The bottom bar module may comprise a printed circuit board assembly comprising a printed circuit board that may be supported by the support element. The one or more solar cells may be electrically coupled to the printed circuit board via two or more first electrical conductors. The one or more first energy storage elements may be electrically coupled to the printed circuit board via two or more second electrical conductors.

The bottom bar module may comprise at least one solar cell module comprising at least a portion of the one or more solar cells mounted to a respective substrate. The support element of the bottom bar module may comprise a recess in which the at least one solar cell module and the printed circuit board may be received.

The support element of the bottom bar module may comprise an upper rear wall above the recess and a lower rear wall below the recess. The support element may comprise an upper flange extending from the upper rear wall into the recess and a lower flange extending from the lower rear wall into the recess. The upper and lower flanges may retain the at least one solar cell module within the recess.

The support element of the bottom bar module may define a gap between the upper and lower flanges. The one or more solar cells may be located within the gap between the upper and lower flanges.

The recess may extend from a first end to a second end of the support element. The support element may comprise one or more ribs extending along a rear wall of the recess from the first end to the second end of the support element. The one or more ribs may define grooves within the recess for receiving the two or more first electrical conductors connected between the one or more solar cells and the printed circuit board. The one or more ribs may allow the support element to flex for widening the gap to allow the at least one solar cell module to be removed from the recess through the gap. The support element may comprise a cavity that may be oriented parallel to the recess and may receive the one or more first energy storage elements.

The printed circuit board assembly may comprise two or more first electrical contacts that may be arranged on the printed circuit board and may be configured to be electrically connected to respective second electrical contacts of the dock when the bottom bar may be in the docked position. The printed circuit board assembly may comprise a charging circuit mounted to the printed circuit board and electrically coupled between the two or more first electrical contacts and the one or more first energy storage elements.

The printed circuit board assembly may comprise a solar cell management circuit mounted to the printed circuit board and electrically coupled between the one or more solar cells and the one or more first energy storage elements. The solar cell management circuit may be configured to charge the one or more first energy storage elements from the one or more solar cells.

The main housing element may comprise a first housing portion attached to the covering material. The support element may comprise a second housing portion. The second housing portion may be attached to the first housing portion.

The covering system may comprise first and second covers for housing the printed circuit board. The first cover may be received in a recess of the second housing portion. The second cover may be coupled to the second housing portion with the printed circuit board captured between the first and second covers. The second housing portion may comprise first and second attachment members that may extend from the second housing portion and that may have first and second channels, respectively. The second cover may be received in the first and second channels of the respective first and second attachment members.

The second cover may comprise a first projection that may extend from an upper wall of the second cover and may be received in the first channel of the first attachment member. The second cover may comprise a second projection that may extend from a lower wall of the second cover and may be received in the second channel of the second attachment member.

The second housing portion may comprise an interior wall within the recess. The interior wall may define one or more cutouts through which electrical conductors between at least one solar cell module and the printed circuit board may extend. The at least one solar cell module may comprise the one or more solar cells.

The second cover may be secured to the first cover via a fastener received through an opening in the second cover, an opening in the printed circuit board, and an opening in the first cover. The fastener may also extend through at least one of the cutouts in the interior wall of the second housing portion.

The printed circuit board assembly may comprise two or more electrical contacts arranged on an outer surface of the printed circuit board. The electrical contacts may comprise respective arms that may extend through respective openings in the first cover. The electrical contacts may also extend through at least one of the cutouts in the interior wall of the second housing portion.

The second attachment member may comprise a support arm that may contact an inner surface of the printed circuit board. The first and second attachment members may engage with the first housing portion for coupling the second housing portion to the first housing portion. The first cover may comprise one or more ribs that may contact an outer surface of the printed circuit board. The second cover may comprise one or more ribs that may contact an inner surface of the printed circuit board. The bottom bar module may comprise a third housing portion attached to the first housing portion. The printed circuit board of the printed circuit board assembly may be supported by the third housing portion.

The covering system may comprise a first end cap connected to a first end of the bottom bar and a second end cap connected to a second end of the bottom bar. The third housing portion may be located between the first end cap and the second housing portion. The second housing portion may comprise a releasable attachment structure that may be configured to detach the second housing portion from the first housing portion when actuated. The second housing portion may comprise a catch that may be located at an upper end of the second housing portion and that may attach to a lip at an upper end of the first housing portion. The releasable attachment structure may be located at a lower end of the second housing portion.

The releasable attachment structure may comprise a clip attached to a lower rear wall of the second housing portion. The clip may engage an indentation of the first housing portion to attach the second housing portion to the first housing portion.

The clip may comprise a wedge portion received in the indentation of the first housing portion when the second housing portion may be attached to the first housing portion. The clip may comprise an actuation portion configured to, when actuated by a user, cause the lower rear wall of the second housing portion to flex and the wedge portion of the clip to be removed from the indentation of the first housing portion, such that the second housing portion may be detached from the first housing portion.

The lip of the first housing portion may be a rear lip. The first housing portion may comprise a front lip and a slot. The slot may receive the covering material. The front and rear lips may be located on both sides of the slot. The releasable attachment structure may comprise first and second attachment members that may extend from the second housing portion and may engage with the first housing portion for coupling the second housing portion to the first housing portion.

The first attachment member may comprise a spring arm received in and engaged with a first channel of the first housing portion. The second attachment member may comprise an engagement portion received in and engaged with a second channel of the first housing portion for attaching the second housing portion to the first housing portion. The second housing portion may comprise an actuation portion configured to, when actuated by a user, cause the spring arm of the first attachment member of the second housing portion to flex and the engagement portion of the second attachment member to be removed from the second channel of the first housing portion, such that the second housing portion may be detached from the first housing portion.

The support element of the bottom bar module may comprise a releasable attachment structure that may be configured to detach the support element from the main housing element when actuated. The support element of the bottom bar module may comprise a catch that may be located at an upper end of the support element and that may attach to a lip at an upper end of the main housing element. The releasable attachment structure may be located at a lower end of the support element. The releasable attachment structure may comprise a clip attached to a lower rear wall of the support element of the bottom bar module. The clip may engage an indentation of the main housing element to attach the support element to the main housing element. The clip may comprise a wedge portion received in the indentation of the main housing element when the support element may be attached to the main housing element. The clip may comprise an actuation portion configured to, when actuated by a user, cause the lower rear wall of the support element to flex and the wedge portion of the clip to be removed from the indentation of the main housing element, such that the support element may detach from the main housing element.

The lip of the main housing element may be a rear lip. The main housing element may comprise a front lip and a slot. The slot may receive the covering material. The front and rear lips may be located on both sides of the slot. The main housing element may comprise a first housing portion of the bottom bar and the support element may comprise a second housing portion of the bottom bar. The first housing portion may be attached to the second housing portion to form a housing of the bottom bar. The one or more solar cells may be supported by the support element of the bottom bar module such that the one or more solar cells may be oriented at an angle from a vertical axis of the covering system.

The covering assembly may comprise a roller tube that may extend from a first end to a second end. The roller tube may be rotatably supported by a first mounting bracket at the first end of the roller tube and by a second mounting bracket at the second end of the roller tube. The top end of the covering material may be attached to the roller tube and the bottom end of the covering material may be attached to the bottom bar. The motor drive unit may be received in the roller tube at the second end of the roller tube and may be supported by the first mounting bracket. The motor drive unit may be configured to rotate the roller tube to adjust the covering material.

When the bottom bar module may be detached from the main housing element, the main housing element may remain attached to the covering material. The bottom bar module may comprise a printed circuit board assembly comprising a printed circuit board. The printed circuit board assembly may comprise two or more first electrical contacts that may be arranged on the printed circuit board and may be configured to be electrically connected to respective second electrical contacts of the dock when the bottom bar may be in the docked position. The two or more first electrical contacts may be accessible at a surface of the bottom bar. The two or more first electrical contacts may be accessible at an exterior surface of the bottom bar. The two or more first electrical contacts may be plates. The two or more first electrical contacts may be arranged in recesses formed in the surface of the bottom bar. The two or more first electrical contacts may each comprise a respective pin that may extend through the bottom bar. The respective pin of each of the two or more first electrical contacts may extend through a respective recess in the cover and into a respective opening in the printed circuit board when the two or more first electrical contacts may be received in the recesses in the surface of the cover.

A bottom bar for a covering system may comprise a covering material. The bottom bar may comprise a housing comprising a first housing portion attached to the covering material and a second housing portion attached to the first housing portion. The bottom bar may comprise one or more solar cell modules, each of the one or more solar cell modules comprising one or more solar cells mounted to a substrate, the one or more solar cell modules supported by the second housing portion. The bottom bar may comprise one or more energy storage elements configured to be charged from the one or more solar cells of the one or more solar cell modules, the one or more energy storage elements supported by the second housing portion. The second housing portion may be configured to be detached from the first housing portion while supporting the one or more solar cell modules and the one or more energy storage elements.

The second housing portion may comprise a recess that may receive the one or more solar cell modules. The second housing portion may comprise an upper rear wall above the recess and a lower rear wall below the recess. The second housing portion may comprise an upper flange extending from the upper rear wall into the recess and a lower flange extending from the lower rear wall into the recess. The upper and lower flanges may retain the one or more solar cell modules within the recess.

The bottom bar may comprise a printed circuit board assembly comprising a printed circuit board. The one or more solar cells of the one or more solar cell modules may be electrically coupled to the printed circuit board via two or more first electrical conductors. The one or more energy storage elements may be electrically coupled to the printed circuit board via two or more second electrical conductors. The printed circuit board of the printed circuit board assembly may be supported by the second housing portion. The recess may extend from a first end to a second end of the second housing portion.

The bottom bar may comprise first and second end caps connected to respective ends of the bottom bar and to cover the recess at the first and second ends of the second housing portion. The printed circuit board of the printed circuit board assembly may be located in the recess of the second housing portion between the first end cap and the one or more solar cell modules.

The bottom bar may comprise a spacer board located in the recess of the second housing portion between the second end cap and the one or more solar cell modules. Each of the first and second end caps may comprise an end portion that may cover the recess at the first and second ends of the second housing portion and a cover portion that may further cover the recess.

The second housing portion may define a gap between the upper and lower flanges. The one or more solar cells of the one or more solar cell modules may be located within the gap between the upper and lower flanges. The second housing portion may comprise one or more ribs extending along a rear wall of the recess from the first end to the second end of the second housing portion. The one or more ribs may define grooves within the recess for receiving the two or more first electrical conductors connected between the one or more solar cells and the printed circuit board. The one or more ribs may allow the second housing portion to flex for widening the gap to allow at least one solar cell module of the one or more solar cell modules to be removed from the recess through the gap.

The printed circuit board assembly may comprise two or more electrical contacts at an outer surface of the printed circuit board and located within the gap between the upper and lower flanges of the second housing portion. The printed circuit board assembly may comprise a charging circuit mounted to an inner surface of the printed circuit board and electrically coupled between the one or more energy storage elements and the two or more electrical contacts. The two or more electrical contacts may be plates.

The printed circuit board assembly may comprise a solar cell management circuit mounted to an inner surface of the printed circuit board and electrically coupled between the one or more solar cells of the one or more solar cell modules and the one or more energy storage elements. The solar cell management circuit may be configured to charge the one or more energy storage elements from the one or more solar cells.

The second housing portion may comprise a cavity that may be oriented parallel to the recess and may receive the one or more energy storage elements. The cavity in which the one or more energy storage elements may be received may extend from the first end to the second end of the second housing portion.

The bottom bar may comprise first and second covers for housing the printed circuit board. The first cover may be received in the recess of the second housing portion. The second cover may be coupled to the second housing portion with the printed circuit board captured between the first and second covers. The second housing portion may comprise first and second attachment members that may extend from the second housing portion and may have first and second channels, respectively. The second cover may be received in the first and second channels of the respective first and second attachment members. The second cover may comprise a first projection that may extend from an upper wall of the second cover and may be received in the first channel of the first attachment member. The second cover may comprise a second projection that may extend from a lower wall of the second cover and may be received in the second channel of the second attachment member.

The second housing portion may comprise an interior wall within the recess. The interior wall may define one or more cutouts through which electrical conductors between the one or more solar cell modules and the printed circuit board may extend. The second cover may be secured to the first cover via a fastener received through an opening in the second cover, an opening in the printed circuit board, and an opening in the first cover. The fastener may also extend through at least one of the cutouts in the interior wall of the second housing portion.

The printed circuit board assembly may comprise two or more electrical contacts at an outer surface of the printed circuit board. The electrical contacts may comprise respective arms that may extend through respective openings in the first cover. The electrical contacts may also extend through at least one of the cutouts in the interior wall of the second housing portion. The second attachment member may comprise a support arm that may contact an inner surface of the printed circuit board. The first and second attachment members may engage with the first housing portion for coupling the second housing portion to the first housing portion. The first cover may comprise one or more ribs that may contact an outer surface of the printed circuit board. The second cover may comprise one or more ribs that may contact an inner surface of the printed circuit board.

The bottom bar may comprise a third housing portion attached to the first housing portion. The printed circuit board of the printed circuit board assembly may be supported by the third housing portion. The bottom bar may comprise a first end cap connected to a first end of the bottom bar and a second end cap connected to a second end of the bottom bar. The third housing portion may be located between the first end cap and the second housing portion.

The second housing portion may comprise a releasable attachment structure that may be configured to detach the second housing portion from the first housing portion when actuated. The second housing portion may comprise a catch that may be located at an upper end of the second housing portion. The catch may attach to a lip at an upper end of the first housing portion. The releasable attachment structure may be located at a lower end of the second housing portion. The releasable attachment structure may comprise a clip attached to a lower rear wall of the second housing portion. The clip may engage an indentation of the first housing portion to attach the second housing portion to the first housing portion.

The clip may comprise a wedge portion received in the indentation of the first housing portion when the second housing portion may be attached to the first housing portion. The clip may comprise an actuation portion configured to, when actuated by a user, cause the lower rear wall of the second housing portion to flex and the wedge portion of the clip to be removed from the indentation of the first housing portion, such that the second housing portion may be detached from the first housing portion.

The lip of the first housing portion may be a rear lip. The first housing portion may further comprise a front lip and a slot. The slot may receive the covering material. The front and rear lips may be located on both sides of the slot. The releasable attachment structure may comprise first and second attachment members that may extend from the second housing portion and may engage with the first housing portion for coupling the second housing portion to the first housing portion.

The second attachment member may comprise an engagement portion received in a first channel of the first housing portion. The first attachment member may comprise a spring arm received in and engaged with a second channel of the first housing portion for attaching the second housing portion to the first housing portion. The second housing portion may comprise an actuation portion configured to, when actuated by a user, cause the spring arm of the first attachment member of the second housing portion to flex and the engagement portion of the second attachment member to be removed from the first channel of the first housing portion, such that the second housing portion may be detached from the first housing portion.

A covering system may comprise a covering assembly comprising a covering material that may extend from a top end to a bottom end. The covering assembly may comprise a bottom bar comprising: (i) a first housing portion attached to the bottom end of the covering material and a second housing portion attached to the first housing portion; (ii) one or more solar cell modules, each of the one or more solar cell modules comprising one or more solar cells mounted to a substrate, the one or more solar cell modules supported by the second housing portion; and (iii) one or more first energy storage elements configured to be charged from the one or more solar cells of the one or more solar cell modules, the one or more first energy storage elements supported by the second housing portion. The second housing portion may be configured to be detached from the first housing portion while supporting the one or more solar cell modules and the one or more first energy storage elements.

The covering system may comprise a motor drive unit comprising a motor configured to adjust the covering material. The covering system may comprise one or more second energy storage elements for powering the motor. The covering system may comprise a dock comprising a base portion electrically coupled to the one or more second energy storage elements. The bottom bar may be configured to be positioned adjacent to the base portion of the dock when the bottom bar may be in a docked position, such that the one or more first energy storage elements may discharge through the base portion of the dock into the one or more second energy storage elements.

The second housing portion may comprise a recess that may receive the one or more solar cell modules. The second housing portion may comprise an upper rear wall above the recess and a lower rear wall below the recess. The second housing portion may comprise an upper flange extending from the upper rear wall into the recess and a lower flange extending from the lower rear wall into the recess. The upper and lower flanges may retain the one or more solar cell modules within the recess.

The covering system may comprise a printed circuit board assembly comprising a printed circuit board. The one or more solar cells of the one or more solar cell modules may be electrically coupled to the printed circuit board via two or more first electrical conductors. The one or more first energy storage elements may be electrically coupled to the printed circuit board via two or more second electrical conductors. The printed circuit board of the printed circuit board assembly may be supported by the second housing portion. The recess may extend from a first end to a second end of the second housing portion.

The covering system may comprise first and second end caps connected to respective ends of the bottom bar and to cover the recess at the first and second ends of the second housing portion. The printed circuit board of the printed circuit board assembly may be located in the recess of the second housing portion between the first end cap and the one or more solar cell modules.

The covering system may comprise a spacer board located in the recess of the second housing portion between the second end cap and the one or more solar cell modules. Each of the first and second end caps may comprise an end portion that may cover the recess at the first and second ends of the second housing portion and a cover portion that may further cover the recess.

The second housing portion may define a gap between the upper and lower flanges. The one or more solar cells of the one or more solar cell modules may be located within the gap between the upper and lower flanges. The second housing portion may comprise one or more ribs extending along a rear wall of the recess from the first end to the second end of the second housing portion. The one or more ribs may define grooves within the recess for receiving the two or more first electrical conductors connected between the one or more solar cells and the printed circuit board. The one or more ribs may allow the second housing portion to flex for widening the gap to allow at least one solar cell module of the one or more solar cell modules to be removed from the recess through the gap.

The printed circuit board assembly may comprise two or more electrical contacts arranged on an outer surface of the printed circuit board and located within the gap between the upper and lower flanges of the second housing portion. The printed circuit board assembly may comprise a charging circuit mounted to an inner surface of the printed circuit board and electrically coupled between the one or more first energy storage elements and the two or more electrical contacts.

The printed circuit board assembly may comprise a solar cell management circuit mounted to an inner surface of the printed circuit board and electrically coupled between the one or more solar cells of the one or more solar cell modules and the one or more first energy storage elements. The solar cell management circuit may be configured to charge the one or more first energy storage elements from the one or more solar cells.

The second housing portion may comprise a cavity that may be oriented parallel to the recess and may receive the one or more first energy storage elements. The cavity in which the one or more first energy storage elements may be received may extend from the first end to the second end of the second housing portion.

The covering system may comprise first and second covers for housing the printed circuit board. The first cover may be received in the recess of the second housing portion. The second cover may be coupled to the second housing portion with the printed circuit board captured between the first and second covers. The second housing portion may comprise first and second attachment members that may extend from the second housing portion and may have first and second channels, respectively. The second cover may be received in the first and second channels of the respective first and second attachment members.

The second cover may comprise a first projection that may extend from an upper wall of the second cover and may be received in the first channel of the first attachment member. The second cover may comprise a second projection that may extend from a lower wall of the second cover and may be received in the second channel of the second attachment member. The second housing portion may comprise an interior wall within the recess. The interior wall may define one or more cutouts through which electrical conductors between the one or more solar cell modules and the printed circuit board may extend.

The second cover may be secured to the first cover via a fastener received through an opening in the second cover, an opening in the printed circuit board, and an opening in the first cover. The fastener may also extend through at least one of the cutouts in the interior wall of the second housing portion.

The printed circuit board assembly may comprise two or more electrical contacts arranged on an outer surface of the printed circuit board. The electrical contacts may comprise respective arms that may extend through respective openings in the first cover. The electrical contacts may also extend through at least one of the cutouts in the interior wall of the second housing portion.

The second attachment member may comprise a support arm that may contact an inner surface of the printed circuit board. The first and second attachment members may engage with the first housing portion for coupling the second housing portion to the first housing portion. The first cover may comprise one or more ribs that may contact an outer surface of the printed circuit board. The second cover may comprise one or more ribs that may contact an inner surface of the printed circuit board.

The bottom bar may comprise a third housing portion attached to the first housing portion. The printed circuit board of the printed circuit board assembly may be supported by the third housing portion. The covering system may comprise a first end cap connected to a first end of the bottom bar and a second end cap connected to a second end of the bottom bar. The third housing portion may be located between the first end cap and the second housing portion.

The second housing portion may comprise a releasable attachment structure that may be configured to detach the second housing portion from the first housing portion when actuated. The second housing portion may comprise a catch that may be located at an upper end of the second housing portion and may be attached to a lip at an upper end of the first housing portion. The releasable attachment structure may be located at a lower end of the second housing portion.

The releasable attachment structure may comprise a clip attached to a lower rear wall of the second housing portion. The clip may engage an indentation of the first housing portion to attach the second housing portion to the first housing portion.

The clip may comprise a wedge portion received in the indentation of the first housing portion when the second housing portion may be attached to the first housing portion. The clip may comprise an actuation portion configured to, when actuated by a user, cause the lower rear wall of the second housing portion to flex and the wedge portion of the clip to be removed from the indentation of the first housing portion, such that the second housing portion may be detached from the first housing portion.

The lip of the first housing portion may be a rear lip. The first housing portion may comprise a front lip and a slot. The slot may receive the covering material. The front and rear lips may be located on both sides of the slot. The releasable attachment structure may comprise first and second attachment members that may extend from the second housing portion and may engage with the first housing portion for coupling the second housing portion to the first housing portion.

The second attachment member may comprise an engagement portion received in a first channel of the first housing portion. The first attachment member may comprise a spring arm received in and engaged with a second channel of the first housing portion for attaching the second housing portion to the first housing portion. The second housing portion may comprise an actuation portion configured to, when actuated by a user, cause the spring arm of the first attachment member of the second housing portion to flex and the engagement portion of the second attachment member to be removed from the second channel of the first housing portion, such that the second housing portion may be detached from the first housing portion.

The bottom bar may comprise one or more sensors.

A bottom bar for a covering system may comprise a covering material. The bottom bar may comprise a main housing element attached to the covering material. The bottom bar may comprise a bottom bar module attached to the main housing element. The bottom bar module may be configured to be removably detached from the main housing element. The bottom bar module may comprise one or more solar cells and one or more energy storage elements configured to be charged from the one or more solar cells. The one or more solar cells and one or more first energy storage elements may separate from the main housing element when the bottom bar module may be detached from the main housing element.

The bottom bar module may comprise a support element to support the one or more solar cells and the one or more energy storage elements.

The bottom bar module may comprise a printed circuit board assembly comprising a printed circuit board that may be supported by the support element. The one or more solar cells may be electrically coupled to the printed circuit board via two or more first electrical conductors. The one or more energy storage elements may be electrically coupled to the printed circuit board via two or more second electrical conductors.

The bottom bar module may comprise at least one solar cell module comprising at least a portion of the one or more solar cells mounted to a respective substrate. The support element of the bottom bar module may comprise a recess in which the at least one solar cell module and the printed circuit board may be received.

The support element of the bottom bar module may comprise an upper rear wall above the recess and a lower rear wall below the recess. The support element may comprise an upper flange extending from the upper rear wall into the recess and a lower flange extending from the lower rear wall into the recess. The upper and lower flanges may retain the at least one solar cell module within the recess. The support element of the bottom bar module may define a gap between the upper and lower flanges. The one or more solar cells may be located within the gap between the upper and lower flanges. The recess may extend from a first end to a second end of the support element. The support element may comprise one or more ribs extending along a rear wall of the recess from the first end to the second end of the support element. The one or more ribs may define grooves within the recess for receiving the two or more first electrical conductors connected between the one or more solar cells and the printed circuit board. The one or more ribs may allow the support element to flex for widening the gap to allow the at least one solar cell module to be removed from the recess through the gap. The support element may comprise a cavity that may be oriented parallel to the recess and may receive the one or more energy storage elements.

The bottom bar may be configured to be positioned adjacent to a base portion of a dock when the bottom bar may be in a docked position, such that the one or more energy storage elements may discharge through the base portion of the dock. The printed circuit board assembly may comprise two or more first electrical contacts that may be arranged on the printed circuit board and may be configured to be electrically connected to respective second electrical contacts of the dock when the bottom bar may be in the docked position.

The printed circuit board assembly may comprise a charging circuit mounted to the printed circuit board and electrically coupled between the two or more first electrical contacts and the one or more energy storage elements.

The printed circuit board assembly may comprise a solar cell management circuit mounted to the printed circuit board and electrically coupled between the one or more solar cells and the one or more energy storage elements. The solar cell management circuit may be configured to charge the one or more energy storage elements from the one or more solar cells.

The main housing element may comprise a first housing portion attached to the covering material. The support element may comprise a second housing portion. The second housing portion may be attached to the first housing portion.

The bottom bar may comprise first and second covers for housing the printed circuit board. The first cover may be received in a recess of the second housing portion. The second cover may be coupled to the second housing portion with the printed circuit board captured between the first and second covers. The second housing portion may comprise first and second attachment members that may extend from the second housing portion and that may have first and second channels, respectively. The second cover may be received in the first and second channels of the respective first and second attachment members. The second cover may comprise a first projection that may extend from an upper wall of the second cover and may be received in the first channel of the first attachment member. The second cover may comprise a second projection that may extend from a lower wall of the second cover and may be received in the second channel of the second attachment member.

The second housing portion may comprise an interior wall within the recess. The interior wall may define one or more cutouts through which electrical conductors between at least one solar cell module and the printed circuit board may extend. The at least one solar cell module may comprise the one or more solar cells. The second cover may be secured to the first cover via a fastener received through an opening in the second cover, an opening in the printed circuit board, and an opening in the first cover. The fastener may also extend through at least one of the cutouts in the interior wall of the second housing portion.

The printed circuit board assembly may comprise two or more electrical contacts arranged on an outer surface of the printed circuit board. The electrical contacts may comprise respective arms that may extend through respective openings in the first cover. The electrical contacts may also extend through at least one of the cutouts in the interior wall of the second housing portion. The second attachment member may comprise a support arm that may contact an inner surface of the printed circuit board. The first and second attachment members may engage with the first housing portion for coupling the second housing portion to the first housing portion. The first cover may comprise one or more ribs that may contact an outer surface of the printed circuit board. The second cover may comprise one or more ribs that may contact an inner surface of the printed circuit board.

The bottom bar module may comprise a third housing portion attached to the first housing portion. The printed circuit board of the printed circuit board assembly may be supported by the third housing portion. The bottom bar may comprise a first end cap connected to a first end of the bottom bar and a second end cap connected to a second end of the bottom bar. The third housing portion may be located between the first end cap and the second housing portion.

The second housing portion may comprise a releasable attachment structure that may be configured to detach the second housing portion from the first housing portion when actuated. The second housing portion may comprise a catch that may be located at an upper end of the second housing portion and that may attach to a lip at an upper end of the first housing portion. The releasable attachment structure may be located at a lower end of the second housing portion. The releasable attachment structure may comprise a clip attached to a lower rear wall of the second housing portion. The clip may engage an indentation of the first housing portion to attach the second housing portion to the first housing portion.

The clip may comprise a wedge portion received in the indentation of the first housing portion when the second housing portion may be attached to the first housing portion. The clip may comprise an actuation portion configured to, when actuated by a user, cause the lower rear wall of the second housing portion to flex and the wedge portion of the clip to be removed from the indentation of the first housing portion, such that the second housing portion may be detached from the first housing portion.

The lip of the first housing portion may be a rear lip. The first housing portion may comprise a front lip and a slot. The slot may be configured to receive the covering material. The front and rear lips may be located on both sides of the slot.

The releasable attachment structure may comprise first and second attachment members that may extend from the second housing portion and may engage with the first housing portion for coupling the second housing portion to the first housing portion.

The second attachment member may comprise an engagement portion received in a first channel of the first housing portion. The first attachment member may comprise an engagement portion received in and engaged with a second channel of the first housing portion for attaching the second housing portion to the first housing portion. The second housing portion may comprise an actuation portion configured to, when actuated by a user, cause a spring arm of the first attachment member of the second housing portion to flex and the engagement portion of the second attachment member to be removed from the second channel of the first housing portion, such that the second housing portion may be detached from the first housing portion.

The support element of the bottom bar module may comprise a releasable attachment structure that may be configured to detach the support element from the main housing element when actuated. The support element of the bottom bar module may comprise a catch that may be located at an upper end of the support element and may be attached to a lip at an upper end of the main housing element. The releasable attachment structure may be located at a lower end of the support element.

The releasable attachment structure may comprise a clip attached to a lower rear wall of the support element of the bottom bar module. The clip may engage an indentation of the main housing element to attach the support element to the main housing element. The clip may comprise a wedge portion received in the indentation of the main housing element when the support element may be attached to the main housing element. The clip may comprise an actuation portion configured to, when actuated by a user, cause the lower rear wall of the support element to flex and the wedge portion of the clip to be removed from the indentation of the main housing element, such that the support element may detach from the main housing element.

The main housing element may comprise a first housing portion of the bottom bar and the support element may comprise a second housing portion of the bottom bar. The first housing portion may be attached to the second housing portion to form the main housing element of the bottom bar.

The one or more solar cells may be supported by the support element of the bottom bar module such that the one or more solar cells may be oriented at an angle from a vertical axis of the covering system.

A bottom bar for a covering system may comprise a covering material. The bottom bar may comprise a housing attached to the covering material. The bottom bar may comprise a cover attached to the housing. The bottom bar may comprise one or more energy storage elements. The bottom bar may comprise a printed circuit board assembly comprising a printed circuit board, wherein the printed circuit board assembly may be supported by the cover. The bottom bar may comprise two or more electrical contacts located at a surface of the cover, the two or more electrical contacts mechanically and electrically coupled to the printed circuit board.

The two or more electrical contacts may be plates. The two or more electrical contacts may be arranged in recesses formed in the surface of the cover. The two or more electrical contacts may each comprise a respective pin that may extend through the cover. The respective pin of each of the two or more electrical contacts may extend through a respective recess in the cover and into a respective opening in the printed circuit board when the two or more electrical contacts may be received in the recesses in the surface of the cover.

The cover may comprise one or more spring arms in each of the recesses. The one or more spring arms may be configured to bias the two or more electrical contacts away from the printed circuit board, such that the two or more electrical contacts may be flush with the surface of the cover. The two or more electrical contacts may be configured to be electrically connected to respective electrical contacts of a dock of the covering system when the bottom bar may be in a docked position.

The one or more energy storage elements may be received in a cavity of the housing. The cavity may be configured such that the one or more energy storage elements may slide into the cavity. The cavity may be defined by a sloped wall and a curved wall of the housing that may extend along a length of the housing, such that the cavity may extend along the length of the housing. The sloped wall and the curved wall may define a slot that may extend for the length of the cavity. The slot may be configured such that the sloped wall and the curved wall may move apart when the one or more energy storage elements may be inserted therein, thereby securing the one or more energy storage elements in the cavity by friction fit.

The bottom bar may comprise one or more solar cell modules, each of the one or more solar cell modules comprising one or more solar cells mounted to a substrate, the one or more solar cell modules supported by the housing. The housing may comprise a recess that may receive the one or more solar cell modules.

The housing may comprise an upper rear wall above the recess and a lower rear wall below the recess. The housing may comprise an upper flange extending from the upper rear wall into the recess and a lower flange extending from the lower rear wall into the recess. The upper and lower flanges may retain the one or more solar cell modules within the recess.

The bottom bar may comprise a first end cap connected to a first end of the bottom bar and a second end cap connected to a second end of the bottom bar. The cover may be located between the first end cap and the housing.

The printed circuit board assembly may be attached to a surface of the cover via a fastener received through an opening in the printed circuit board and an opening in the cover. The cover portion may comprise a first attachment member that may extend from the cover and may be attached to the housing. The housing may comprise a spacer housing portion comprising a second attachment member attached to the housing.

The bottom bar may comprise one or more solar cell modules, each of the one or more solar cell modules comprising one or more solar cells mounted to a substrate, the one or more solar cell modules supported by the housing. The one or more energy storage elements may be configured to be charged from the one or more solar cells of the one or more solar cell modules. The one or more solar cells of the one or more solar cell modules may be electrically coupled to the printed circuit board via two or more first electrical conductors. The one or more energy storage elements may be electrically coupled to the printed circuit board via two or more second electrical conductors.

The two or more electrical contacts may extend through the housing. The two or more electrical contacts may each comprise a respective spring arm coupled to a respective base member. The respective base members of the two or more electrical contacts may be mounted to the printed circuit board. The respective spring arms of the electrical contacts may be biased away from the printed circuit board.

A bottom bar for a covering system may comprise a covering material. The bottom bar may comprise a housing attached to the covering material. The bottom bar may comprise one or more energy storage elements. The bottom bar may comprise a printed circuit board assembly comprising a printed circuit board. The bottom bar may comprise a first cover and a second cover, wherein the first cover and the second cover may house the printed circuit board assembly, the first and second covers supported by the housing. The bottom bar may comprise two or more electrical contacts located at a surface of the first cover, the two or more electrical contacts mechanically and electrically coupled to the printed circuit board.

The printed circuit board assembly may be supported by the second cover. The first cover may be coupled to the second cover with the printed circuit board captured between the first cover and the second cover. The second cover may be supported by the housing. The second cover may comprise one or more projections that may be received in one or more respective channels of the housing for coupling the second cover to the housing. The second cover may be attached to the housing with the printed circuit board captured between the housing and the second cover.

The two or more electrical contacts may extend through the first cover. The two or more electrical contacts may each comprise a respective spring arm coupled to a respective base member. The respective base members of the two or more electrical contacts may be mounted to the printed circuit board. The respective spring arms of the electrical contacts may be biased away from the printed circuit board. The respective spring arms of the two or more electrical contacts may extend through respective openings in the first cover or the second cover. The respective spring arms of the two or more electrical contacts may extend through respective openings in the cover when the first cover may be coupled to the second cover with the printed circuit board captured between the first cover and the second cover. The two or more electrical contacts may be configured to bias the first cover away from the printed circuit board, such that the first cover may be flush with the surface of the housing.

The housing may comprise a recess that may receive one or more solar cell modules of the bottom bar. The first cover may be received in the recess of the housing. The housing may comprise an upper rear wall above the recess and a lower rear wall below the recess. The housing may comprise an upper flange extending from the upper rear wall into the recess and a lower flange extending from the lower rear wall into the recess. The upper and lower flanges may retain the one or more solar cell modules within the recess.

The one or more energy storage elements may be received in a cavity of the housing. The cavity may be configured such that the one or more energy storage elements may be configured to slide into the cavity. The cavity may be configured to secure the one or more energy storage elements in the cavity by friction fit.

The bottom bar may comprise one or more solar cell modules, each of the one or more solar cell modules comprising one or more solar cells mounted to a substrate, the one or more solar cell modules supported by the housing. The one or more energy storage elements may be configured to be charged from the one or more solar cells of the one or more solar cell modules. The one or more solar cells of the one or more solar cell modules may be electrically coupled to the printed circuit board via two or more first electrical conductors. The one or more energy storage elements may be electrically coupled to the printed circuit board via two or more second electrical conductors. The housing may comprise a first housing portion and a second housing portion. The second housing portion may be configured to be detached from the first housing portion while supporting the one or more solar cell modules and the one or more energy storage elements.

The bottom bar may comprise a first end cap and a second end cap. The first cover may be located between the one or more solar cell modules and the first end cap.

The two or more electrical contacts may be plates. The two or more electrical contacts may be arranged in recesses formed in the surface of the first cover or the second cover.

A bottom bar for a covering system may comprise a covering material. The bottom bar may comprise a main housing element attached to the covering material. The bottom bar may comprise a bottom bar module attached to the main housing element. The bottom bar module may be configured to be removably detached from the main housing element. The bottom bar module may comprise one or more solar cells and one or more first energy storage elements configured to be charged from the one or more solar cells. The one or more solar cells and one or more first energy storage elements may separate from the main housing element when the bottom bar module may be detached from the main housing element.

The bottom bar module may comprise a support element configured to support the one or more solar cells and the one or more first energy storage elements. The bottom bar module may comprise a printed circuit board assembly comprising a printed circuit board that may be supported by the support element. The one or more solar cells may be electrically coupled to the printed circuit board via two or more first electrical conductors. The one or more first energy storage elements may be electrically coupled to the printed circuit board via two or more second electrical conductors.

The bottom bar module may comprise at least one solar cell module comprising at least a portion of the one or more solar cells mounted to a respective substrate. The support element of the bottom bar module may comprise a recess in which the at least one solar cell module and the printed circuit board may be configured to be received.

The support element of the bottom bar module may comprise an upper rear wall above the recess and a lower rear wall below the recess. The support element may comprise an upper flange extending from the upper rear wall into the recess and a lower flange extending from the lower rear wall into the recess. The upper and lower flanges may be configured to retain the at least one solar cell module within the recess. The support element of the bottom bar module may define a gap between the upper and lower flanges. The one or more solar cells may be located within the gap between the upper and lower flanges.

The recess may extend from a first end to a second end of the support element. The support element may comprise one or more ribs extending along a rear wall of the recess from the first end to the second end of the support element. The one or more ribs may define grooves within the recess for receiving the two or more first electrical conductors connected between the one or more solar cells and the printed circuit board. The support element may comprise a cavity that may be oriented parallel to the recess and may be configured to receive the one or more first energy storage elements.

The bottom bar may be configured to be positioned adjacent to a base portion of a dock when the bottom bar may be in a docked position, such that the one or more first energy storage elements may discharge through the base portion of the dock into one or more second energy storage elements of the covering system. The printed circuit board assembly may comprise two or more first electrical contacts that may be arranged on the printed circuit board and may be configured to be electrically connected to respective second electrical contacts of the dock when the bottom bar may be in the docked position.

The printed circuit board assembly may comprise a solar cell management circuit mounted to the printed circuit board and electrically coupled between the one or more solar cells and the one or more first energy storage elements. The solar cell management circuit may be configured to charge the one or more first energy storage elements from the one or more solar cells.

The main housing element may comprise a first housing portion configured to be attached to the covering material. The bottom bar module may comprise a second housing portion. The second housing portion may be configured to be attached to the first housing portion.

The bottom bar may comprise first and second covers for housing the printed circuit board. The first cover may be received in a recess of the second housing portion. The second cover may be coupled to the second housing portion with the printed circuit board captured between the first and second covers.

The printed circuit board assembly may comprise two or more electrical contacts arranged on an outer surface of the printed circuit board. The electrical contacts may comprise respective arms that may extend through respective openings in the first cover. The electrical contacts may also extend through at least one of the cutouts in the interior wall of the second housing portion.

The bottom bar module may comprise a third housing portion configured to be attached to the first housing portion. The printed circuit board of the printed circuit board assembly may be supported by the third housing portion.

A covering system may comprise a covering material. The covering system may comprise the bottom bar of any of the foregoing, wherein the bottom bar may be attached to the covering material. The covering system may comprise a motor drive unit comprising a motor configured to adjust the covering material. The covering system may comprise one or more second energy storage elements for powering the motor.

A bottom bar for a covering system may comprise a covering material. The bottom bar may comprise a housing comprising a first housing portion attached to the covering material and a second housing portion attached to the first housing portion. The bottom bar may comprise one or more solar cell modules, each of the one or more solar cell modules comprising one or more solar cells mounted to a substrate, the one or more solar cell modules supported by the second housing portion. The bottom bar may comprise one or more energy storage elements configured to be charged from the one or more solar cells of the one or more solar cell modules, the one or more energy storage elements supported by the second housing portion. The second housing portion may be configured to be detached from the first housing portion while supporting the one or more solar cell modules and the one or more energy storage elements.

The second housing portion may comprise a recess configured to receive the one or more solar cell modules. The second housing portion may comprise an upper rear wall above the recess and a lower rear wall below the recess. The second housing portion may comprise an upper flange extending from the upper rear wall into the recess and a lower flange extending from the lower rear wall into the recess. The upper and lower flanges may be configured to retain the one or more solar cell modules within the recess.

The bottom bar may comprise a printed circuit board assembly comprising a printed circuit board. The one or more solar cells of the one or more solar cell modules may be electrically coupled to the printed circuit board via two or more first electrical conductors. The one or more energy storage elements may be electrically coupled to the printed circuit board via two or more second electrical conductors.

The printed circuit board of the printed circuit board assembly may be supported by the second housing portion. The recess may extend from a first end to a second end of the second housing portion. The bottom bar may comprise first and second end caps configured to connect to respective ends of the bottom bar and to cover the recess at the first and second ends of the second housing portion. The printed circuit board of the printed circuit board assembly may be located in the recess of the second housing portion between the first end cap and the one or more solar cell modules. The bottom bar may comprise a spacer board located in the recess of the second housing portion between the second end cap and the one or more solar cell modules. Each of the first and second end caps may comprise an end portion configured to cover the recess at the first and second ends of the second housing portion and a cover portion configured to further cover the recess.

The second housing portion may define a gap between upper and lower flanges. The one or more solar cells of the one or more solar cell modules may be located within the gap between the upper and lower flanges. The second housing portion may comprise one or more ribs extending along a rear wall of the recess from a first end to a second end of the second housing portion. The one or more ribs may define grooves within the recess for receiving the two or more first electrical conductors connected between the one or more solar cells and the printed circuit board. The one or more ribs may allow the second housing portion to flex for widening the gap to allow at least one solar cell module of the one or more solar cell modules to be removed from the recess through the gap.

The printed circuit board assembly may comprise two or more electrical contacts arranged on an outer surface of the printed circuit board and located within the gap between the upper and lower flanges of the second housing portion. The printed circuit board assembly may comprise a charging circuit mounted to an inner surface of the printed circuit board and electrically coupled between the one or more energy storage elements and the two or more electrical contacts.

The printed circuit board assembly may comprise a solar cell management circuit mounted to an inner surface of the printed circuit board and electrically coupled between the one or more solar cells of the one or more solar cell modules and the one or more energy storage elements. The solar cell management circuit may be configured to charge the one or more energy storage elements from the one or more solar cells.

The second housing portion may comprise a cavity that may be oriented parallel to the recess and may be configured to receive the one or more energy storage elements. The cavity in which the one or more energy storage elements may be received may extend from the first end to the second end of the second housing portion.

The bottom bar may comprise first and second covers for housing the printed circuit board. The first cover may be received in the recess of the second housing portion. The second cover may be coupled to the second housing portion with the printed circuit board captured between the first and second covers.

The second housing portion may comprise first and second attachment members that may extend from the second housing portion and may have first and second channels, respectively. The second cover may be received in the first and second channels of the respective first and second attachment members. The second cover may comprise a first projection that may extend from an upper wall of the second cover and may be received in the first channel of the first attachment member and a second projection that may extend from a lower wall of the second cover and may be received in the second channel of the second attachment member. The second housing portion may comprise an interior wall within the recess. The interior wall may define one or more cutouts through which electrical conductors between the one or more solar cell modules and the printed circuit board may extend.

A covering system may comprise a covering material. The covering system may comprise the bottom bar of any of the foregoing, wherein the bottom bar may be attached to the covering material. The covering system may comprise a motor drive unit comprising a motor configured to adjust the covering material. The covering system may comprise one or more second energy storage elements for powering the motor.

A covering system may comprise a motor drive unit comprising a motor configured to adjust the covering material. The covering system may comprise a covering assembly comprising a covering material that may extend from a top end to a bottom end. The covering assembly may comprise a bottom bar comprising a bottom bar module and a housing. The housing may be attached to the bottom end of the covering material and further attached to the bottom bar module. The bottom bar module may be configured to be removably detached from the housing. The bottom bar module may comprise a printed circuit board assembly that comprises a printed circuit board. The bottom bar module may comprise one or more solar cells electrically coupled to the printed circuit board. The bottom bar module may comprise one or more energy storage elements electrically coupled to the printed circuit board. The bottom bar module may comprise one or more sensors that may be configured to be powered from the one or more solar cells.

A bottom bar for a covering system may comprise a covering material. The bottom bar may comprise a housing comprising a first housing portion attached to the covering material and a second housing portion attached to the first housing portion. The bottom bar may comprise a printed circuit board supported by the second housing portion. The bottom bar may comprise one or more energy storage elements configured to power the printed circuit board, wherein the one or more energy storage elements may be supported by the second housing portion. The second housing portion may be configured to be detached from the first housing portion while supporting the printed circuit board and the one or more energy storage elements, while the first housing portion may remain attached to the covering material.

### BRIEF DESCRIPTION OF THE DRAWINGS

FIG. 1 is a diagram of an example load control system.

FIG. 2 is a perspective view of an example covering system.

FIG. 3 is a rear perspective view of the covering system of FIG. 2.

FIG. 4 is a front perspective view of a covering assembly of the covering system of FIG. 2.

FIG. 5 is a rear perspective view of the covering assembly of FIG. 4.

FIG. 6 is a left-side view of the covering assembly of FIG. 4.

FIG. 7 is a perspective view of a motor drive unit of the covering assembly of the covering system of FIG. 2.

FIG. 8 is a partial enlarged perspective view of the motor drive unit of FIG. 7.

FIG. 9 is a front view of the motor drive unit of FIG. 7.

FIG. 10 is a top view of the motor drive unit of FIG. 7.

FIG. 11 is a left-side view of the motor drive unit of FIG. 7.

FIG. 12 is a partial enlarged rear perspective view of a bottom bar of the covering assembly of FIG. 4.

FIG. 13 is a left-side cross section view of the bottom bar of FIG. 12.

FIG. 14 is a right-side cross-section view of another example covering assembly for use in a covering system showing a bottom bar in an undocked position.

FIG. 15 is a right-side cross-section view of the covering assembly of FIG. 14 showing the bottom bar in a docked position.

FIG. 16 is a partial enlarged rear perspective view of the bottom bar of the covering assembly of FIG. 14.

FIG. 17 is a front perspective view of an example of a bottom bar for use in a covering system.

FIG. 18 is a rear perspective view of the bottom bar of FIG. 17.

FIG. 19 is a front exploded view of the bottom bar of FIG. 17.

FIG. 20 is a rear exploded view of the bottom bar of FIG. 17.

FIG. 21 is an enlarged partial exploded view of a first end of the bottom bar of FIG. 17.

FIG. 22 is an enlarged partial exploded view of a second end of the bottom bar of FIG. 17.

FIG. 23 is a side cross-section view of the bottom bar of FIG. 17.

FIG. 24 is a front perspective view of an example of a bottom bar for use in a covering system.

FIG. 25 is a rear perspective view of the bottom bar of FIG. 24.

FIG. 26 is a front exploded view of the bottom bar of FIG. 24.

FIG. 27 is a rear exploded view of the bottom bar of FIG. 24.

FIG. 28 is an enlarged partial exploded view of a first end of the bottom bar of FIG. 24.

FIG. 29 is another enlarged partial exploded view of the first end of the bottom bar of FIG. 24.

FIG. 30 is an enlarged partial exploded view of a second end of the bottom bar of FIG. 24.

FIG. 31 is a side cross-section view of the bottom bar of FIG. 24.

FIG. 32 is a front perspective view of an example of a bottom bar for use in a covering system.

FIG. 33 is a rear perspective view of the bottom bar of FIG. 32.

FIG. 34 is a front exploded view of the bottom bar of FIG. 32.

FIG. 35 is a rear exploded view of the bottom bar of FIG. 32.

FIG. 36 is an enlarged partial exploded view of a first end of the bottom bar of FIG. 32.

FIG. 37 is an enlarged partial exploded view of a second end of the bottom bar of FIG. 32.

FIG. 38 is another enlarged partial exploded view of the first end of the bottom bar of FIG. 32.

FIG. 39 is another enlarged partial exploded view of the second end of the bottom bar of FIG. 32.

FIG. 40 is a side cross-section view of the bottom bar of FIG. 32.

FIG. 41 is a simplified block diagram of a control system for controlling a covering system.

FIG. 42 is a flowchart of an example procedure for adjusting a present position of a covering material of a covering system.

FIG. 43 is a flowchart of an example procedure for determining when to dock a bottom bar of a covering system.

FIGS. 44A-44G are flowcharts of example procedures for determining when to dock a bottom bar of a covering system.

FIGS. 45A-45C are flowcharts of example procedures for docking a bottom bar of a covering system.

FIG. 46 is a flowchart of an example procedure for adjusting a present position of a covering material of a covering system in response to a solar power being received by one or more solar cells of the covering system.

### DETAILED DESCRIPTION

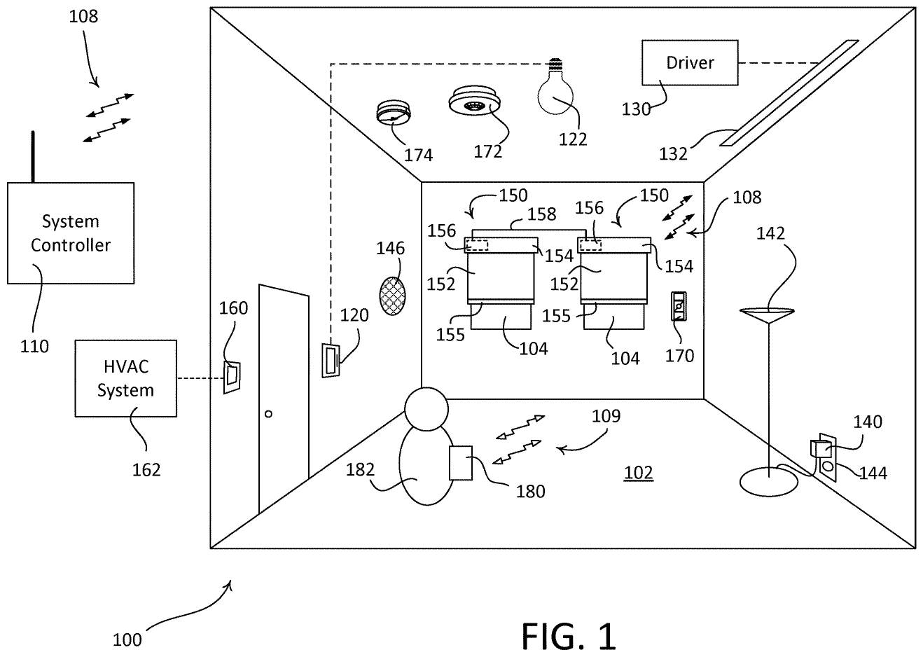

FIG. 1 is a diagram of an example load control system 100 for controlling an amount of power delivered from a power source (not shown), such as an alternating-current (AC) power source or a direct-current (DC) power source, to one or more electrical loads. The load control system 100 may be installed in a room 102 of a building. The load control system 100 may comprise a plurality of control devices configured to communicate with each other by transmitting and/or receiving messages (e.g., digital messages) via wireless signals, e.g., radio-frequency (RF) signals 108. Alternatively or additionally, the load control system 100 may comprise a wired digital communication link coupled to one or more of the control devices to provide for communication between the control devices. The control devices of the load control system 100 may comprise a number of control-source devices (e.g., input devices operable to transmit messages in response to user inputs, occupancy and/or vacancy conditions, changes in measured light intensity, etc.) and a number of control-target devices (e.g., load control devices operable to receive messages and control respective electrical loads in response to the received messages). A single control device of the load control system 100 may operate as both a control-source and a control-target device.

The control-source devices may be configured to transmit messages directly to the control-target devices. In addition, the load control system 100 may comprise a system controller 110 (e.g., a central processor or load controller) configured to communicate messages to and from (e.g., between) the control devices (e.g., the control-source devices and/or the control-target devices). For example, the system controller 110 may be configured to receive messages from the control-source devices and transmit messages to the control-target devices in response to the messages received from the control-source devices. The system controller 110 may be configured to originate messages and transmit those messages to control devices.

The load control system 100 may comprise one or more load control devices, such as a dimmer switch 120 (e.g., a control-target device) for controlling a lighting load 122. The dimmer switch 120 may be configured to control an amount of power delivered from the AC power source to the lighting load 122 to adjust an intensity level and/or a color (e.g., a color temperature) of the lighting load 122. The dimmer switch 120 may be adapted to be wall-mounted in a standard electrical wallbox. The dimmer switch 120 may also be a tabletop or plug-in load control device. The dimmer switch 120 may comprise a toggle actuator (e.g., a button) and an intensity adjustment actuator (e.g., a rocker switch). Actuations (e.g., successive actuations) of the toggle actuator may toggle (e.g., turn off and on) the lighting load 122. Actuations of an upper portion or a lower portion of the intensity adjustment actuator may respectively increase or decrease the amount of power delivered to the lighting load 122 and thus increase or decrease the intensity of the lighting load 122 from a minimum intensity (e.g., approximately 1%) to a maximum intensity (e.g., approximately 100%). The dimmer switch 120 may comprise a plurality of visual indicators, e.g., light-emitting diodes (LEDs), which may be illuminated to provide feedback of the intensity of the lighting load 122. The dimmer switch 120 may be configured to receive messages (e.g., such as wireless messages) via the RF signals 108 (e.g., from the system controller 110) and to control the lighting load 122 in response to the received messages. Examples of wall-mounted dimmer switches are described in greater detail in U.S. Patent Application Publication No. 9,679,696, issued Jun. 13, 2017, entitled WIRELESS LOAD CONTROL DEVICE, the entire disclosure of which is hereby incorporated by reference.

The load control system 100 may comprise one or more remotely-located load control devices, such as an LED driver 130 (e.g., a control-target device) for driving an LED light source 132 (e.g., an LED light engine). The LED driver 130 may be located remotely, for example, in or adjacent to the lighting fixture of the LED light source 132 and/or be integral with the lighting fixture of the LED light source 132. The LED driver 130 may be configured to receive messages, such as wireless messages via the RF signals 108 (e.g., from the system controller 110), and to control the LED light source 132 in response to the received messages. The LED driver 130 may be configured to adjust the color temperature of the LED light source 132 in response to the received messages. The load control system 100 may further comprise other types of remotely-located load control devices, such as, for example, electronic dimming ballasts for driving fluorescent lamps.

The load control system 100 may comprise a plug-in load control device 140 (e.g., a control-target device) for controlling a plug-in electrical load, e.g., a plug-in lighting load, such as a lamp 142 (e.g., a floor lamp or a table lamp) and/or an appliance (e.g., such as a television or a computer monitor). For example, the lamp 142 may be plugged into the plug-in load control device 140. The plug-in load control device 140 may be plugged into a standard electrical outlet 144 and thus may be coupled in series between the AC power source and the lamp 142. The plug-in load control device 140 may be configured to receive messages (e.g., such as wireless messages) via the RF signals 108 (e.g., from the system controller 110), and to turn on and off or adjust the intensity of the lamp 142 in response to the received messages. Alternatively or additionally, the load control system 100 may comprise controllable receptacles (e.g., control-target devices) for controlling plug-in electrical loads plugged into the receptacles. The load control system 100 may comprise one or more load control devices or appliances that are able to receive messages (e.g., such as wireless message) via the RF signals 108 (e.g., from the system controller 110), such as a speaker 146 (e.g., part of an audio/visual or intercom system), which may be able to generate audible sounds, such as alarms, music, intercom functionality, etc.

The load control system 100 may comprise one or more daylight control devices, e.g., motorized window treatments 150 (e.g., control-target devices), such as motorized roller shades, for controlling the amount of daylight entering the room 102. Each motorized window treatment 150 may comprise a covering material 152 (e.g., a window treatment fabric) hanging from a roller tube 154 in front of a respective window 104 and having a respective bottom bar 155 connected to a bottom end of the respective covering material

152. The covering material 152 may be wound around and unwound from the roller tube 154 for respectively raising and lowering the covering material 152. Each motorized window treatment 150 may further comprise a motor drive unit 156 located inside of the roller tube 154, for example, and having a motor for rotating the roller tube 154 to raise and lower the covering material 152 for controlling the amount of daylight entering the room 102 (one will appreciate that the motor drive unit 156 or portions thereof may be located outside (e.g., external) to or partially external to the roller tube 154). The motor drive units 156 may be configured to adjust a present position P_{PRES} of the respective covering material 152 between a raised position P_{RAISED} (e.g., a fully-raised position and/or a fully-open position) and a lowered position P_{LOWERED} (e.g., a fully-lowered position and/or a fully-closed position).

The motor drive units 156 of the motorized window treatments 150 may each include a communication circuit(s) configured to communicate (e.g., transmit and/or receive) messages, for example via the RF signals 108. The communication circuit may be located internal to and/or external to the roller tube 154. For example, the motor drive units 156 of the motorized window treatments 150 may each be configured to receive messages (e.g., from the system controller 110 or other control-source devices, such as a remote control device 170, an occupancy sensor 172, and/or a daylight sensor 174) and adjust the present position P_{PRES} of the respective covering material 152 in response to the received messages. The motor drive unit 156 of each of the motorized window treatments 150 may be battery-powered or may be coupled to an external AC or DC power source. When battery-powered, one or more batteries may be located internal to and/or external to the roller tube 154. The load control system 100 may comprise other types of daylight control devices, such as, for example, a cellular shade, a drapery, a Roman shade, a Venetian blind, a Persian blind, a pleated blind, a tensioned roller shade system, an electrochromic or smart window, and/or other suitable daylight control device. Further, the load control system 100 is not limited to any particular window or environment, and for instance, may be adapted for various types of interior daylight control devices (e.g., shades, blinds, or drapery for interior windows, skylights in interior spaces, moonlights in automobiles, etc.) and/or exterior daylight control devices (e.g., exterior blinds or shades, awnings, etc.). For example, although the covering systems and the motorized window treatments are described herein primarily in the context of a covering material or treatment for a window, the covering systems and the motorized window treatments may be used in other environments, such as a shade for a patio (e.g., that is mounted to the roofline of a porch or patio for sun protection or privacy) and/or as an outdoor curtain (e.g., at a balcony, cabana, outdoor kitchen, or pergola, for example, to provide shade, privacy, or to protect against wind or bugs). Examples of battery-powered motorized window treatments are described in greater detail in U.S. Pat. No. 10,494,864, issued Dec. 3, 2019, entitled MOTORIZED WINDOW TREATMENT, the entire disclosure of which is hereby incorporated by reference.

Each of the motorized window treatments 150 may comprise one or more solar cells (e.g., photovoltaic cells), as described in greater detail below. For example, the one or more solar cells may be located at the bottom bars 155 of the motorized window treatments 150 (e.g., on a rear surface of the bottom bars 155). The bottom bars 155 may each comprise an energy storage element (e.g., one or more of rechargeable batteries and/or supercapacitors) (e.g., a first energy storage element) configured to charge from the one or more solar cells. The motor drive units 156 of each of the motorized window treatments 150 may be configured to control the respective covering materials 152 to the raised position P_{RAISED} to allow the energy storage element in the bottom bar 155 to discharge into an energy storage element (e.g., one or more of rechargeable batteries and/or supercapacitors) (e.g., a second energy storage element) of the respective motor drive unit 156 for producing a storage voltage across the energy storage element of the respective motor drive unit 156. The energy storage element of the respective motor drive unit 156 may be configured to provide power to the motor and other circuitry of the motor drive unit 156. The energy storage element of the respective motor drive unit 156 may be located internal to and/or external to the roller tube 154. The motor drive units 156 may each be configured to drive and/or provide power to the respective motor and other circuitry of the motor drive unit 156 from the storage voltage produced across the energy storage element of the respective motor drive unit 156. Further, in some examples, the one or more solar cells may be positioned on the motorized window treatment 150 at a location other than the bottom bar 155, such as on the covering material 152 or the motor drive unit 156.

The load control system 100 may further comprise one or more temperature control devices, e.g., a thermostat 160 (e.g., a control-target device) for controlling a room temperature in the room 102. The thermostat 160 may be coupled to a heating, ventilation, and air conditioning (HVAC) system 162 via a control link (e.g., an analog control link or a wired digital communication link). The thermostat 160 may be configured to wirelessly communicate messages with a controller of the HVAC system 162. The thermostat 160 may comprise a temperature sensor for measuring a room temperature of the room 102 and may control the HVAC system 162 to adjust room temperature of the room 102 to a setpoint temperature. The load control system 100 may comprise one or more wireless temperature sensors (not shown) located in the room 102 for measuring the room temperature of the room 102. For example, the thermostat 160 and the wireless temperature sensors may be battery-powered. The HVAC system 162 may be configured to turn a compressor on and off for cooling the room 102 and to turn a heating source on and off for heating the room 102 in response to the control signals received from the thermostat 160. The HVAC system 162 may be configured to turn a fan of the HVAC system on and off in response to the control signals received from the thermostat 160. The thermostat 160 and/or the HVAC system 162 may be configured to control one or more controllable dampers to control the air flow in the room 102.

The load control system 100 may further comprise one or more input devices (e.g., control-source devices), such as a remote control device 170, an occupancy sensor 172, and/or a daylight sensor 174. The input devices may be fixed or movable input devices. The remote control device 170, the occupancy sensor 172, and/or the daylight sensor 174 may be wired or wireless control devices (e.g., RF transmitters) configured to transmit messages, such as messages via the RF signals 108, directly to the load control devices (e.g., the dimmer switch 120, the LED driver 130, the plug-in load control device 140, the motorized window treatments 150, and/or the thermostat 160) and/or to the system controller 110 (e.g., directly to the system controller). The system controller 110 may be configured to transmit one or more messages to the load control devices (e.g., the dimmer switch 120, the LED driver 130, the plug-in load control device 140, the motorized window treatments 150, and/or the thermostat 160) in response to the messages received from the remote control device 170, the occupancy sensor 172, and/or the daylight sensor 174. The remote control device 170, the occupancy sensor 172, and/or the daylight sensor 174 may also and/or alternatively be configured to transmit messages directly to the dimmer switch 120, the LED driver 130, the plug-in load control device 140, the motorized window treatments 150, and/or the thermostat 160.

The remote control device 170 may be configured to transmit messages to the system controller 110 and/or a control-target device, such as via the RF signals 108, in response to an actuation of one or more buttons of the remote control device 170. For example, the remote control device 170 may be battery-powered. Examples of remote control devices are described in greater detail in commonly-assigned U.S. Pat. No. 9,361,790, issued Jun. 7, 2016, entitled REMOTE CONTROL FOR A WIRELESS LOAD CONTROL SYSTEM, and U.S. Pat. No. 9,633,557, issued Apr. 25, 2017, entitled BATTERY-POWERED RETROFIT REMOTE CONTROL DEVICE, the entire disclosures of which are hereby incorporated by reference.

The occupancy sensor 172 may be configured to detect occupancy and vacancy conditions in the room 102 (e.g., in which the occupancy sensor 172 is mounted). For example, the occupancy sensor 172 may be battery-powered. The occupancy sensor 172 may transmit messages to the system controller 110 and/or a load control device, such as via the RF signals 108, in response to detecting the occupancy or vacancy conditions. The system controller 110 may be configured to control load control devices (e.g., the dimmer switch 120, the LED driver 130, the plug-in load control device 140, the motorized window treatments 150, and/or the thermostat 160) in response to receiving an indication of an occupied condition and/or a vacant condition from the occupancy sensor 172. In addition, the load control devices may be responsive to an indication of an occupied condition and/or a vacant condition received directly from the occupancy sensor 172. Examples of RF load control systems having occupancy and vacancy sensors are described in greater detail in commonly-assigned U.S. Pat. No. 8,009,042, issued Aug. 30, 2011, entitled RADIO-FREQUENCY LIGHTING CONTROL SYSTEM WITH OCCUPANCY SENSING, the entire disclosure of which is hereby incorporated by reference.

The daylight sensor 174 may be configured to measure a total light intensity in the room 102 (e.g., the room in which the daylight sensor 174 is installed). For example, the daylight sensor 174 may be battery-powered. The daylight sensor 174 may transmit digital messages (e.g., including the measured light intensity) to the system controller 110, such as via the RF signals 108. The system controller 110 may be configured to control the load control devices (e.g., the dimmer switch 120, the LED driver 130, the plug-in load control device 140, the motorized window treatments 150, and/or the thermostat 160) in response to receiving a message including the measured light intensity from the daylight sensor 174. In addition, the load control devices may each be responsive to a message including the measured light intensity received directly from the daylight sensor 174. Examples of RF load control systems having daylight sensors are described in greater detail in commonly-assigned U.S. Pat. No. 8,451,116, issued May 28, 2013, entitled WIRELESS BATTERY-POWERED DAYLIGHT SENSOR, the entire disclosure of which is hereby incorporated by reference.

The system controller 110 may be configured to be coupled to a network, such as a wireless or wired local area network (LAN), e.g., for access to the Internet. The system controller 110 may be wirelessly connected to the network. The system controller 110 may be coupled to the network via a network communication bus (e.g., an Ethernet communication link). The system controller 110 may be configured to communicate via the network with one or more network devices, e.g., a mobile device 180, such as a mobile personal computing device and/or a wearable wireless device. The mobile device 180 may be located on an occupant 182, for example, may be attached to the body or clothing of the occupant 182, or may be held by the occupant 182. The mobile device 180 may be characterized by a unique identifier (e.g., a serial number or address stored in memory) that uniquely identifies the mobile device 180 and thus the occupant 182. Examples of mobile personal computing devices may include a smart phone, a laptop, and/or a tablet device. Examples of wearable wireless devices may include an activity tracking device, a smart watch, smart clothing, and/or smart glasses. The system controller 110 may be configured to communicate via the network with one or more other network devices, e.g., a stationary computing device, such as a stationary personal computing device (e.g., a personal computer) and/or a server. In addition, the system controller 110 may be configured to communicate via the network with one or more other control systems (e.g., a building management system, a security system, etc.).

The mobile device 180 may be configured to transmit digital messages, such as via RF signals 109, to the system controller 110 and/or the load control devices, for example, in one or more Internet Protocol packets. For example, the mobile device 180 may be configured to transmit digital messages to the system controller 110 over the LAN and/or via the Internet. The mobile device 180 may be configured to transmit digital messages over the Internet to an external service, and then the digital messages may be received by the system controller 110. The load control system 100 may comprise other types of network devices coupled to the network, such as a desktop personal computer (PC), a wireless-communication-capable television, or any other suitable Internet-Protocol-enabled device.

The operation of the load control system 100 may be programmed and configured using, for example, the mobile device 180 or other network device (e.g., when the mobile device 180 is a personal computing device). The mobile device 180 may execute a graphical user interface (GUI) configuration software for allowing a user to program how the load control system 100 will operate. For example, the configuration software may run as a PC application or a web interface. The configuration software and/or the system controller 110 (e.g., via instructions from the configuration software) may generate a load control database that defines the operation of the load control system 100. For example, the load control database may include information regarding the operational settings of different load control devices of the load control system 100 (e.g., the dimmer switch 120, the LED driver 130, the plug-in load control device 140, the motorized window treatments 150, and/or the thermostat 160). The load control database may comprise information regarding associations between the load control devices and the input devices (e.g., the remote control device 170, the occupancy sensor 172, and/or the daylight sensor 174). The load control database may comprise information regarding how the load control devices respond to inputs received from the input devices. Examples of configuration procedures for load control systems are described in greater detail in commonly-assigned U.S. Pat. No. 10,027,127, issued Jul. 17, 2018, entitled COMMISSIONING LOAD CONTROL SYSTEMS, the entire disclosure of which is hereby incorporated by reference.

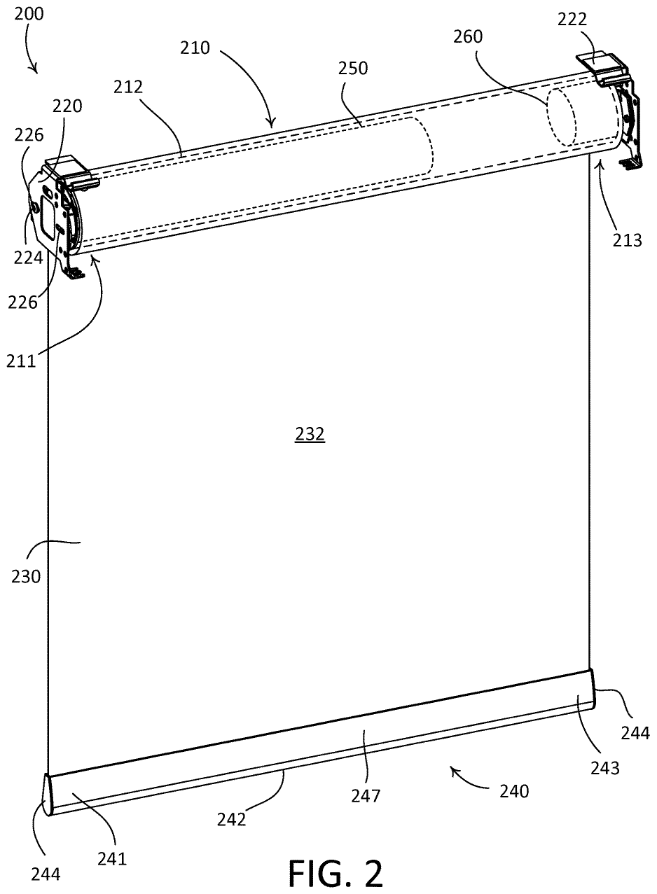

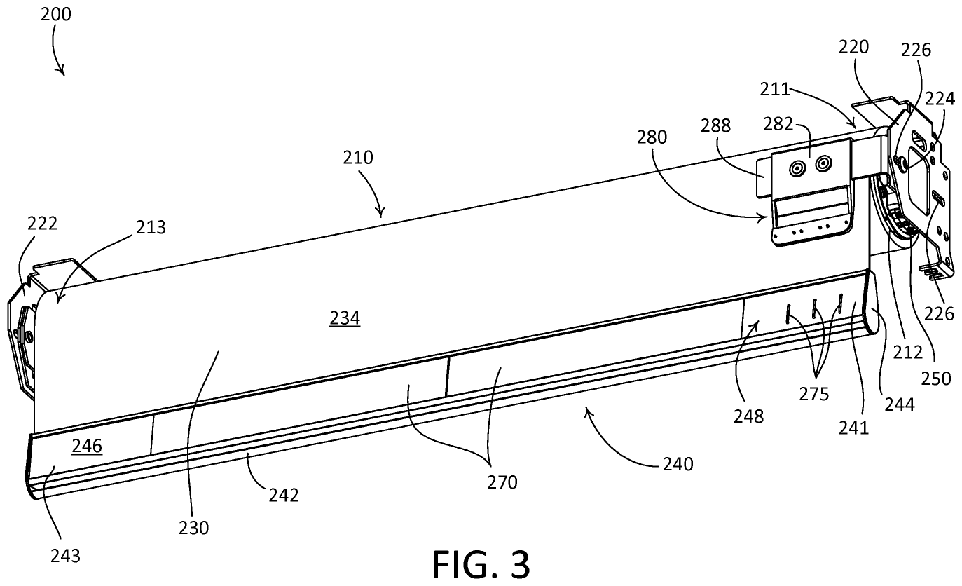

FIG. 2 is a front perspective view and FIG. 3 is a rear perspective view of an example covering system, such as a motorized window treatment 200, which may be deployed as one or more of the motorized window treatments 150 of the load control system 100. The motorized window treatment 200 may comprise a covering assembly, such as a window treatment assembly 210, and one or more mounting brackets, such as first and second mounting brackets 220, 222. The first and second mounting brackets 220, 222 may be configured to be coupled to or otherwise mounted to a structure. For example, each of the first and second mounting brackets 220, 222 may be configured to be mounted to (e.g., attached to) a window frame, a wall, a ceiling, or other structure of a building, such that the motorized window treatment 200 may be mounted proximate to an opening (e.g., over the opening or in the opening), such as a window for example. The first and second mounting brackets 220, 222 may be configured to be mounted to a vertical structure (e.g., wall-mounted to a wall) and/or mounted to a horizontal structure (e.g., ceiling-mounted to a ceiling).

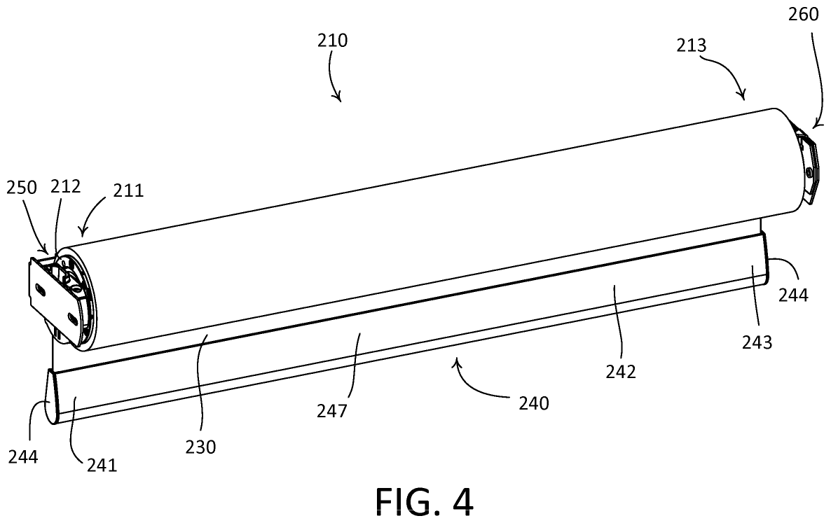

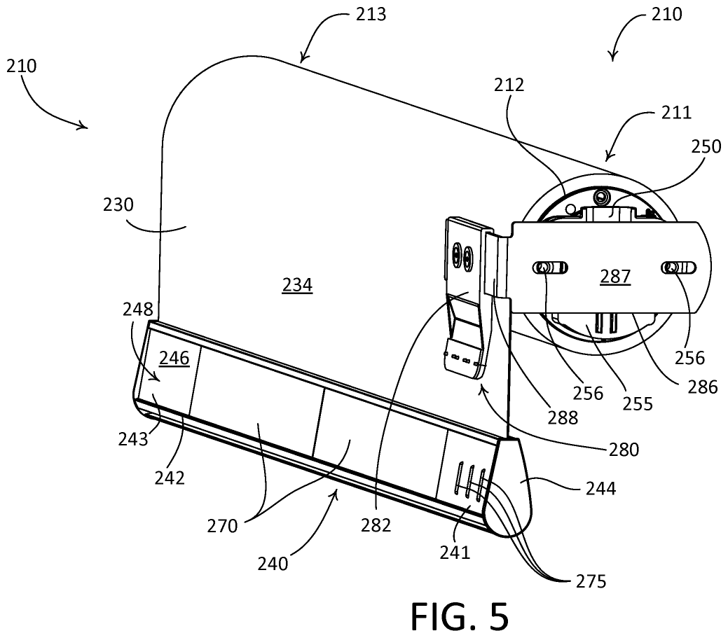

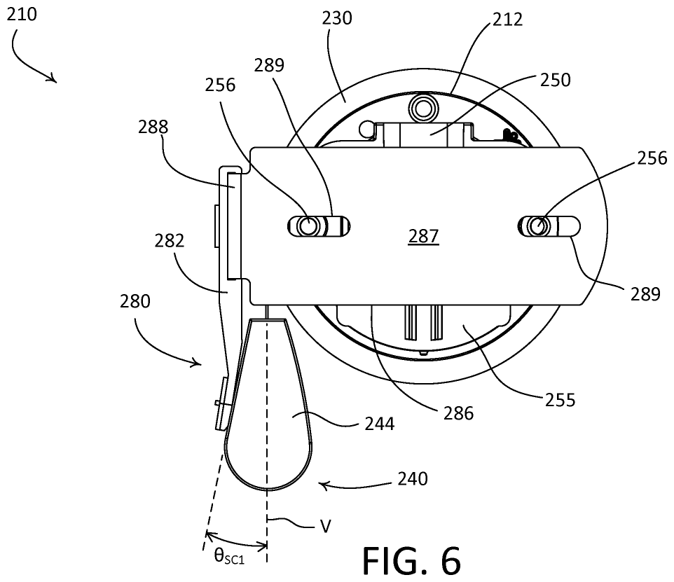

The window treatment assembly 210 may be coupled to (e.g., supported by) the first and second mounting brackets 220, 222. FIG. 4 is a front perspective view, FIG. 5 is a rear perspective view, and FIG. 6 is a left-side view of the window treatment assembly 210 detached from the first and second mounting brackets 220, 222. The window treatment assembly 210 may include a roller tube 212, a covering material 230 (e.g., a flexible material), a bottom bar 240 (e.g., a hembar), a motor drive unit 250 at a first end 211 of the roller tube 212, and an idler 260 at a second end 213 of the roller tube 212. The motor drive unit 250 may be coupled to (e.g., fixedly coupled to) the first mounting bracket 220 and may be rotatably coupled to the roller tube 212 at the first end 211 of the roller tube 212. The idler 260 (FIG. 2) may be coupled to (e.g., fixedly coupled to) the second mounting bracket 222 and may be rotatably coupled to the roller tube 212 at the second end 213 of the roller tube 212. Other configurations of the motor drive unit 250 and the idler 260 are possible. For example, the motor drive unit 250 may be located at the second end 213 of the roller tube 212 and the idler 260 may be located at the first end 211 of the roller tube 212. As indicated earlier, one of more components of the motor drive unit 250 may be external to or partially external to the roller tube 212.

The covering material 230 may be windingly attached to the roller tube 212. The covering material 230 may comprise a top end (not shown) attached to the roller tube 212 and a bottom end (not shown) attached to the bottom bar 240. The bottom bar 240 may comprise a housing 242 having first and second ends 241, 243. In some examples, the bottom end of the covering material 230 may be received within the housing 242 and secured to the bottom bar 240 inside the housing 242. The bottom bar 240 may also comprise, for example, two end caps 244 connected respectively to the first and second ends 241, 243 of the bottom bar 240. In addition, the bottom bar 240 (e.g., the housing 242) may be configured, for example weighted, to cause the covering material 230 to hang vertically. For example, the covering material 230 may be configured to cover the window that is proximate to the motorized window treatment 200. The covering material 230 may comprise a front surface 232 that faces the space in which the motorized window treatment 200 is mounted and a rear surface 234 that faces the window.

The roller tube 212 of the window treatment assembly 210 may operate as a rotational element of the motorized window treatment 200. The roller tube 212 of the window treatment assembly 210 may be rotatably mounted to (e.g., rotatably supported by) the first and second mounting brackets 220, 222. The first and second mounting brackets 220, 222 may extend from the structure to which the motorized window treatment 200 is mounted. The covering material 230 may be windingly attached to the roller tube 212, such that rotation of the roller tube 212 causes the covering material 230 to wind around or unwind from the roller tube 212. For example, rotation of the roller tube 212 may cause the covering material 230 (e.g., the bottom bar 240) to move between a raised position P_{RAISED} (e.g., a fully-raised position and/or a fully-open position as shown in FIG. 3) and a lowered position P_{LOWERED} (e.g., a fully-lowered position and/or a fully-closed position as shown in FIG. 2).

The window treatment assembly 210 (e.g., the motor drive unit 250) may be configured to cause the bottom bar 240 and the covering material 230 to be moved into a docked position P_{DOCKED} (e.g., as shown in FIG. 6). The docked position P_{DOCKED} may be the position of the covering material 230 (e.g., the bottom bar 240) when the bottom bar 240 is adjacent to (e.g., in electrical connection with) a dock 280 of the motorized window treatment 200, for example, as described in more detail below. The docked position P_{DOCKED} may be, for example, above the raised position P_{RAISED} such that the raised position P_{RAISED} is between the lowered position P_{LOWERED} and the docked position P_{DOCKED}. In some examples, the raised position P_{RAISED} may be the docked position P_{DOCKED}. The covering material 230 may be fully wound around the roller tube 212 in the docked position P_{DOCKED} and fully extended in the lowered position P_{LOWERED}. Further, in some examples, the window treatment assembly 210 may be configured such that a user can control the covering material 230 (e.g., the bottom bar 240) to move between the raised position P_{RAISED} and the lowered position P_{LOWERED} (e.g., but not into the docked position P_{DOCKED}).

The covering material 230 may be any suitable material or any combination of materials. For example, the covering material 230 may be “scrim,” woven cloth, non-woven material, light-control film, screen, and/or mesh. The motorized window treatment 200 may be any type of covering system, such as a window treatment. For example, the motorized window treatment 200 may be a roller shade as illustrated, a soft sheer shade, a drapery, a cellular shade, a Roman shade, or a Venetian blind. As shown, the covering material 230 may be a material suitable for use as a shade fabric, and may be alternatively referred to as a flexible material. The covering material 230 is not limited to shade fabric. For example, in accordance with an alternative implementation of the motorized window treatment 200 as a retractable projection screen, the covering material 230 may be a material suitable for displaying images projected onto the covering material. With all types of covering materials, the window treatment assembly 210 may have a bottom bar (e.g., such as the bottom bar 240) attached at a bottom end of the covering material 230.

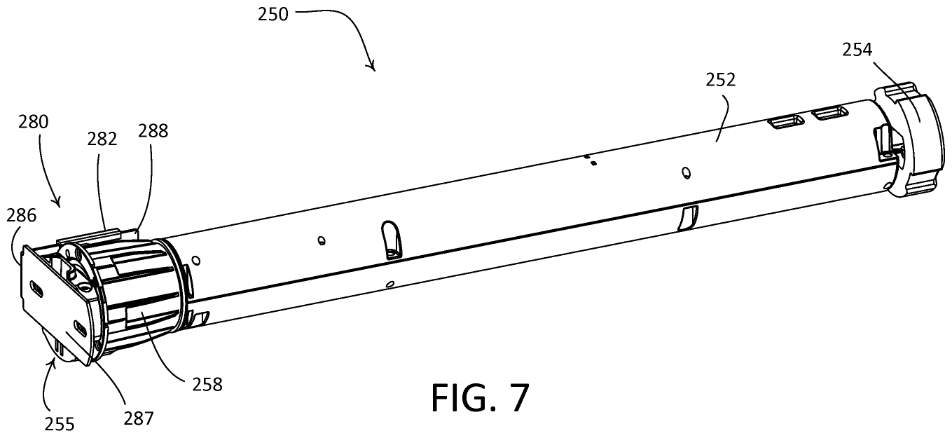

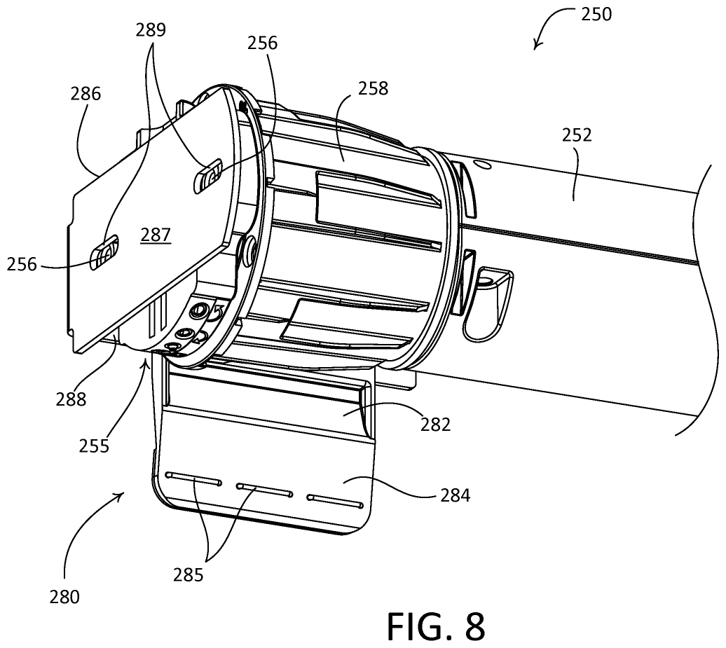

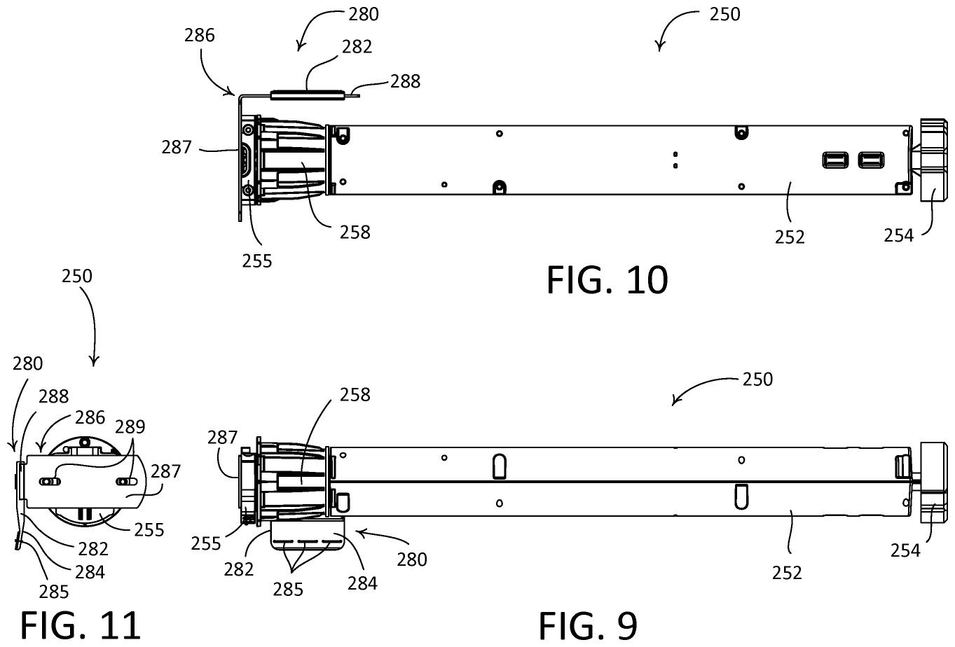

FIG. 7 is a perspective view of an example of the motor drive unit 250. FIG. 8 is a partial enlarged perspective view of the motor drive unit 250. FIG. 9 is a front view, FIG. 10 is a top view, and FIG. 11 is a left-side view of the motor drive unit 250. The motor drive unit 250 may include an enclosure 252 for housing an internal motor (not shown) that may be coupled to a drive coupler 254. The drive coupler 254 may be notched about its outer periphery to facilitate engagement between the drive coupler 254 and an interior surface of the roller tube 212 in which the motor drive unit 250 is received. The motor drive unit 250 may be configured to rotate the drive coupler 254 for rotatably driving the roller tube 212. The motor drive unit 250 may further comprise an end portion 255 that may be coupled to (e.g., supported by) the first mounting bracket 220. For example, the end portion 255 may comprise one or more openings 256 that are configured to receive respective fasteners 224 (e.g., screws as shown in FIGS. 2 and 3). The fasteners 224 may also be received though respective openings 226 in the first and second mounting brackets 220, 222. In some examples, the end portion 255 of the motor drive unit 250 may comprise additional openings (not shown) configured to allow the window treatment assembly 210 to be mounted to other mounting brackets (e.g., other than the first and second mounting brackets 220, 222). The openings 256 and the additional openings may be sized and/or located to allow the window treatment assembly 210 to be mounted to multiple types of mounting brackets (e.g., the first and second mounting brackets 220, 222 as well as other mounting brackets). The motor drive unit 250 may comprise a bearing assembly 258, which may be located adjacent to the end portion 255 and may be rotatably coupled to the roller tube 212 at the first end 211 of the roller tube 212 to enable the roller tube 212 to rotate relative to the enclosure 252, for example.

The motor drive unit 250 may be responsive to messages (e.g., digital messages) transmitted by an external device, such as a remote control device, via wired or wireless signals, such as RF signals. The motor drive unit 250 may comprise a communication circuit, such as a wireless communication circuit (e.g., an RF transceiver coupled to an antenna, an infrared (IR) receiver, etc.) and/or a wired communication circuit. For example, the antenna may be wrapped around the enclosure 252 of the motor drive unit 250 underneath the bearing assembly 258. The motor drive unit 250 may be configured to control the movement of the covering material 230 in response to a shade movement command received in messages from the remote control device, for example. During a configuration procedure (e.g., an association procedure), the motor drive unit 250 may be associated with the remote control device, such that the motor drive unit 250 may be responsive to the messages transmitted by the remote control device (e.g., via wireless signals). Similarly, as described in more detail herein, the bottom bar 240 may include a communication circuit, such as a wireless communication circuit (e.g., an RF transceiver coupled to an antenna, an IR receiver, etc.) and/or a wired communication circuit so that the bottom bar 240 may be configured to communicate with the motor drive unit 250. As described above, the communication circuit of the motor drive unit 250 may be internal to the enclosure 252 or external thereto, including external to the roller tube 212.

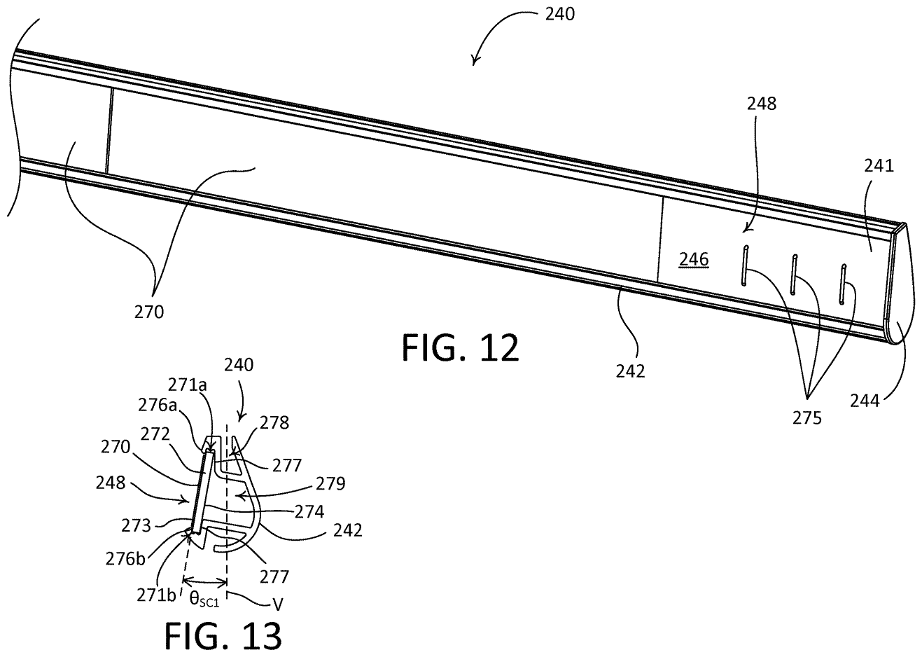

As shown in FIGS. 3 and 5, the bottom bar 240 may comprise one or more solar cells 270 (e.g., photovoltaic cells). FIG. 12 is an enlarged rear perspective view of the first end 241 of the bottom bar 240. The solar cells 270 may be located at the housing 242 of the bottom bar 240. For example, the solar cells 270 may be attached to a rear surface 246 of the housing 242 of the bottom bar 240, such that the solar cells 270 face the window (e.g., that the covering material 230 is configured to cover) and are able to receive solar energy (e.g., from the sun), such as from outside the building. For example, the solar cells 270 may be located within a recess 248 in the housing 242. The rear surface 246 of the housing 242 of the bottom bar 240 may be oriented at an angle θ_{SC1} from a vertical axis V (e.g., with respect to the covering material 230 as shown in FIG. 6), such that the solar cells 270 may be angled up (e.g., towards the sky to maximize the amount of sunlight that may shine on the solar cells 270). The housing 242 and the end caps 244 may define, for example, a teardrop shape as shown in FIG. 6, but could define other shapes, such as a triangular shape or a polygon shape having an angled rear surface. For example, the angle θ_{SC1} at which the solar cells 270 are oriented may be in the range of approximately 5° to 75° (e.g., approximately 30°). The solar cells 270 may be oriented horizontally across the rear surface 246 of the housing 242 of the bottom bar 240. However, in some examples, the solar cells 270 may be oriented vertically (e.g., in parallel with the shade fabric), for instance, across the rear surface 246 of the housing 242 of the bottom bar 240. Further, in some examples, the motorized window treatment 200 may include one or more solar cells 270 attached to an interior surface 245 of the housing 242 of the bottom bar 240 (e.g., receive solar energy from outside the building), for instance, in addition to one or more solar cells 270 being attached to the rear surface 246 of the housing 242 of the bottom bar 240.

As noted, the one or more solar cells 270 may be located at the housing 242 of the bottom bar 240 (e.g., on a rear surface 246 of the housing 242 of the bottom bar 240). For example, the one or more solar cells 270 may be proximate to the housing 242 of the bottom bar 240, adjacent to the housing 242 of the bottom bar 240, on the housing 242 of the bottom bar 240, supported by the housing 242 of the bottom bar 240, recessed within the housing 242 of the bottom bar 240, extending through the housing 242 of the bottom bar 240, and/or supported by different portions of the housing 242 and/or supported by to other structures supported by or connected to the housing 242 of the bottom bar 240. Further, in some examples, the one or more solar cells 270 may be positioned on the motorized window treatment 200 at a location other than the bottom bar 240, such as on the covering material 230 or the motor drive unit 250.

FIG. 13 is a left-side cross section view of the bottom bar 240. The bottom bar 240 may comprise a printed circuit board 272 configured to be received in a first channel 271a and a second channel 271b, such that an outer surface 273 of the printed circuit board 272 forms at least a portion of the rear surface 246 of the bottom bar 240. The first channel 271a in the bottom bar 240 may be formed by an upper flange portion 276a adjacent to the outer surface 273 of the printed circuit board 272 and by inner surfaces 277 of the bottom bar 240 adjacent to an inner surface 274 of the printed circuit board 272. Additionally, the second channel 271b in the bottom bar 240 may be formed by a lower flange portion 276b adjacent to the outer surface 273 of the printed circuit board 272 and by the inner surfaces 277 of the bottom bar 240 adjacent to the inner surface 274 of the printed circuit board 272. For example, the printed circuit board 272 may be configured to be slid into the first and second channels 271a, 271b from either the first end 241 or the second end 243 of the bottom bar 240 (e.g., when at least one of the end caps 244 is removed). The solar cells 270 may be located on (e.g., mounted to) the outer surface 273 of the printed circuit board 272. For example, the printed circuit board 272 (e.g., and thus the solar cells 270) may be mounted at the angle θ_{SC1} from the vertical axis V.

The housing 242 of the bottom bar 240 may define a first cavity 278 that may be configured to receive the bottom end of the covering material 230. For example, the bottom end of the covering material 230 may be attached to an elongated member (not shown) that may extend through the first cavity 278 (e.g., the from the first end 241 to the second end 243 of the housing 242) and may prevent the bottom end of the covering material 230 from being removed from the first cavity 278. In addition, the bottom bar 240 may comprise a second cavity 279 that may also extend from the first end 241 to the second end 243 of the housing 242. The second cavity 279 may be configured to receive a weighting member (not shown) for weighting the bottom bar 240 to cause the covering material 230 to hang vertically.

The solar cells 270 of the bottom bar 240 may be electrically connected to one or more energy storage elements (not shown) (e.g., one or more of rechargeable batteries and/or supercapacitors) contained within the housing 242 of the bottom bar 240. The energy storage elements of the bottom bar 240 may comprise, for example, one or more of rechargeable batteries and/or supercapacitors. For example, the energy storage elements of the bottom bar 240 may be located in the second cavity 279. The solar cells 270 may be configured to convert the received solar energy into a photovoltaic output voltage, which may be used to charge the energy storage elements located within the housing 242 of the bottom bar 240 (e.g., to generate a storage voltage across the energy storage elements). The energy stored in the energy storage elements of the bottom bar 240 may be discharged into one or more energy storage elements of the motor drive unit 250 when the bottom bar 240 is close to (e.g., proximate with) the motor drive unit 250, for example, when the bottom bar 240 is in the docked position P_{DOCKED}. For example, the motor drive unit 250 may comprise one or more energy storage elements (not shown) configured to charge from the energy storage elements of the bottom bar 240 when the covering material 230 is in the docked position P_{DOCKED}, and further configured to provide power to the motor and other circuitry of the motor drive unit 250. For example, the energy storage elements of the motor drive unit 250 may comprise one or more of rechargeable batteries and/or supercapacitors. As described above, the energy storage elements of the motor drive unit 250 may be internal to the enclosure 252 or external thereto, including external to the roller tube 212.

The dock 280 (e.g., as shown in FIG. 8) of the motorized window treatment 200 (e.g., the motor drive unit 250) may be configured to facilitate discharging of the energy storage elements of the bottom bar 240 into the energy storage elements of the motor drive unit 250, for example, when the covering material 230 is in the docked position P_{DOCKED} (e.g., when the bottom bar 240 is docked). The dock 280 may comprise a base portion 282 that may be located adjacent to the rear surface 234 of the covering material 230 (e.g., adjacent to the window) at the first end 211 of the roller tube 212. The bottom bar 240 may be configured to be positioned adjacent to the base portion 282 of the dock 280 when the covering material 230 is in the docked position P_{DOCKED}, such that the energy storage elements of the bottom bar 240 may discharge through the base portion 282 of the dock 280 into the energy storage elements of the motor drive unit 250. The base portion 282 of the dock 280 may define a contact surface 284 that may be configured to abut against the rear surface 246 of the bottom bar 240 when the bottom bar 240 is docked (e.g., when the covering material 230 is in the docked position P_{DOCKED}). The contact surface 284 of the base portion 282 may be oriented at approximately the angle θ_{SC1} from the vertical axis V (e.g., to match the rear surface 246 of the bottom bar 240).

The dock 280 may also comprise two or more electrical contacts 285 (e.g., two horizontally-oriented electrical contacts) located at the contact surface 284 of the base portion 282. The base portion 282 of the dock 280 (e.g., the electrical contacts 285) may be electrically coupled to the motor drive unit 250 in order to discharge the energy stored in the energy storage elements of the bottom bar 240 into the energy storage elements of the motor drive unit 250 when, for example, the covering material 230 is in the docked position P_{DOCKED} (e.g., when the bottom bar 240 is docked). For example, the base portion 282 of the dock 280 may be electrically coupled to the motor drive unit 250 via two or more electrical conductors (e.g., wires) extending between the base portion 282 of the dock 280 and the end portion 255 of the motor drive unit 250.

The dock 280 may further comprise an attachment member 286 that extends from the end portion 255 of the motor drive unit 250 to the base portion 282. The attachment member 286 may comprise a plate 287 and an arm 288 that is oriented at an angle (e.g., approximately 90°) from the plate 287 (e.g., to bend the attachment member 286 behind the rear surface 234 of the covering material 230). The electrical conductors that extend between the base portion 282 of the dock 280 and the end portion 255 of the motor drive unit 250 may be located internal to or external to the attachment member 286. The plate 287 may comprise openings 289 through which the respective fasteners 224 may extend for coupling the window treatment assembly 210 to the first mounting bracket 220 (e.g., extending through the openings 226 in the first mounting bracket 220 and the openings 256 in the end portion 255 of the motor drive unit 250). For example, the attachment member 286 (e.g., the plate 287) may be affixed to and/or formed as a part of (e.g., integral with) the enclosure 252 and/or the end portion 255 of the motor drive unit 250. In some examples, the attachment member 286 may be affixed to and/or formed as a part of the first mounting bracket 220.

As indicated above, the energy storage elements of the motor drive unit 250 may be internal to the enclosure 252. Here, the two or more electrical conductors (e.g., wires) may extend from the electrical contacts 285 of the base portion 282 of the dock 280 to the end portion 255 of the motor drive unit 250 and electrically interface (e.g., indirectly through discharge circuitry) to the energy storage elements of the motor drive unit 250 located in the enclosure 252, for example. As another example, the energy storage elements of the motor drive unit 250 may be external to the enclosure 252, including external to the roller tube 212. As one example, the energy storage elements of the motor drive unit 250 may be located on the dock 280. In such a configuration, the electrical contacts 285 of the base portion 282 of the dock 280 may electrically interface (e.g., indirectly through discharge circuitry which may also be located on the dock 280) with the energy storage elements of the motor drive unit 250 located on the dock 280. Two or more electrical conductors (e.g., wires) as described above may extend from the energy storage elements of the motor drive unit 250 to the end portion 255 of the motor drive unit 250 in order to provide power to the motor of the motor drive unit 250. Other configurations are possible.

The electrical contacts 285 of the dock 280 may be configured to contact respective electrical contacts 275 (e.g., three vertically-oriented electrical contacts) at the rear surface 246 of the bottom bar 240 (e.g., at the first end 241 of the bottom bar 240) when the bottom bar 240 is docked (e.g., when the covering material 230 is in the docked position P_{DOCKED}). Each of the electrical contacts 275 of the bottom bar 240 and the electrical contacts 285 of the dock 280 may be, for example, an elongated conductive element (e.g., an uninsulated wire). The electrical contacts 275 of the bottom bar 240 may be located next to each other (e.g., horizontally spaced apart from each other) and the electrical contacts 285 of the dock 280 may be located next to each other (e.g., horizontally spaced apart from each other). For example, the electrical contacts 275 of the bottom bar 240 may each be oriented vertically and the electrical contacts 285 of the dock 280 may each be oriented horizontally (or vis versa) to facilitate electrical connection between the respective electrical contacts 275, 285 when the bottom bar 240 is docked. Other variations are possible.

The electrical contacts 275 of the bottom bar 240 may be electrically connected to the energy storage elements in the bottom bar 240, and the electrical contacts 285 of the dock 280 may be electrically connected to the energy storage elements of the motor drive unit 250, such that that the energy storage elements of the motor drive unit 250 may charge from the energy storage elements of the bottom bar 240 when the bottom bar 240 is docked. For example, the electrical contacts 275 of the bottom bar 240 may be biased (e.g., spring-loaded) away from the rear surface 246 (e.g., biased towards the window) and/or the electrical contacts 285 of the dock 280 may be biased (e.g., spring-loaded) away from the contact surface 284 (e.g., biased towards the rear surface 234 of the covering material 230) to help establish and/or maintain electrical contact between the electrical contacts 275 of the bottom bar 240 and the electrical contacts 285 of the dock 280 when the bottom bar 240 is docked.

As noted, the electrical contacts 275 may be located at the housing 242 of the bottom bar 240. For example, the electrical contacts 275 may be proximate to the housing 242 of the bottom bar 240, adjacent to the housing 242 of the bottom bar 240, on the housing 242 of the bottom bar 240, supported by the housing 242 of the bottom bar 240, recessed within the housing 242 of the bottom bar 240, extending through the housing 242 of the bottom bar 240, and/or supported by different portions of the housing 242 and/or supported by to other structures supported by or connected to the housing 242 of the bottom bar 240. Alternatively or additionally, the electrical contacts 275 of the bottom bar 240 may be located on different surfaces of the bottom bar 240, such as on one of the end caps 244. In such examples, the dock 280 and the electrical contacts 285 of the dock 280 may be positioned such that the electrical contacts 285 of the dock 280 are aligned with the one of the end caps 244 of the bottom bar 240. Other variations are possible.

Since the motor drive unit 250 is powered from (e.g., entirely powered from) the solar cells 270 and is configured to communicate (via wires or wirelessly) with external devices, the window treatment assembly 210 may be mounted to essentially any mounting brackets—even mounting brackets for manually-operated window treatment assemblies. Accordingly, the window treatment assembly 210 may provide a retro-fit solution for upgrading a manually-operated window treatment to a motorized window treatment without the need to replace the mounting brackets and/or run electrical wiring to the new motorized window treatment.

In some examples, the motor drive unit 250 may include an electrical terminal (not shown) that is configured to allow for an external power source to jump start the motor drive unit 250 or recharge the motor drive unit 250 (e.g., if the motor drive unit 250 is uncharged and/or not performing well). In some examples, the electrical terminal may be a standard power supply connector (e.g., a Universal Serial Bus (USB) connector). As such, the motor drive unit 250 (e.g., the energy storage element of the motor drive unit 250) could receive power from an external power source.

Although it is described herein that the motorized window treatment 200 comprises the bottom bar 240 that includes the solar cells 270 and that is configured to charge the motor drive unit 250, other configurations of the motorized window treatment 200 may be possible. In some examples, the bottom bar 240 may not be configured to charge the motor drive unit 250 (e.g., the solar cells 270 may power elements such as sensors that may be located on or in the bottom bar 240) or may be one source of energy for the motor drive unit 250 in addition to other sources. For example, the motor drive unit 250 may be powered from an external source and/or changeable and/or replaceable batteries, or may be powered from an external source and/or changeable and/or replaceable batteries in addition to the solar cells 270 of the bottom bar 240.

In some examples as described herein, the bottom bar 240 may include the solar cells 270 and the motor drive unit 250 may charge the energy storage element of the motor drive unit 250 when the bottom bar 240 is docked. Alternatively or additionally, the bottom bar 240 may include the solar cells 270, and one or more of the solar cells 270 may be configured to charge the energy storage element in the bottom bar 240 between docking events, or when docking is not possible. In some examples, the bottom bar 240 may not include the solar cells 270 (e.g., when there is a wired connection between the bottom bar 240 and the motor drive unit 250). For example, the bottom bar 240 may not include the solar cells 270 in examples where the bottom bar 240 is not able to or does not need to dock.

In some examples, the bottom bar 240 may include one or more sensors, such as an occupancy sensor, a vacancy sensor, a photosensor, etc., where the bottom bar 240 and/or the motor drive unit 250 may be configured to control the motorized window treatment 200 and/or external devices (e.g., such as lighting loads) based on feedback from the sensor(s). Such sensors may be powered by the solar cells 270 of the bottom bar 240. In some examples, the motor drive unit 250 may be configured to move the covering material 230 to the raised position P_{RAISED} or to the lowered position P_{LOWERED} based on feedback from the one or more sensors, e.g., if the sensors detect that the window is open. Further, in such examples, the housing 242 of the bottom bar 200 may include one or more openings for the sensors.

One will also appreciate that motorized window treatment 200, the window treatment assembly 210, and/or the motor drive unit 250 (e.g., and other motorized window treatments, other window treatment assemblies, and/or other motor drive units described herein) are not limited to the form of the first and second mounting brackets 220, 222 as described herein, the form of the motor drive unit 250 as described herein, or the form of the dock 280 as described herein. For example, the dock 280 may be integral with and/or part of one of the first and second mounting brackets 220, 222, and not the motor drive unit 250. Other variations are possible. For instance, in some examples, the dock 280 may be separate from the motor drive unit 250 and the bottom bar 240 (e.g., the dock 280 may be coupled to, for example screwed into, the wall or window frame and one or more wires may be used to electrically connect the dock 280 to the motor drive unit 250). One will also appreciate that while the motorized window treatment 200 and/or the window treatment assembly 210 (e.g., and other motorized window treatments and/or other window treatment assemblies described herein) are described as covering a window and receiving solar energy from outside a building for example, the motorized window treatments and/or window treatment assemblies may be configured as external blinds, shades, or awnings (such as for patio uses), or for skylights, moonroofs, etc.

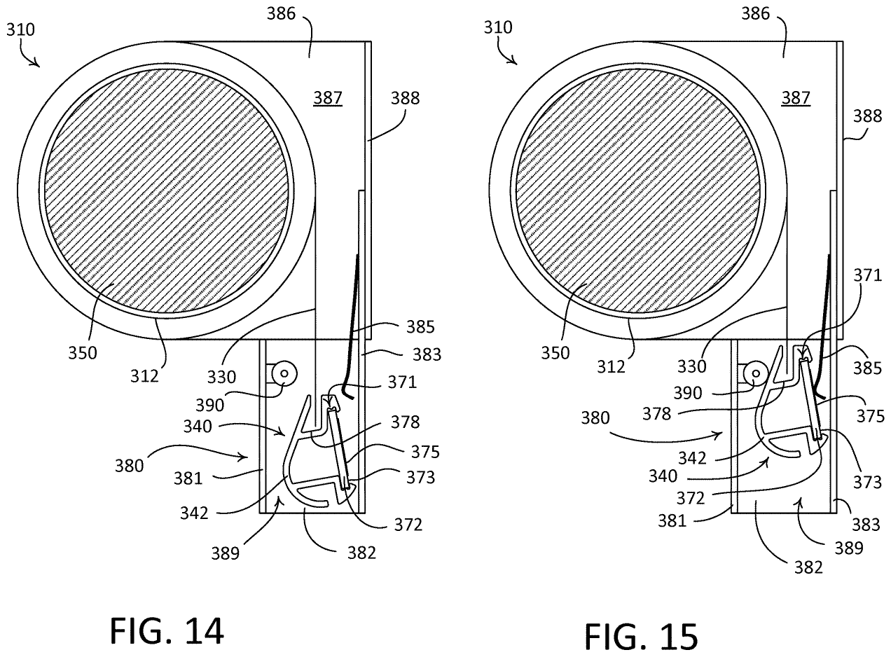

FIGS. 14 and 15 are right-side cross-section views of another example of a covering assembly, such as a window treatment assembly 310, for use in covering system, such as a motorized window treatment (e.g., the motorized window treatments 150 of the load control system 100 shown in FIG. 1 and/or the motorized window treatment 200 shown in FIG. 2). The window treatment assembly 310 may be coupled to (e.g., supported by) mounting brackets (e.g., such as the first and second mounting brackets 220, 222) that may be configured to be mounted (e.g., wall-mounted and/or ceiling-mounted) to a structure (e.g., a window frame, a wall, or other structure of a building). The window treatment assembly 310 may include a roller tube 312, a covering material 330, a bottom bar 340, a motor drive unit 350 at a first end of the roller tube 312, and an idler (not shown) (e.g., such as the idler 260) at a second end of the roller tube 312. The bottom bar 340 may comprise a housing 342 that may be secured to a bottom end of the covering material 330, and may be configured (e.g., weighted) to cause the covering material 330 to hang vertically (e.g., to cover a window, such as window that is proximate to the motorized window treatment 200, the motorized window treatments 150, etc.). While not shown in FIGS. 14 and 15, the bottom end of the covering material 330 may be coupled, for example, to an elongated member (not shown) that may extend through a cavity 378 of the housing 342 of the bottom bar 340 for securing the bottom end of the covering material 330 to the bottom bar 340.

The roller tube 312 of the window treatment assembly 310 may be rotatably mounted to (e.g., rotatably supported by) the mounting brackets. The covering material 330 may be windingly attached to the roller tube 312, such that rotation of the roller tube 312 causes the covering material 330 to wind around or unwind from the roller tube 312 to move the covering material 330 between a raised position P_{RAISED} (e.g., a fully-raised position and/or a fully-open position) and a lowered position P_{LOWERED} (e.g., a fully-lowered position and/or a fully-closed position). The window treatment assembly 310 (e.g., the motor drive unit 350) may be configured to cause the bottom bar 340 and the covering material 330 to be moved into a docked position P_{DOCKED} (e.g., as shown in FIG. 15), which may be the position of the covering material 330 (e.g., the bottom bar 340) when the bottom bar 340 is adjacent to (e.g., in electrical connection with) a dock 380 of the motor drive unit 350, for example, as described in more detail below. The docked position P_{DOCKED} may be, in some examples, above the raised position P_{RAISED} such that the raised position P_{RAISED} is between the lowered position P_{LOWERED} and the docked position P_{DOCKED}. The motor drive unit 350 may be similar to the motor drive unit 250 shown in FIGS. 7 and 8, and may be coupled to the roller tube 312 for rotating the roller tube 312 to raise and lower the covering material 330.

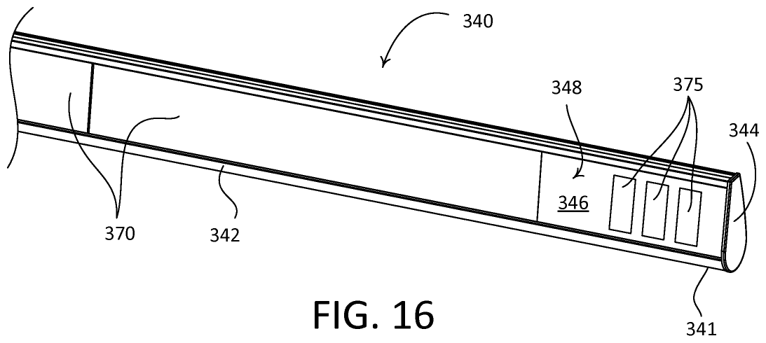

FIG. 16 is a partial enlarged rear perspective view of the bottom bar 340. The bottom bar 340 may extend from a first end 341 to a second end (not shown). For example, the bottom bar 340 may comprise end caps 344 connected to the first end 341 and the second end of the bottom bar 340 (e.g., the end cap connected to the second end of the bottom bar 340 is not shown in FIGS. 14-16). The bottom bar 340 may comprise one or more solar cells 370 (e.g., photovoltaic cells). The solar cells 370 may be located at the housing 342 of the bottom bar 340. For example, the he solar cells 370 may be attached to a rear surface 346 of the housing 342 of the bottom bar 340, such that the solar cells 370 face a window for example (e.g., that the covering material 330 is configured to cover) and are able to receive solar energy from outside the building for example (e.g., from the sun). The bottom bar 340 may comprise a printed circuit board 372 configured to be located in a channel 371 in the housing 342, such that an outer surface 373 of the printed circuit board 372 forms at least a portion of the rear surface 346 of the bottom bar 340. The solar cells 370 may be mounted to the outer surface 373 of the printed circuit board 372, and may be located within a recess 348 in the housing 342 relative to the rear surface 346 of the housing 342 and formed by the printed circuit board 372 and the housing 342. The rear surface 346 of the housing 342 of the bottom bar 340 may be oriented at an angle from a vertical axis (e.g., such as the angle θ_{SC1} at which the rear surface 246 of the bottom bar 240 is oriented from the vertical axis V, as shown in FIG. 6), such that the solar cells 370 may be angled upwards (e.g., towards the sky to maximize the amount of sunlight that may shine on the solar cells 370).

The solar cells 370 may be electrically connected to one or more energy storage elements (not shown) contained within the housing 342 of the bottom bar 340. For example, the energy storage elements of the bottom bar 340 may comprise one or more of rechargeable batteries and/or supercapacitors. The solar cells 370 may be configured to convert the received solar energy into a photovoltaic output voltage, which may be used to charge the energy storage elements located within the housing 342 of the bottom bar 340 (e.g., to generate a storage voltage across the energy storage elements). The energy stored in the energy storage elements of the bottom bar 340 may be discharged into one or more energy storage elements of the motor drive unit 350 when the bottom bar 340 is close to the motor drive unit 350, for example, when the covering material 330 is in the docked position P_{DOCKED}. For example, the motor drive unit 350 may comprise one or more energy storage elements (not shown) configured to charge from the energy storage elements of the bottom bar 340 when the covering material 330 is in the docked position P_{DOCKED}. For example, the energy storage elements of the motor drive unit 350 may comprise one or more of rechargeable batteries and/or supercapacitors and be configured to power the motor and/or other circuity of the motor drive unit 350.

As shown in FIGS. 14 and 15, for example, the dock 380 of the motor drive unit 350 may be configured to facilitate discharging of the energy storage elements of the bottom bar 340 into the energy storage elements of the motor drive unit 350, for example, when the covering material 330 is in the docked position P_{DOCKED} (e.g., when the bottom bar 340 is docked). For example, the bottom bar 340 may be shown in an undocked position in FIG. 14, and a docked position in FIG. 15. The dock 380 may comprise a base portion 382 that defines a cavity 389 through which the covering material 330 may extend, such that the bottom bar 340 may be received within the cavity 389 of the base portion 382 (e.g., as the covering material 330 is raised). The bottom bar 340 may be configured to be positioned within the cavity 389 of the base portion 382 of the dock 380 when the bottom bar 340 is docked, such that the energy storage elements of the bottom bar 340 may discharge through the base portion 382 of the dock 380 into the energy storage elements of the motor drive unit 350.

The dock 380 may comprise two or more electrical contacts 385 (e.g., three electrical contacts, one being shown in the Figures) mechanically connected to the base portion 382. While only one electrical contact 385 can be seen in FIGS. 14 and 15, the electrical contacts 385 may be located side-by-side at (e.g., horizontally spaced apart along) the base portion 382. The electrical contacts 385 may comprise respective spring contacts that are biased away from the base portion 382 (e.g., towards the roller tube 312, the covering material 330, and/or the bottom bar 340). The dock 380 (e.g., the electrical contacts 385) may be electrically coupled to the motor drive unit 350. For example, the base portion 382 of the dock 380 may be electrically coupled to the motor drive unit 350 via two or more electrical conductors (e.g., wires) extending between the base portion 382 of the dock 380 and an end portion of the motor drive unit 350 as similarly described herein. The base portion 382 of the dock 380 may be connected to the end portion of the motor drive unit 350 via an attachment member 386 (e.g., in a similar manner that the attachment member 286 connects the dock 280 to the end portion 255 of the motor drive unit 250). The attachment member 386 may comprise a plate 387 and an arm 388 that is oriented at an angle (e.g., approximately 90°) from the plate 387. For example, the attachment member 386 (e.g., the plate 387) may be affixed to and/or formed as a part of (e.g., integral with) the motor drive unit 350. In some examples, the attachment member 386 may be affixed to and/or formed as a part of the mounting bracket that supports the motor drive unit 350 as described herein. Other variations are possible.

The bottom bar 340 may comprise two or more electrical contacts 375 located at the rear surface 346 of the bottom bar 340 (e.g., three electrical contacts 375 as shown in FIG. 16), each of which may correspond to the electrical contacts 385 of the dock 380. Each of the electrical contacts 375 on the bottom bar 340 may be, for example, a planar piece of conductive material (e.g., rectangularly shaped). When the bottom bar 340 is docked, the electrical contacts 385 of the dock 380 may be configured to contact the electrical contacts 375 on the bottom bar 340. The electrical contacts 375 on the bottom bar 340 may be electrically connected to the energy storage elements in the bottom bar 340, and the electrical contacts 385 of the dock 380 may be electrically connected to the energy storage elements of the motor drive unit 350. The energy storage elements of the motor drive unit 350 may charge from the energy storage elements of the bottom bar 340 when the bottom bar 340 is docked.

The dock 380 may comprise one or more biasing members 390 extending from a first wall 381 (e.g., a front wall) of the base portion 382. The biasing member 390 may be configured to push against the bottom bar 340 when the bottom bar 340 is docked to hold the electrical contacts 375 on the bottom bar 340 against the electrical contacts 385 of the dock 380 (e.g., as shown in FIG. 15). The electrical contacts 385 of the of the dock 380 may be secured at a proximal end against a second wall 383 (e.g., a rear wall) of the base portion 382. For example, the biasing member 390 may comprise a roller configured to roll against a front surface opposite the rear surface 346 of the bottom bar 340. In addition, the bottom bar 340 and/or the base portion of the dock 380 may comprise one or more magnets and/or metallic portions (e.g., located proximate to and/or adjacent to the electrical contacts 375, 385) that may be magnetically attracted to each other when the electrical contacts 375 on the bottom bar 340 are located adjacent to the electrical contacts 385 of the dock 380 to pull the electrical contacts 375, 385 together.

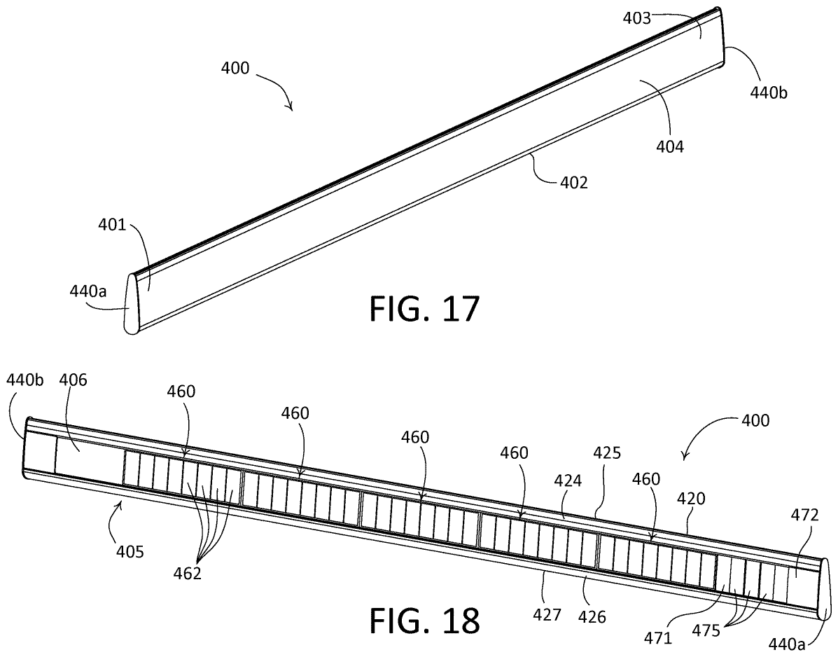

FIG. 17 is a front perspective view and FIG. 18 is a rear perspective view of another example of a bottom bar 400 (e.g., similar to the bottom bars 240, 340) for use in a covering system, such as a motorized window treatment (e.g., the motorized window treatments 150 of the load control system 100 and/or the motorized window treatment 200). The motorized window treatment may comprise a covering assembly, such as a window treatment assembly (e.g., window treatment assemblies 210, 310), and one or more mounting brackets (e.g., such as the first and second mounting brackets 220, 222). The one or more mounting brackets may be configured to be coupled to or otherwise mounted to a structure (e.g., such as a window frame, a wall, a ceiling, or other structure of a building), such that the motorized window treatment may be mounted proximate to an opening (e.g., over the opening or in the opening), such as a window for example. The one or more mounting brackets may be configured to be mounted to a vertical structure (e.g., wall-mounted to a wall) and/or mounted to a horizontal structure (e.g., ceiling-mounted to a ceiling). The window treatment assembly may be coupled to (e.g., supported by) the one or more mounting brackets. The window treatment assembly may include a roller tube (e.g., similar to the roller tubes 212, 312), a covering material (e.g., similar to the covering materials 230, 330), the bottom bar 400, a motor drive unit (e.g., similar to the motor drive units 250, 350), and an idler (e.g., similar to the idler 260). One will appreciate that other variations of a motorized window treatment that are functionally operative with the bottom bar 400 are possible.

The bottom bar 400 may be configured to be connected to a bottom edge of the covering material. The bottom bar 400 may comprise a housing 402 having first and second ends 401, 403. In some examples, the bottom end of the covering material may be received within the housing 402 and secured to the bottom bar 400 inside the housing 402. The bottom bar 400 may also comprise, for example, end caps, such as a first end cap 440a connected to the first end 401 of the bottom bar 400 and a second end cap 440b connected to the second end 403 of the bottom bar 400. In addition, the bottom bar 400 (e.g., the housing 402) may be configured, for example weighted, to cause the covering material to hang vertically. The bottom bar 400 (e.g., the housing 402) may comprise a front surface 404 and a rear surface 406.

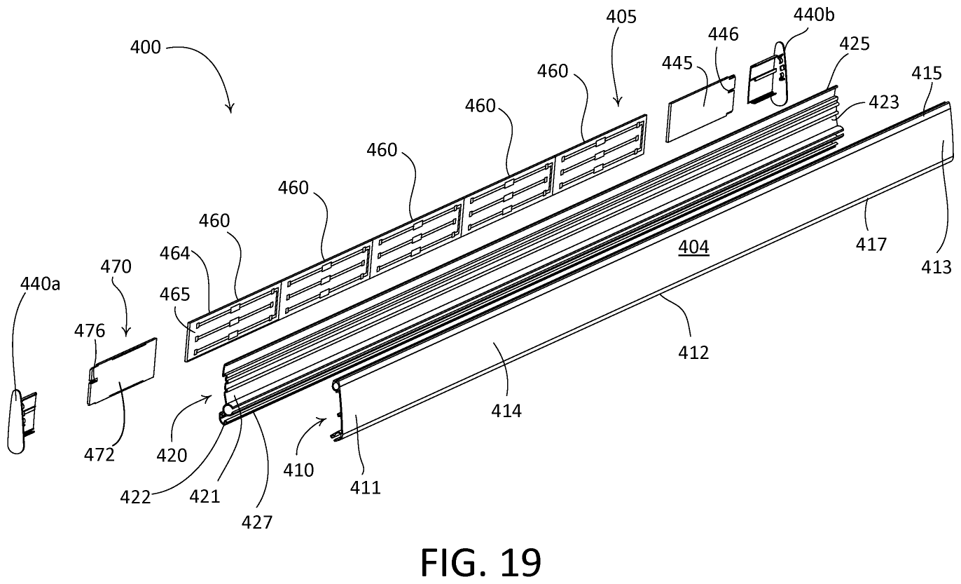

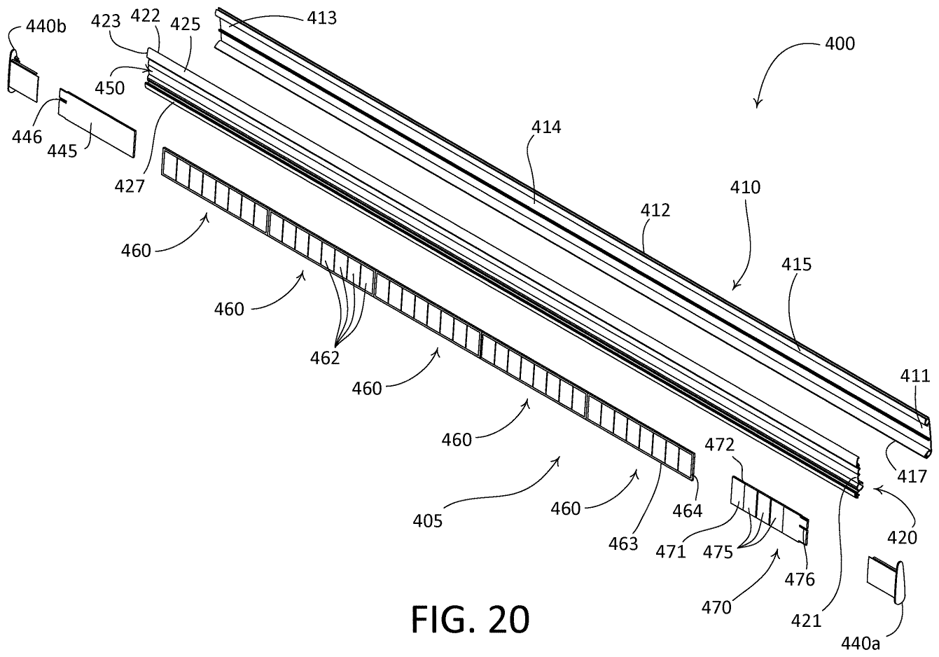

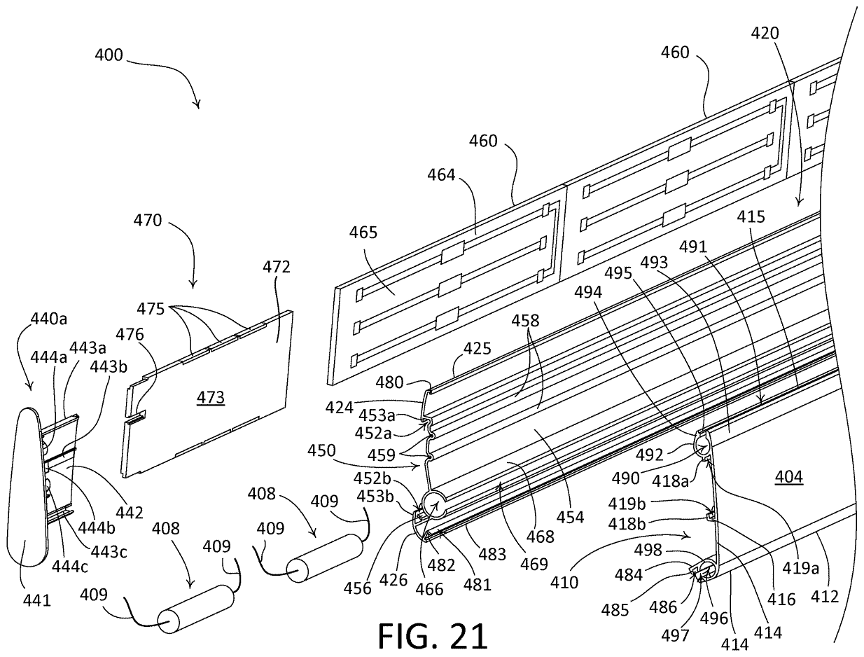

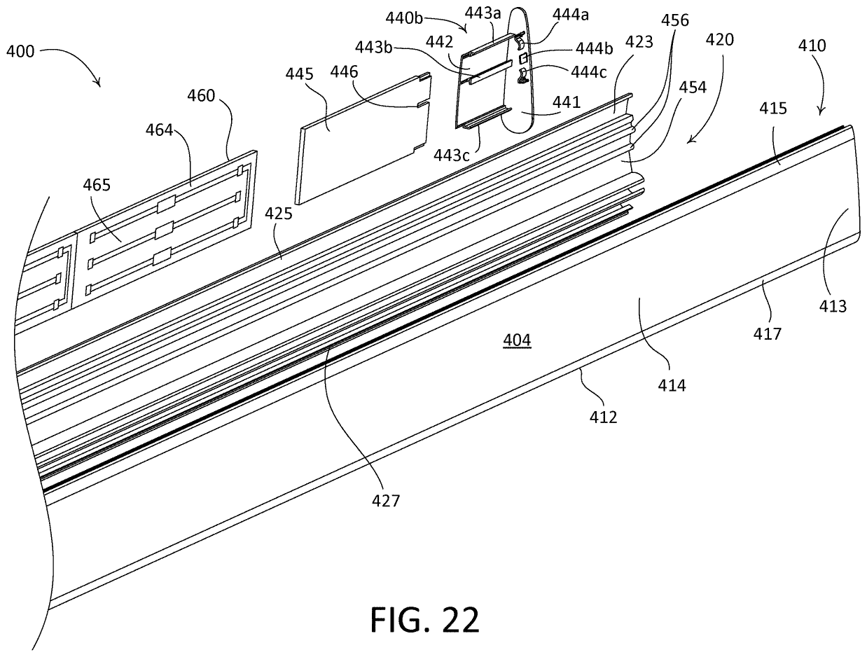

FIG. 19 is a front exploded view and FIG. 20 is a rear exploded view of the bottom bar 400. The housing 402 of the bottom bar 400 may comprise a first housing portion 410 (e.g., a front housing portion) and a second housing portion 420 (e.g., a rear housing portion). The second housing portion 420 may be configured to be attached (e.g., removably attached) to the first housing portion 410. The first housing portion 410 may comprise a body 412 extending from a first end 411 to a second end 413. The body 412 of the first housing portion 410 may comprise a front wall 414 that may extend from an upper end 415 to an opposing lower end 417 of the body 412, and may define the front surface 404 of the bottom bar 400. The second housing portion 420 may comprise a body 422 extending from a first end 421 to a second end 423. The body 422 of the second housing portion 420 may comprise an upper rear wall 424 at an upper end 425 of the body 422 and an opposing lower rear wall 426 at an opposing lower end 427 of the body 422. The body 422 of the second housing portion 420 may be configured to be connected to the body 412 of the first housing portion 410 (e.g., as will be described in greater detail below). FIG. 21 is an enlarged partial exploded view of the first end 401 of the bottom bar 400 (e.g., showing the first end 411 of the body 412 of the first housing portion 410 and the first end 421 of the body 422 of the second housing portion 420 in greater detail). FIG. 22 is an enlarged partial exploded view of the second end 403 of the bottom bar 400 (e.g., showing the second end 413 of the body 412 of the first housing portion 410 and the second end 423 of the body 422 of the second housing portion 420 in greater detail).

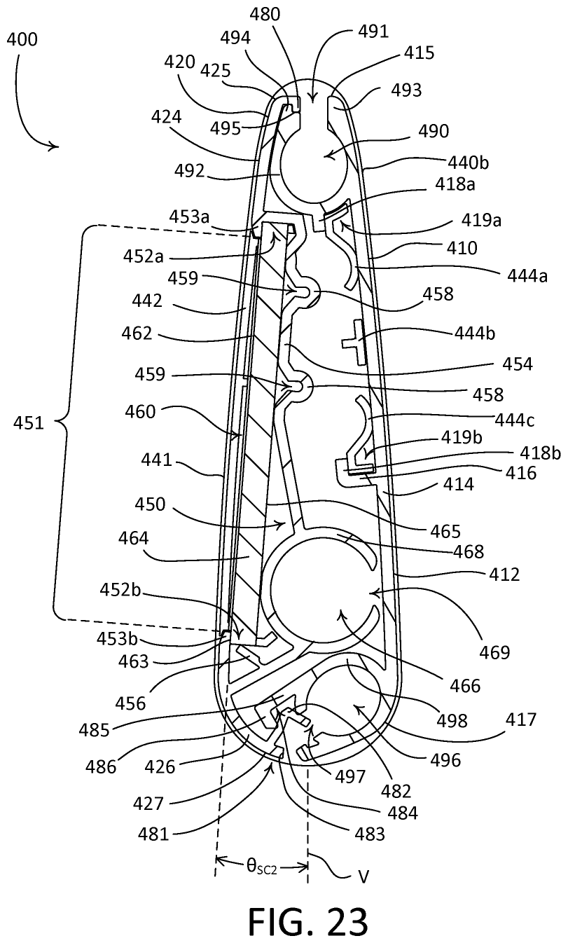

FIG. 23 is a side cross-section view of the bottom bar 400.

The first housing portion 410 may be a main housing element (e.g., a primary housing element) of the bottom bar 400. In some examples, the first housing portion 410 (e.g., the front wall 414) may provide an aesthetically-pleasing appearance, such that the first housing portion 410 may be a decorative element of the bottom bar 400. In addition, the first housing portion 410 may also operate as a weighting element of the bottom bar 400. For example, the first housing portion 410 may be made of metal. The first housing portion 410 may be configured to be connected to (e.g., attached to) the covering material of the motorized window treatment (e.g., even when the first housing portion 410 is decoupled from the remaining portions of the bottom bar 400, including the second housing portion 420). The body 412 of the first housing portion 410 may comprise a first cavity 490 proximate to the upper end 415 and that is defined by a first curved wall 492 (e.g., an oval-shaped wall) and that may extend for the length of the first housing portion 410 (e.g., from the first end 411 to the second end 413 of the body 412). The first cavity 490 may be configured to receive the bottom end of the covering material of the motorized window treatment. For example, the first curved wall 492 may define a slot 491 proximate to the upper end 415 (e.g., an elongated slot) and that may extend for the length of the first housing portion 410 (e.g., from the first end 411 to the second end 413 of the body 412). The first curved wall 492 may define a front lip 493 and a rear lip 494 located on both sides of the slot 491. The covering material (e.g., the bottom end of the covering material) may be received through the slot 491 and into the first cavity 490 (e.g., between the front and rear lips 493, 494 defined by the first curved wall 492).

In some examples, the bottom bar 400 (e.g., the first housing portion 410) may be fabric-wrapped, for example, by the covering material. In such an example, the covering material may extend from the first cavity 490 of the first housing portion 410 to a second cavity 496 of the first housing portion 410 that is proximate to the lower end 417, such that the covering material extends across the front surface 404 of the bottom bar 400 (e.g., across the front wall 414 of the first housing portion 410). The second cavity 496 may be defined by a second curved wall 498 that is proximate to the lower end 417 (e.g., an oval-shaped wall) and that may extend for the length of the first housing portion 410 (e.g., from the first end 411 to the second end 413 of the body 412). The front wall 414 of the first housing portion 410 may extend between the first curved wall 492 and the second curved wall 498. The second cavity 496 may be configured to receive the bottom end of the covering material of the motorized window treatment. For example, the second curved wall 498 may define a slot 497 that is proximate to the lower end 417 (e.g., an elongated slot) and that may extend for the length of the first housing portion 410 (e.g., from the first end 411 to the second end 413 of the body 412). The covering material (e.g., an intermediate portion of the covering material above the bottom end of the covering material) may enter the first cavity 490 through the slot 491 of the first curved wall 492, wrap around an element (e.g., a spline) within the first cavity 490, then exit the first cavity 490 through the slot 491 of the first curved wall 492. The covering material (e.g., the bottom end of the covering material) may enter the second cavity 496 through the slot 497 of the second curved wall 498.

The bottom bar 400 may comprise a bottom bar module 405 that includes a solar power system that includes one or more solar cell modules 460, one or more energy storage elements 408, a solar cell management circuit, a charging circuit, and a control circuit as further described herein. The solar power system may be configured to charge an energy storage element of the motor drive unit of the motorized window treatment (e.g., as will be described in greater detail below). The bottom bar module 405 and the second housing portion 420 may be configured such that, in one aspect, the bottom bar module 405 may be considered to include the second housing portion 420 of the housing 402 of the bottom bar 400. The second housing portion 420 of the housing 402 may operate as a support element of the bottom bar 400 and may be configured to support one or more components of the bottom bar module 405 (e.g., as will be described in greater detail below).

The one or more solar cell modules 460 of the bottom bar module 405 may each include one or more solar cells 462 (e.g., photovoltaic cells). The solar cells 462 may be located at the bottom bar module 405. Each of the solar cell modules 460 may comprise a substrate 464 (e.g., such as a printed circuit board), which may have an outer surface 463 and an opposing inner surface 465. The solar cells 462 of each of the solar cell modules 460 may be mounted to the outer surface 463 of the respective substrate 464. Each of the solar cell modules 460 may comprise, for example, eight solar cells 462, although other variations are possible. For example, the solar cell modules 460 may each comprise four pairs of the solar cells 462, where each solar cell 462 of the pair of the solar cells 462 is series-coupled, and where the four pairs of the solar cells 462 are coupled in parallel (e.g., in a 2S4P configuration).

The solar cell modules 460 may be supported by the second housing portion 420 of the housing 402 of the bottom bar 400. For example, the solar cell modules 460 may be received in a recess 450 of the second housing portion 420 of the housing 402. The recess 450 may be located proximate to the rear surface 406 of the housing/opposite the front wall 414 of the first housing portion 410 (e.g., facing the window and/or on the same side as the rear surface of the covering material), and may be further located between the upper rear wall 424 and the lower rear wall 426 of the second housing portion 420. The outer surfaces 463 of the substrates 464 of the solar cell modules 460 may face the window and/or be on the same side as the rear surface of the covering material, and the inner surfaces 465 of the substrates 464 of the solar cell modules 460 may face the recess 450 of the second housing portion 420 of the housing 402.

The second housing portion 420 may include first and second opposing channels 452a, 452b proximate the upper rear wall 424 and the lower rear wall 426 respectively and that may be located within the recess 450 and may be configured to receive the substrates 464 of the respective solar cell modules 460 (e.g., as shown in FIG. 23). The second housing portion 420 may comprise an upper flange 453a extending from the upper rear wall 424 and into the recess 450. The second housing portion 420 may comprise a lower flange 453b (that opposes the upper flange 453a) extending from the lower rear wall 426 and into the recess 450 towards the upper flange 453a. The first and second channels 452a, 452b may be formed by the respective upper and lower flanges 453a, 453b and a surface of a rear wall 454 of the second housing portion 420, where the surface of the rear wall 454 forms part of the recess 450 of the second housing portion 420 of the housing 402. The recess 450 and the first and second channels 452a, 452b may extend the length of the second housing portion 420 (e.g., from the first end 421 to the second end 423 of the body 422). One will appreciate that other variations are possible (e.g., the first and/or second channels 452a, 452b may extend intermittently for the length of the second housing portion 420).

The solar cell modules 460 (e.g., the substrates 464 of the respective solar cell modules 460) may be received in the first and second channels 452a, 452b and may be located in the recess 450. The solar cell modules 460 (e.g., the substrates 464 of the respective solar cell modules 460) may be retained in the recess 450 by the upper and lower flanges 453a, 453b. The second housing portion 420 may define a gap 451 between the upper and lower flanges 453a, 453b (e.g., as shown in FIG. 23). The solar cells 462 of the respective solar cell modules 460 may be located within the gap 451 between the upper and lower flanges 453a, 453b, and may be exposed to sunlight received through the gap 451. The solar cells 462 and the outer surfaces 463 of the respective substrates 464 (e.g., that are located within the gap 451) may form at least a portion of the rear surface 406 of the bottom bar 400. For example, the substrate 464 of each of the solar cell modules 460 may be configured to slide into the recess 450 (e.g., via the first and second channels 452a, 452b) from either the first end 421 or the second end 423 of the second housing portion 420 of the bottom bar 400. The second housing portion 420 may further comprise a biasing member 456 located in the first channel 452a and/or the second channel 452b (e.g., shown in the second channel in FIG. 21). The biasing member 456 may be configured to contact a respective surface of the substrates 464 (e.g., the inner surfaces 465 of the substrates 464) of the respective solar cell modules 460 to push the substrates 464 up into the opposing channels—here the first channel 452a (e.g., to maintain alignment of the adjacent solar cell modules 460 within the recess 450). One will appreciate other configurations are possible to maintain alignment of the solar cell modules 460 within the recess 450. The first and second end caps 440a, 440b may be attached to the bottom bar 400 once the solar cell modules 460 are slid into the recess 450, and may further contain the solar cell modules 460 in the recess 450.

The rear surface 406 of the housing 402 of the bottom bar 400 (e.g., the solar cells 462 and/or the outer surfaces 463 of the substrates 464 of the respective solar cell modules 460) may be oriented at an angle θ_{SC2} from a vertical axis V (e.g., with respect to the covering material of the motorized window treatment), such that the solar cells 462 of the respective solar cell modules 460 may be angled upwards (e.g., angled up slightly towards the sky to increase the amount of sunlight that may shine on the solar cells 462). The housing 402 and the end caps 440a, 440b may define, for example, a teardrop shape as shown in FIG. 23, but could define other shapes, such as a triangular shape or a polygon shape having an angled rear surface. For example, the angle θ_{SC2} at which the solar cells 462 are oriented may be in the range of approximately 2° to 30° (e.g., approximately 3.66°). In some examples, the solar cells 462 may be oriented vertically (e.g., in parallel with the shade fabric). Further, in some examples, the bottom bar 400 may include one or more solar cells attached to the front surface 404 of the housing 402 of the bottom bar 400 (e.g., to receive solar energy from outside the building), for instance, in addition to the solar cells 462 of the solar cell modules 460 mounted at the rear surface 406 of the housing 402 of the bottom bar 400. Other variations are possible.

The one or more energy storage elements 408 of the bottom bar module 405 may be charged from the solar cells 462 of the respective solar cell modules 460 by the solar power system (e.g., as will be described in greater detail below). For example, the energy storage elements 408 of the bottom bar 400 may comprise one or more of supercapacitors and/or rechargeable batteries coupled in parallel and/or in series. The energy storage elements 408 may each comprise or be connected to electrical conductors, such as wires 409 (e.g., two wires), to allow for electrical connection of the energy storage elements 408 to electrical circuitry of the solar power system of the bottom bar module 405. The solar cells 462 may be configured to convert the received solar energy into a photovoltaic output voltage, which may be used to charge the energy storage elements 408 (e.g., to generate a storage voltage across the energy storage elements 408).

The energy storage elements 408 may be received in a cavity 466 of the housing 402 (e.g., the second housing portion 420) of the bottom bar 400. The cavity 466 may be defined by, for example, a cylindrical wall 468 of the housing 402 (e.g., the second housing portion 420) of the bottom bar 400. For example, the cylindrical wall 468 may extend along the length of the second housing portion 420 (e.g., from the first end 421 to the second end 423 of the body 422), such the cavity 466 extends for the length of the second housing portion 420 and is oriented parallel to the recess 450 of the second housing portion 420. In other examples, the cylindrical wall 468 may extend along a portion of the length of the second housing portion 420 such the cavity 466 only extends along a portion of the length of the second housing portion 420. In other examples, the cylindrical wall 468 and the cavity 466 need not be oriented in this fashion to extend along the length of the second housing portion 420 and/or extend parallel to the recess 450. In some examples, the substrates 464 of the respective solar cell modules 460 may be configured to abut the cylindrical wall 468 when the solar cell modules 460 are installed in the recess 450. For example, the energy storage elements 408 may each be cylindrical in shape to fit within the cavity 466 defined by the cylindrical wall 468 of the second housing portion 420. The energy storage elements 408 and the cavity 466 may be configured such that the energy storage elements 408 fit within the cavity 466 and may be further configured such that the energy storage elements 408 may be slid into the cavity 466 from either the first end 421 or the second end 423 of the body 422 of the second housing portion 420. The end caps 440a, 440b may be attached to the bottom bar 400 once the energy storage elements 408 are slid into the cavity 466, and may further contain the energy storage elements 408 within the cavity 466. The cylindrical wall 468 may define a slot 469 that extends for the length of the cavity 466 (e.g., from the first end 421 to the second end 423 of the body 422 of the second housing portion 420). The slot 469 may allow the cylindrical wall 468 to move apart/open when the energy storage element 408 is inserted therein, thereby securing the energy storage element 408 in the cavity 466 by friction fit. In addition, the wires 409 of the energy storage elements 408 may extend through the slot 469 to be electrically connected to the electrical circuitry of the solar power system of the bottom bar module 405. One will appreciate that the cavity 466 need not be cylindrical in shape. According to a further aspect, the energy storage elements 408 may be removable from the cavity 466.

The rear wall 454 of the recess 450 may comprise one or more ribs 458 that may extend along the length (or intermittently along the length) of the second housing portion 420 (e.g., from the first end 421 to the second end 423 of the body 422, or along a portion of this length). For example, the ribs 458 may each be formed by a U-shaped portion formed in the rear wall 454 of the recess 450 (e.g., as shown in FIG. 23), although other configurations are possible. The ribs 458 may each also define a respective groove 459 in the rear wall 454 of the recess 450 (e.g., as shown in FIGS. 21 and 23). When the second housing portion 420 is detached from the first housing portion 410, the second housing portion 420 may be flexed to enlarge the gap 451 between the upper and lower flanges 453a, 453b, such that the solar cell modules 460 may be removed from and/or installed into the recess 450 via the gap 451 rather than by sliding into the recess 450, as described above.

For example, the ribs 458 (e.g., the U-shaped portions of the rear wall 454) may improve the flexibility of the second housing portion 420 to allow for such installation and/or removal of the solar cell modules 460. Other configurations of the second housing portion 420 are possible to provide such flexibility.

The bottom bar module 405 may further comprise a printed circuit board (PCB) assembly 470 (e.g., a bottom bar printed circuit board assembly). The printed circuit board assembly 470 may comprise a printed circuit board 472, which may have an outer surface 471 and an opposing inner surface 473. The outer surface 471 may face the window and/or be on the same side as the rear surface of the covering material, and the inner surface 473 may face the recess 450. For example, the printed circuit board assembly 470 may comprise the electrical circuitry of the solar power system of the bottom bar module 405, and the electrical circuity may be mounted to the printed circuit board 472 (e.g., to the inner surface 473 of the printed circuit board 472). The electrical circuitry of the solar power system of the bottom bar module 405 mounted to the printed circuit board 472 (e.g., the printed circuit board assembly 470) may comprise a solar cell management circuit configured to charge the energy storage elements 408 of the bottom bar module 405 from the photovoltaic output voltage generated by the solar cells 462 of the solar cell modules 460. For example, the wires 409 of the energy storage elements 408 may be electrically connected to the solar cell management circuit on the printed circuit board 472. In addition, the solar cells 462 of the solar cell modules 460 may be electrically connected to the solar cell management circuit on the printed circuit board 472 via two or more electrical conductors (e.g., wires-not shown). For example, the electrical conductors may be electrically connected to (e.g., soldered to) electrical contacts (e.g., electrical pads) on the inner surfaces 465 of the substrates 464 of the respective solar cell modules 460. In one example, the wires 409 between the printed circuit board 472 and the energy storage elements 408 and/or the electrical conductors between the printed circuit board 472 and the solar cells 462 of the solar cell modules 460 may include connectors and/or plugs in various configurations that allow the energy storage elements 408 and/or the solar cells 462 and/or the printed circuit board 472 to be detached from one another in order to be replaced, for example. The grooves 459 defined by the ribs 458 in the rear wall 454 of the second housing portion 420 may each be configured to receive one or more of the electrical conductors (e.g., wires) that extend between the solar cell modules 460 and the printed circuit board 472 of the printed circuit board assembly 470 located in the recess 450, although other variations are possible.

The printed circuit board assembly 470 may be supported by the second housing portion 420 of the housing 402 of the bottom bar 400. For example, the printed circuit board assembly 470 may be received in the recess 450 of the second housing portion 420 of the housing 402 (e.g., adjacent to the solar cell modules 460). The first and second channels 452a, 452b in the recess 450 of the second housing portion 420 may be configured to receive (e.g., slidingly receive) the printed circuit board 472 of the printed circuit board assembly 470. The printed circuit board 472 of the printed circuit board assembly 470 may be received in the first and second channels 452a, 452b and may be located in the recess 450, such that the outer surface 471 of the printed circuit board 472 forms at least a portion of the rear surface 406 of the bottom bar 400. For example, the printed circuit board 472 may be configured to slide into the recess 450 (e.g., via the first and second channels 452a, 452b) from either the first end 421 or the second end 423 of the second housing portion 420 of the bottom bar 400 (e.g., after the solar cell modules 460 are installed in the recess 450), and the first and second end caps 440a, 440b may then be installed to retain the printed circuit board 472 in the bottom bar 400. As another example, the second housing portion 420 may be flexed to enlarge the gap 451 between the upper and lower flanges 453a, 453b, such that the printed circuit board 472 may be removed from and/or installed into the recess 450 via the gap 451, rather than by sliding into the recess 450 as described above. The printed circuit board 472 of the printed circuit board assembly 470 may be located in the recess 450 between the first end cap 440a and the solar cell modules 460 (e.g., as shown in FIG. 21). In addition, the bottom bar module 405 may comprise one or more spacer boards 445 located between the second end cap 440b and the solar cell module 460 (e.g., as shown in FIG. 22). For example, the spacer board 445 may be a substrate, such as a printed circuit board (e.g., the spacer board 445 may be made from the same material as the printed circuit board 472 of the printed circuit board assembly 470).

The bottom bar 400 (e.g., the bottom bar module 405) may comprise two or more electrical contacts 475 (e.g., three electrical contacts as shown in FIGS. 18 and 20) at the rear surface 406 of the bottom bar 400 (e.g., at the first end 401 of the bottom bar 400). For example, the electrical contacts 475 may be accessible at the rear surface 460 of the bottom bar 400. The electrical contacts 475 of the bottom bar 400 may be located next to each other (e.g., horizontally spaced apart from each other). For example, the electrical contacts 475 may be arranged (e.g., located) on the outer surface 471 of the printed circuit board 472 of the printed circuit board assembly 470. The electrical contacts 475 may be electrically connected to the electrical circuitry of the solar power system of the bottom bar module 405 mounted to the printed circuit board 472. In some examples, the electrical contacts 475 may extend through the housing 402 of the bottom bar 400.

When the bottom bar 400 is docked with the motor drive unit (e.g., when the covering material is in the docked position P_{DOCKED}), the electrical contacts 475 of the bottom bar 400 may be configured to contact respective electrical contacts of the dock (e.g., such as the electrical contacts 285, 385 of the dock 280 or 380 shown in FIGS. 8, 14, and 15). The electrical contacts of the dock may be, for example, biased (e.g., spring-loaded) towards the electrical contacts 475 of the bottom bar 400 to help establish and/or maintain the electrical contact between the electrical contacts 475 of the bottom bar 400 and the electrical contacts of the dock when the bottom bar 400 is docked.

In some examples, the bottom bar module 405 may not comprise the electrical contacts 475, but may alternatively comprise one or more induction coils with one or more corresponding induction coils located on the dock (e.g., the dock 280 or 380) (e.g., a first induction coil included in the bottom bar 400 and a second induction coil included in the dock) to facilitate inductive coupling (e.g., magnetic coupling) between the bottom bar module 405 and the dock. In such examples, when the covering material is in the docked position P_{DOCKED} (e.g., when the bottom bar 400 is docked), the induction coil of the bottom bar module 405 may be inductively coupled to the induction coil of the dock, such that the energy storage elements of the motor drive unit may be configured to charge from the energy storage elements 408 of the bottom bar module 405 via the charging circuit.

The energy stored in the energy storage elements 408 of the bottom bar 400 may be discharged into the energy storage elements of the motor drive unit when the bottom bar 400 is docked with the motor drive unit, for example, when the bottom bar 400 is in the docked position P_{DOCKED}. For example, the motor drive unit may comprise one or more energy storage elements (not shown) configured to charge from the energy storage elements 408 of the bottom bar 400 when the covering material is in the docked position P_{DOCKED}. For example, the electrical circuitry of the solar power system of the bottom bar module 405 mounted to the printed circuit board 472 (e.g., the printed circuit board assembly 470) may comprise a charging circuit electrically connected to the energy storage elements 408 and the electrical contacts 475, such that the energy storage elements of the motor drive unit are configured to charge from the energy storage elements 408 of the bottom bar module 405 via the charging circuit of the solar power system when the bottom bar 400 is docked. In addition, the electrical circuitry of the solar power system of the bottom bar module 405 mounted to the printed circuit board 472 (e.g., the printed circuit board assembly 470) may comprise a control circuit (e.g., a microprocessor or other suitable processing device as described herein) configured to control the solar cell management circuit and/or the charging circuit mounted to the printed circuit board 472. In some examples, the energy storage elements 408 may be electrically connected (e.g., directly connected) to the electrical contacts 475 of the bottom bar 400 (e.g., the motor drive unit may comprise a charging circuit for charging the energy storage elements 408 of the bottom bar 400).

The first and second end caps 440a, 440b may be configured to be attached to the first housing portion 410 (e.g., to the first end 411 and the second end 413 of the body 412, respectively) and/or to the second housing portion 420 (e.g., to the first end 421 and the second end 423 of the body 422, respectively). For example, the second end cap 440b (e.g., as shown in FIG. 22) may be a mirror image of the first end cap 440a (e.g., as shown in FIG. 21). The first and second end caps 440a, 440b may each comprise an end portion 441 (e.g., a plate portion) and a cover portion 442 that extends from the end portion 441.

The first and second end caps 440a, 440b (e.g., the respective end portions 441) may be configured to hold the solar cell modules 460, the printed circuit board assembly 470, and the spacer board 445 within the recess 450 of the second housing portion 420 when the second housing portion 420 and the first and second end caps 440a, 440b are attached to the first housing portion 410. The first and second end caps 440a, 440b may each further comprise an upper rail 443a, a middle rail 443b, and a lower rail 443c (e.g., where the lower rail 443c is opposite the upper rail 443a, and where the middle rail 443b is between the upper and lower rails 443a, 443c), that each extend from and/or along the cover portion 442. The upper rail 443a of each of the first and second end caps 440a, 440b may be configured to be received within the first channel 452a of the recess 450 of the second housing portion 420. The lower rail 443c of each of the first and second end caps 440a, 440b may be configured to be received within the second channel 452b of the recess 450 of the second housing portion 420. The printed circuit board 472 of the printed circuit board assembly 470 may comprise a notch 476 configured to engage (e.g., receive) the middle rail 443b of the first end cap 440a. The spacer board 445 may comprise a notch 446 configured to engage (e.g., receive) the middle rail 443b of the second end cap 440b.

The first and second end caps 440a, 440b (e.g., the respective end portions 441) may be configured to cover (e.g., enclose) the recess 450 of the second housing portion 420 (e.g., respective portions of the recess 450 at the first end 421 and the second end 423 of the body 422 of the second housing portion 420) when the second housing portion 420 and the first and second end caps 440a, 440b are attached to the first housing portion 410. The first housing portion 410 may comprise a ledge 416 that extends from an interior surface (opposing the front surface 404) of the front wall 414 (e.g., towards the second housing portion 420). The first housing portion 410 may further comprise a first flange 418a extending from the first curved wall 492 and an opposing second flange 418b extending from the ledge 416. The front wall 414, the first curved wall 492, and the first flange 418a may form a first channel 419a of the first housing portion 410. The front wall 414, the ledge 416, and the second flange 418b may form a second channel 419b of the first housing portion 410. The first and second end caps 440a, 440b may each further comprise an upper attachment member 444a, a middle attachment member 444b, and a lower attachment member 444c (where the middle attachment member 444b is between the upper and lower attachment members 444a, 444c) that extend from the end portion 441 inwards towards the cover portion 442. The upper attachment member 444a of each of the first and second end caps 440a, 440b may be configured to be received within the first channel 419a of the first housing portion 410 and may abut the first curved wall 492 (e.g., as shown in FIG. 23). The lower attachment member 444c of each of the first and second end caps 440a, 440b may be configured to be received within the second channel 419b of the first housing portion 410 and may abut the ledge 416 (e.g., as shown in FIG. 23). The middle attachment member 444b of each of the first and second end caps 440a, 440b may be configured to abut the interior surface of the front wall 414 (e.g., as shown in FIG. 23). In addition, the upper attachment member 444a and the lower attachment member 444c may may be configured to abut the interior surface of the front wall 414 (e.g., as shown in FIG. 23).

The bottom bar module 405 (e.g., the second housing portion 420) may be removably attached to the first housing portion 410. For example, the second housing portion 420 may be detached from the first housing portion 410 while the first housing portion 410 remains coupled to the covering material to allow for servicing of the solar power system of the bottom bar module 405. The second housing portion 420 may comprise an attachment member, such as a catch 480 (e.g., a hook), that extends from the upper rear wall 424 and may be configured to be attached to (e.g., hooked over) the rear lip 494 of the first housing portion 410. For example, the catch 480 may be received in a notch 495 in and/or formed by the rear lip 494 of the first housing portion 410 (e.g., as shown in FIG. 23) when attached to the first housing portion 410.

In addition, the second housing portion 420 may comprise a releasable attachment structure, such as a clip 481, which may be configured to engage with the first housing portion 410 to attach (e.g., removably attach) the second housing portion 420 to the first housing portion 410. For example, the clip 481 may be located at the lower end 427 of the second housing portion 420 and may extend from the lower rear wall 426. The first housing portion 410 may define an indentation 484 configured to engage (e.g., receive) the clip 481 of the second housing portion 420. For example, the first housing portion 410 may comprise an angled wall 485 extending from the second curved wall 498 and a flange 486 extending from the angled wall 485 (e.g., at approximately a right angle). The indentation 484 of the first housing portion 410 may be formed by the second curved wall 498, the angled wall 485, and the flange 486.

The clip 481 of the second housing portion 420 may be configured to engage with the indentation 484 of the first housing portion 410. For example, the clip 481 may define a wedge portion 482 that may extend into and engage the indentation 484 of the first housing portion 410 for attaching the second housing portion 420 to the first housing portion 410. The clip 481 may comprise an actuation portion 483 that may be actuated or flexed by a user to detach the wedge portion 482 from the indentation 484 and thus detach the second housing portion 420 from the first housing portion 410 (e.g., disengage the second housing portion 420 from attachment with the first housing portion 410). For example, when the actuation portion 483 of the clip 481 is pulled down, the lower rear wall 426 of the second housing portion 420 may flex, such that the wedge portion 482 of the clip 481 is pulled out of the indentation 484 of the first housing portion 410 (e.g., out of engagement with the indentation 484 of the first housing portion 410). At this time, the lower end 427 of the second housing portion 420 may be pulled away from the first housing portion 410 and the catch 480 may be decoupled (e.g., unhooked) from the rear lip 494 of the first housing portion 410.

The bottom bar module 405 may be a self-contained and self-supported assembly for housing and/or supporting the solar power system. The bottom bar module 405 may comprise the second housing portion 420, the solar cell modules 460 (e.g., located in the recess 450), the energy storage elements 408 (e.g., located within the cavity 466), and the printed circuit board assembly 470 (e.g., located within the recess 450 and including the electrical contacts 475). Since the second housing portion 420 (e.g., the bottom bar module 405) may be removed from the first housing portion 410 without removing the first housing portion 410 from the covering material, the solar power system of the bottom bar 400 may be easily serviced after the motorized window treatment is installed. For example, the bottom bar module 405 may be removed from the first housing portion 410 and replaced with a new bottom bar module to replace the solar cell modules 460 and/or the energy storage elements 408. For example, if one or more of the solar cell modules 460 or another component of the bottom bar module 405 needs to be replaced or if upgraded components are available, the bottom bar module 405 (e.g., one or more components of the bottom bar module 405) may be accessed, serviced, and/or removed by a technician. As another example, such removal would allow for upgrading the operation of the bottom bar module 405 (e.g., new software, or newer solar cells or energy storage elements having a greater capacity). One will appreciate that other configurations of the first and second housing portions 410, 420 are possible to allow for the bottom bar module 405 and/or the second housing portion 420 to be detached from the first housing portion 410 (which may remain attached to the covering material) to allow for servicing of the bottom bar module 405.

In some examples, the bottom bar 400 may include one or more sensors, such as an occupancy sensor, a vacancy sensor, a photosensor, etc. The bottom bar 400 may be configured to control the motorized window treatment and/or external devices (e.g., such as lighting loads) based on feedback from the sensor(s). Such sensors may be located on and/or connected to the printed circuit board 472. The sensors may be powered by the solar cells 462 of the bottom bar 400 (e.g., via the energy storage elements 408). Further, the housing 402 of the bottom bar 400 may include one or more openings for the sensors (e.g., such as the front surface 404 or the rear surface 406). In some examples, the motor drive unit may be configured to move the covering material to the raised position P_{RAISED} or to the lowered position P_{LOWERED} based on feedback from the one or more sensors of the bottom bar 400, e.g., if the sensors detect that the window is open.

Although it is described herein that the bottom bar 400 that includes the solar cells 462 and that is configured to charge a motor drive unit, other configurations of the bottom bar 400 may be possible. In some examples, the bottom bar 400 may not be configured to charge the motor drive unit (e.g., the solar cells 464 may power elements such as sensors that may be located on or in the bottom bar 400). Further, in some examples, the bottom bar 400 may not include the electrical contacts 475 (e.g., in examples where the bottom bar does not charge the motor drive unit, but instead the solar cells 464 may be used to power the printed circuit board 472 and/or the sensors).

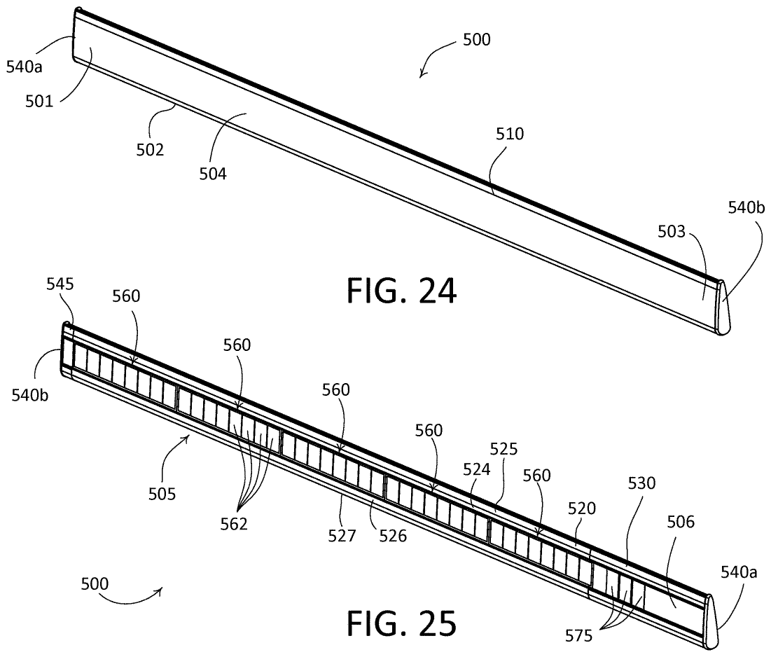

FIG. 24 is a front perspective view and FIG. 25 is a rear perspective view of another example of a bottom bar 500 (e.g., similar to the bottom bars 240, 340) for use in a covering system, such as a motorized window treatment (e.g., the motorized window treatments 150 of the load control system 100 and/or the motorized window treatment 200). The motorized window treatment may comprise a window treatment assembly (e.g., such as window treatment assemblies 210, 310) and one or more mounting brackets (e.g., such as the first and second mounting brackets 220, 222). The first and second mounting brackets may be configured to be coupled to or otherwise mounted to a structure (e.g., such as a window frame, a wall, a ceiling, or other structure of a building), such that the motorized window treatment may be mounted proximate to an opening (e.g., over the opening or in the opening), such as a window for example. The first and second mounting brackets may be configured to be mounted to a vertical structure (e.g., wall-mounted to a wall) and/or mounted to a horizontal structure (e.g., ceiling-mounted to a ceiling). The window treatment assembly may be coupled to (e.g., supported by) the first and second mounting brackets. The window treatment assembly may include a roller tube (e.g., similar to the roller tubes 212, 312), a covering material (e.g., similar to the covering materials 230, 330), the bottom bar 500, a motor drive unit (e.g., similar to the motor drive units 250, 350), and an idler (e.g., similar to the idler 260). One will appreciate that other variations of a motorized window treatment that are functionally operative with the bottom bar 500 are possible.

The bottom bar 500 may be configured to be connected to a bottom edge of the covering material. The bottom bar 500 may comprise a housing 502 having first and second ends 501, 503. In some examples, the bottom edge of the covering material may be received within the housing 502 and secured to the bottom bar 500 inside the housing 502. The bottom bar 500 may also comprise, for example, end caps, such as a first end cap 540a connected to the first end 501 of the bottom bar 500 and a second end cap 540b connected to the second end 503 of the bottom bar 500. In addition, the bottom bar 500 (e.g., the housing 502) may be configured, for example weighted, to cause the covering material to hang vertically. The bottom bar 500 (e.g., the housing 502) may comprise a front surface 504 and a rear surface 506.

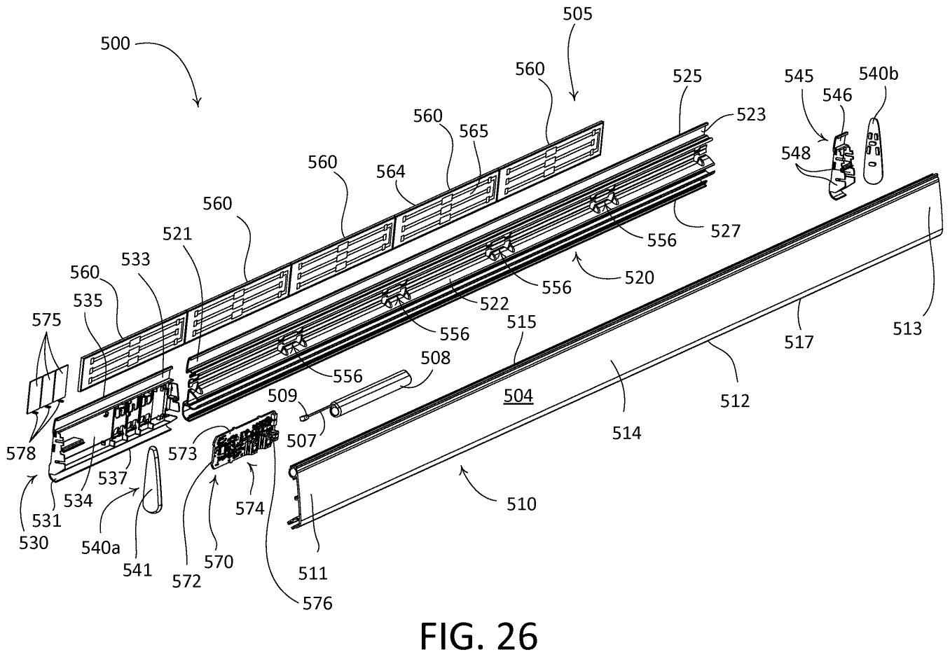

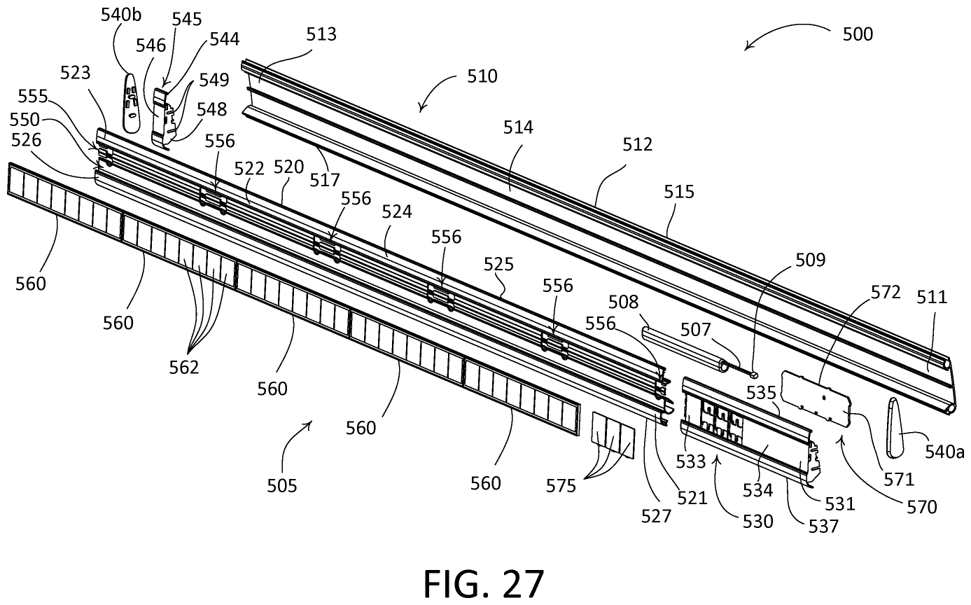

FIG. 26 is a front exploded view and FIG. 27 is a rear exploded view of the bottom bar 500. The housing 502 of the bottom bar 500 may comprise a first housing portion 510 (e.g., a front housing portion), a second housing portion 520 (e.g., a first rear housing portion), and a third housing portion 530 (e.g., a second rear housing portion, or a cover). In addition, the housing 502 of the bottom bar 500 may comprise one or more spacer housing portions 545, for example, one spacer housing portion 545 as shown in FIGS. 26 and 27 (e.g., as will be described in greater detail below). The second and third housing portions 520, 530 and the spacer housing portion 545 may be configured to be attached (e.g., removably attached) to the first housing portion 510.

The first housing portion 510 may comprise a body 512 extending from a first end 511 to a second end 513. The body 512 of the first housing portion 510 may comprise a front wall 514 that may extend from an upper end 515 to an opposing lower end 517 of the body 512, and that may define the front surface 504 of the bottom bar 500. The second housing portion 520 may comprise a body 522 extending from a first end 521 to a second end 523. The second housing portion 520 may comprise an upper rear wall 524 at an upper end 525 of the body 522 and an opposing lower rear wall 526 at an opposing lower end 527 of the body 522. The third housing portion 530 may comprise a body 532 extending from a first end 531 to a second end 533. The body 532 of the third housing portion 530 may comprise a rear wall 534 that may extend from an upper end 535 to an opposing lower end 537 of the body 532. The spacer housing portion 545 may comprise a rear wall 546 and opposing side walls 548 extending from the rear wall 546 (e.g., at a 90-degree angle from the rear wall 546). The second housing portion 520, the third housing portion 530, and the spacer housing portion 545 may be configured to be connected to the body 512 of the first housing portion 510 (e.g., as will be described in greater detail below). The upper rear wall 524 and the lower rear wall 526 of the body 522 of the second housing portion 520, the rear wall 534 of the body 532 of the third housing portion 530, and/or the rear wall 546 of the spacer housing portion 545 may each define at least a portion of the rear surface 506 of the bottom bar 500.

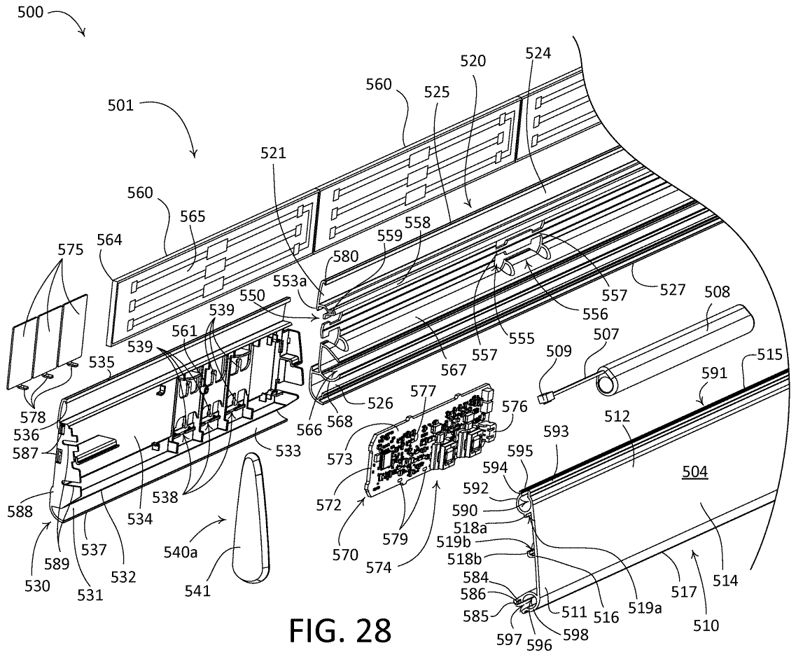

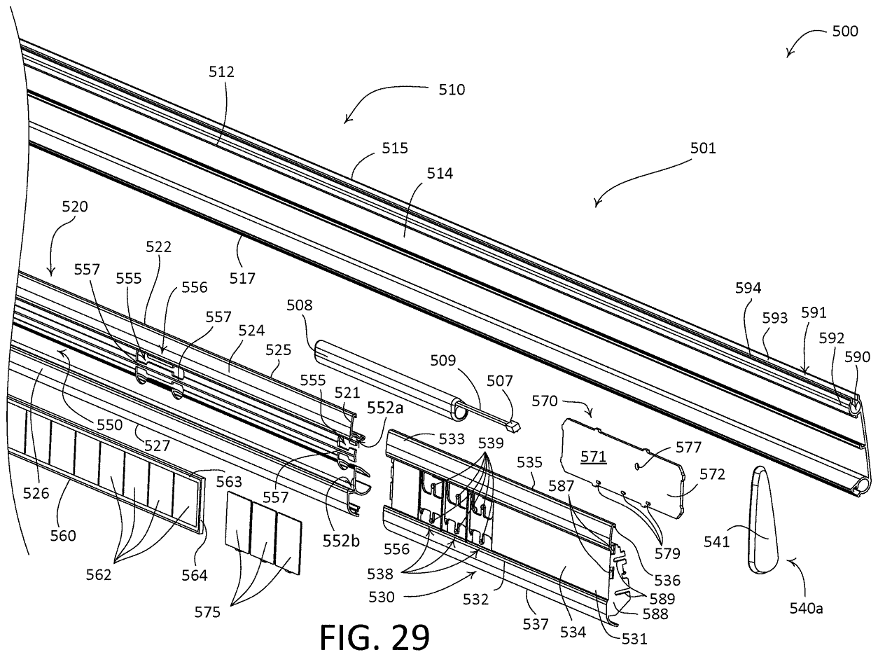

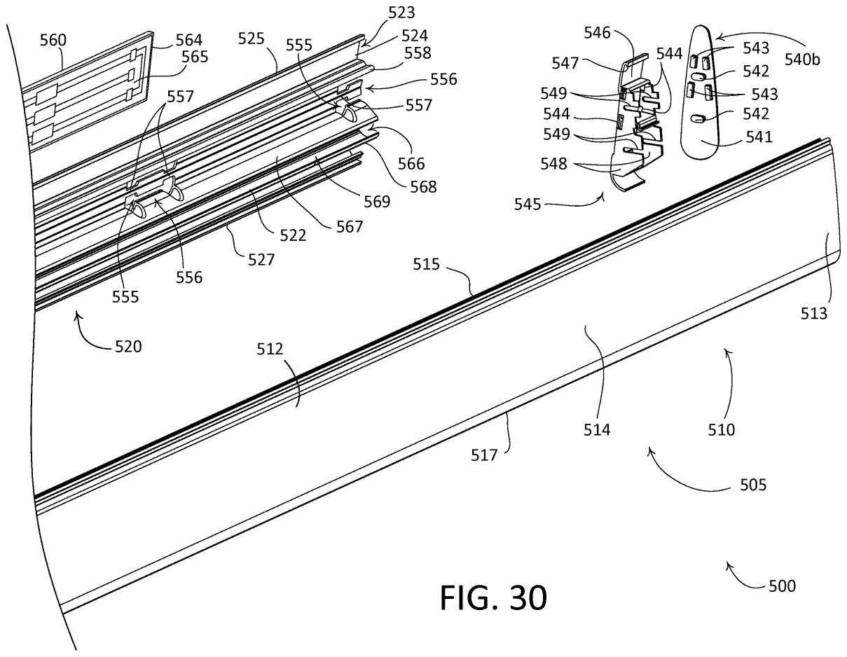

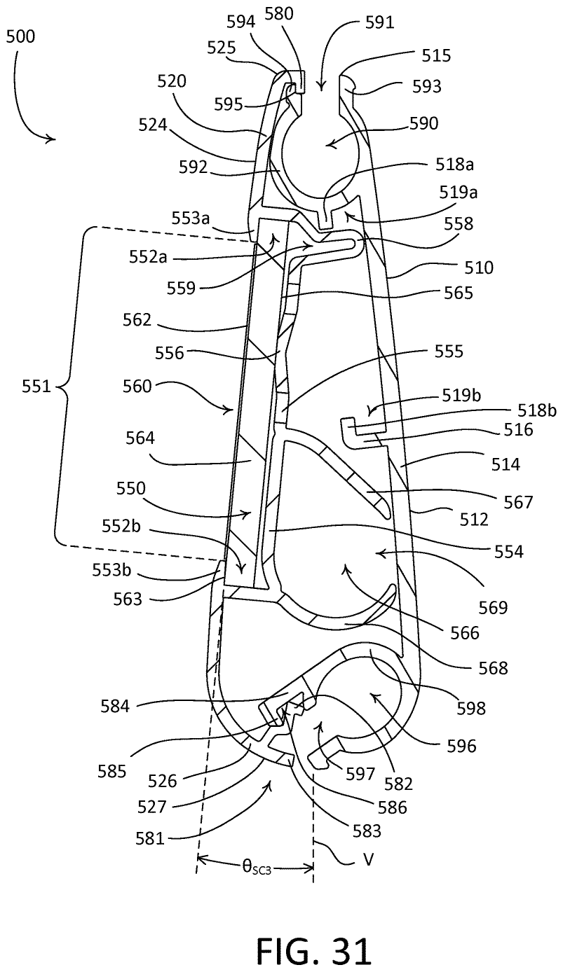

FIGS. 28 and 29 are enlarged partial exploded views of the first end 501 of the bottom bar 500 (e.g., showing the first end 511 of the body 512 of the first housing portion 510, the first end 521 of the body 522 of the second housing portion 520, and the third housing portion 530 in greater detail). FIG. 30 is an enlarged partial exploded view of the second end 503 of the bottom bar 500 (e.g., showing the second end 513 of the body 512 of the first housing portion 510, the second end 523 of the body 522 of the second housing portion 520, and the spacer housing portion 545 in greater detail). FIG. 31 is a side cross-section view of the bottom bar 500 (e.g., without the first and second end caps 540a, 540b and/or the spacer housing portion 545 shown).

The first housing portion 510 may be a main housing element (e.g., a primary housing element) of the bottom bar 500. In some examples, the first housing portion 510 (e.g., the front wall 514) may provide an aesthetically-pleasing appearance, such that the first housing portion 510 may be a decorative element of the bottom bar 500. In addition, the first housing portion 510 may operate as a weighting element of the bottom bar 500. For example, the first housing portion 510 may be made of metal. The first housing portion 510 may be configured to be connected to (e.g., attached to) the covering material of the motorized window treatment (e.g., even when the first housing portion 510 is decoupled from the remaining portions of the bottom bar 500 including the second and third housing portions 520, 530 and the spacer housing portion 545). The body 512 of the first housing portion 510 may comprise a first cavity 590 proximate to the upper end 515 and defined by a first curved wall 592 (e.g., an oval-shaped wall) and that may extend along the length of the first housing portion 510 (e.g., from the first end 511 to the second end 513 of the body 512). The first cavity 590 may be configured to receive the bottom edge of the covering material of the motorized window treatment. For example, the first curved wall 592 may define a slot 591 proximate to the upper end 515 (e.g., an elongated slot) that may extend along the length of the first housing portion 510 (e.g., from the first end 511 to the second end 513 of the body 512). The first curved wall 592 may define a front lip 593 and a rear lip 594 located on both sides of the slot 591. The covering material (e.g., the bottom edge of the covering material) may be received through the slot 591 and into the first cavity 590 (e.g., between the front and rear lips 593, 594 defined by the first curved wall 592).

In some examples, the bottom bar 500 (e.g., the first housing portion 510) may be fabric-wrapped, for example, by the covering material. In such an example, the covering material may extend from the first cavity 590 of the first housing portion 510 to a second cavity 596 of the first housing portion 510 that is proximate to the lower end 517, such that the covering material extends across the front surface 504 of the bottom bar 500 (e.g., across the front wall 514 of the first housing portion 510). The second cavity 596 may be defined by a second curved wall 598 that is proximate to the lower end 517 (e.g., an oval-shaped wall) and that may extend along the length of the first housing portion 510 (e.g., from the first end 511 to the second end 513 of the body 512). The front wall 514 of the first housing portion 510 may extend between the first curved wall 592 and the second curved wall 598. The second cavity 596 may be configured to receive the bottom edge of the covering material of the motorized window treatment. For example, the second curved wall 598 may define a slot 597 that is proximate to the lower end 517 (e.g., an elongated slot) and that may extend along the length of the first housing portion 510 (e.g., from the first end 511 to the second end 513 of the body 512). The covering material (e.g., an intermediate portion of the covering material above the bottom end of the covering material) may enter the first cavity 590 through the slot 591 of the first curved wall 592, wrap around an element (e.g., a spline) within the first cavity 590, then exit the first cavity 590 through the slot 591 of the first curved wall 592. The covering material (e.g., the bottom edge of the covering material) may enter the second cavity 596 through the slot 597 of the second curved wall 598.

The bottom bar 500 may comprise a bottom bar module 505 that includes a solar power system that includes one or more solar cell modules 560, one or more energy storage elements 508, a solar cell management circuit, a charging circuit, and a control circuit as further described herein. The solar power system may be configured to charge an energy storage element of the motor drive unit of the motorized window treatment (e.g., as will be described in greater detail below). The bottom bar module 505 and the second and third housing portions 520, 530 may be configured such that, in one aspect, the bottom bar module 505 may be considered to include the second housing portion 520 and the third housing portion 530 of the housing 502 of the bottom bar 500. The second housing portion 520 and the third housing portion 530 of the housing 502 may operate as support elements of the bottom bar 500 and may be configured to support one or more components of the bottom bar module 505 (e.g., as will be described in greater detail below). Further, the third housing portion 530 may operate as (e.g., define) a cover for the bottom bar module 505.

The one or more solar cell modules 560 of the bottom bar 500 may each include one or more solar cells 562 (e.g., photovoltaic cells). The solar cells 562 may be located at the bottom bar module 505. Each of the solar cell modules 560 may comprise a substrate 564 (e.g., such as a printed circuit board), which may have an outer surface 563 and an opposing inner surface 565. The outer surface 563 may face the window and/or be on the same side as the rear surface of the covering material and the inner surface 565 may face a recess 550 of the second housing portion 520 of the housing 502. The solar cells 562 of each of the solar cell modules 560 may be mounted to the outer surface 563 of the respective substrate 564. Each of the solar cell modules 560 may comprise, for example, eight solar cells 562, although other variations are possible. For example, the solar cell modules 560 may each comprise four pairs of solar cells 562, where each solar cell 562 of the pair of solar cells 562 is series-coupled, and where the four pairs of solar cells 562 are coupled in parallel (e.g., in a 2S4P configuration). The solar cell modules 560 may be supported by the second housing portion 520 of the housing 502 of the bottom bar 500. For example, the solar cell modules 560 may be received in the recess 550 of the second housing portion 520 of the housing 502. The recess 550 may be located proximate to the rear surface 506 of the housing 502 and/or opposite the front wall 514 of the first housing portion 510 (e.g., facing the window and/or on the same side as the rear surface of the covering material), and may be further located between the upper rear wall 524 and the lower rear wall 526 of the second housing portion 520.

The second housing portion 520 may include opposing first and second channels 552a, 552b proximate the upper rear wall 524 and the lower rear wall 526, respectively, and that may be located within the recess 550 and may be configured to receive the substrates 564 of the respective solar cell modules 560 (e.g., as shown in FIG. 31). The second housing portion 520 may comprise an upper flange 553a extending from the upper rear wall 524 and into the recess 550. The second housing portion 520 may comprise a lower flange 553b (e.g., that opposes the upper flange 553a) extending from the lower rear wall 526 and into the recess 550 towards the upper flange 553a. The first and second channels 552a, 552b may be formed by the respective upper and lower flanges 553a, 553b and a surface of a rear wall 554 of the second housing portion 520 where that surface of the rear wall 554 forms part of the recess 550 of the second housing portion 520 of the housing 502. The recess 550 and the first and second channels 552a, 552b may extend along the length of the second housing portion 520 (e.g., from the first end 521 to the second end 523 of the body 522). One will appreciate that other variations are possible (e.g., the first channel 552a and/or the second channel 552b may extend intermittently along the length of the second housing portion 520).

The solar cell modules 560 (e.g., the substrates 564 of the respective solar cell modules 560) may be received in the first and second channels 552a, 552b and may be located in the recess 550. The solar cell modules 560 (e.g., the substrates 564 of the respective solar cell modules 560) may be retained in the recess 550 by the upper and lower flanges 553a, 553b. The second housing portion 520 may define a gap 551 between the upper and lower flanges 553a, 553b (e.g., as shown in FIG. 31). The solar cells 562 of the respective solar cell modules 560 may be located within the gap 551 between the upper and lower flanges 553a, 553b and may be exposed to sunlight received through the gap 551. The solar cells 562 and the outer surfaces 563 of the respective substrates 564 (e.g., that are located within the gap 551) may form at least a portion of the rear surface 506 of the bottom bar 500. For example, the substrate 564 of each of the solar cell modules 560 may be configured to slide into the recess 550 (e.g., via the first and second channels 552a, 552b) from either the first end 521 or the second end 523 of the second housing portion 520 of the bottom bar 500.

The second housing portion 520 may further comprise one or more biasing members 556 in the rear wall 554 of the recess 550, such that the biasing members 556 extend towards the gap 551. For example, the biasing members 556 may be formed in and/or be part of the surface of the rear wall 554, although other variations are possible, including the biasing members 556 being separate elements attached to the rear wall 554. As one example, the biasing members 556 may be located in respective openings 555 on the surface of the rear wall 554 of the recess 550 and may each be connected to the body 522 of the second housing portion 520 via respective arms 557 (e.g., one or two arms). For example, the biasing members 556 located at the first end 521 and the second end 523 of the body 522 of the second housing portion 520 may each be connected to the body 522 via one arm 557, while the other biasing members 556 located within the body 522 may be connected to the body 522 via two arms 557. The biasing members 556 may each be configured to contact the inner surfaces 565 of the substrates 564 of the respective solar cell modules 560 to push the substrates 564 against the upper and lower flanges 553a, 553b (e.g., as shown in FIG. 31), and thereby maintain alignment of the solar cell modules 560 within the recess 550. One will appreciate other configurations are possible to maintain alignment of the solar cell modules 560 within the recess 550.

The rear surface 506 of the housing 502 of the bottom bar 500 (e.g., the solar cells 562 and/or the outer surfaces 563 of the substrates 564 of the respective solar cell modules 560) may be oriented at an angle θ_{SC3} from a vertical axis V (e.g., with respect to the covering material of the motorized window treatment), such that the solar cells 562 of the respective solar cell modules 560 may be angled upwards (e.g., angled up slightly towards the sky to increase the amount of sunlight that may shine on the solar cells 562). The housing 502 and the end caps 540a, 540b may define, for example, a teardrop shape as shown in FIG. 31, but could define other shapes, such as a triangular shape or a polygon shape having an angled rear surface. For example, the angle θ_{SC3} at which the solar cells 562 are oriented may be in the range of approximately 2° to 30° (e.g., approximately 5.5°). In some examples, the solar cells 562 may be oriented vertically (e.g., in parallel with the shade fabric). Further, in some examples, the bottom bar 500 may include one or more solar cells attached to the front surface 504 of the housing 502 of the bottom bar 500 (e.g., receiving solar energy from outside the building), for instance, in addition to the solar cells 562 of the solar cell modules 560 mounted to the rear surface 506 of the housing 502 of the bottom bar 500. Other variations are possible.

The one or more energy storage elements 508 of the bottom bar module 505 may be charged from the solar cells 562 of the respective solar cell modules 560 by the solar power system (e.g., as will be described in greater detail below). The one or more energy storage elements 508 of the bottom bar module 505 may be, for example, a single energy storage element 508 (e.g., as shown in FIGS. 26-29). For example, the energy storage element 508 of the bottom bar 500 may comprise a supercapacitor and/or a rechargeable battery. In some examples, the energy storage element 508 may comprise one or more of supercapacitors and/or rechargeable batteries coupled in parallel and/or in series. The energy storage element 508 may comprise a cable 507 that may include two or more electrical conductors (e.g., wires) to allow for electrical connection of the energy storage element 508 to electrical circuitry of the solar power system of the bottom bar module 505. The cable 507 may comprise a plug 509 for detachable connection to the electrical circuitry of the solar power system. The solar cells 562 may be configured to convert the received solar energy into a photovoltaic output voltage, which may be used to charge the energy storage element 508 (e.g., to generate a storage voltage across the energy storage element 508).

The energy storage element 508 may be received within the housing 502 (e.g., between the first housing portion 510 and the second housing portion 520) of the bottom bar 500. In some examples, the energy storage element 508 may be supported by the housing 502 (e.g., the first housing portion 510 and/or the second housing portion 520). For example, the energy storage element 508 may be received in a cavity 566 of the housing 502 (e.g., the second housing portion 520) of the bottom bar 500. The cavity 566 may be defined by, for example, a sloped wall 567 and a curved wall 568 of the housing 502 (e.g., the second housing portion 520) of the bottom bar 500. For example, the sloped wall 567 and the curved wall 568 may extend along the length of the second housing portion 520 (e.g., from the first end 521 to the second end 523 of the body 522), such that the cavity 566 extends along the length of the second housing portion 520 and is oriented parallel to the recess 550 of the second housing portion 520. In other examples, the sloped wall 567 and the curved wall 568 may extend along a portion of the length of the second housing portion 520, such that the cavity 566 only extends for the portion of the length of the second housing portion 520. In other examples, the sloped wall 567 and the curved wall 568 need not be oriented in this fashion to extend along the length of the second housing portion 520 and/or may extend parallel to the recess 550. The energy storage element 508 and the cavity 566 may be configured such that the energy storage element 508 fits within the cavity 566, and may be further configured such that the energy storage element 508 slides into the cavity 566 from either the first end 521 or the second end 523 of the body 522 of the second housing portion 520. The sloped wall 567 and the curved wall 568 may define a slot 569 that extends for the length of the cavity 566 (e.g., from the first end 521 to the second end 523 of the body 522 of the second housing portion 520). The slot 569 may be configured such that the sloped wall 567 and the curved wall 568 may move apart when the energy storage element 508 is inserted therein, thereby securing the energy storage element 508 in the cavity 566 by friction fit. One will appreciate that other configurations are possible. According to a further aspect, the energy storage elements 508 may be removable from the cavity 566.

The rear wall 554 of the recess 550 may comprise one or more ribs, such as a single rib 558 that may extend along the length (or intermittently along the length) of the second housing portion 520 (e.g., from the first end 521 to the second end 523 of the body 522, or along a portion of this length). For example, the rib 558 may be formed by a U-shaped portion formed in the rear wall 554 of the recess 550 (e.g., as shown in FIG. 31), although other configurations are possible. The rib 558 may also define a groove 559 in the rear wall 554 of the recess 550 (e.g., as shown in FIGS. 28 and 31). When the second housing portion 520 is detached from the first housing portion 510, the second housing portion 520 may be flexed to enlarge the gap 551 between the upper and lower flanges 553a, 553b, such that the solar cell modules 560 may be removed from and installed into the recess 550 via the gap 551 rather than slid into the recess 550, as described above. For example, the rib 558 (e.g., the U-shaped portion of the rear wall 554) may improve the flexibility of the second housing portion 520. Other configurations of the second housing portion 520 are possible to provide such flexibility.

The bottom bar module 505 may further comprise a printed circuit board assembly 570 (e.g., a bottom bar printed circuit board assembly). The printed circuit board assembly 570 may comprise a printed circuit board 572, which may have an outer surface 571 and an opposing inner surface 573. The outer surface 571 may face the window and/or be on the same side as the rear surface of the covering material, and the inner surface 573 may face the recess 550. For example, the printed circuit board assembly 570 may comprise electrical circuitry 574 of the solar power system of the bottom bar module 505, which may be mounted to the printed circuit board 572 (e.g., to the inner surface 573 of the printed circuit board 572). The electrical circuitry 574 of the solar power system of the bottom bar module 505 mounted to the printed circuit board 572 (e.g., the printed circuit board assembly 570) may comprise a solar cell management circuit configured to charge the energy storage element 508 of the bottom bar module 505 from the photovoltaic output voltage generated by the solar cells 562 of the solar cell modules 560. For example, the plug 509 of the energy storage element 508 may be plugged into a connector 576 of the printed circuit board assembly 570 to electrically connect the energy storage element 508 to the solar cell management circuit on the printed circuit board 572, although other variations are possible. In addition, the solar cells 562 of the solar cell modules 560 may be electrically connected to the solar cell management circuit on the printed circuit board 572 via two or more electrical conductors (e.g., wires-not shown). For example, the electrical conductors may be electrically connected to (e.g., soldered to) electrical contacts (e.g., electrical pads) on the inner surfaces 565 of the substrates 564 of the respective solar cell modules 560. In one example, the electrical conductors between the printed circuit board 572 and the solar cells 562 of the solar cell modules 560 may include connectors and/or plugs in various configurations that allow the solar cells 562 and/or the printed circuit board 572 to be detached from one another in order to be replaced, for example. The groove 559 defined by the rib 558 in the rear wall 554 of the second housing portion 520 may be configured to receive the two or more of the electrical conductors (e.g., wires) that extend between the solar cell modules 560 and the printed circuit board 572 of the printed circuit board assembly 570 located in the recess 550, although other variations are possible.

The printed circuit board assembly 570 may be supported by the third housing portion 530 of the housing 502 of the bottom bar 500. For example, the printed circuit board assembly 570 may be attached to a surface (e.g., a surface opposite the rear surface 506) of the rear wall 534 of the body 532 of the third housing portion 530 via a fastener (e.g., a screw—not shown) received through an opening 577 in the printed circuit board 572 and an opening 561 in the body 532 of the third housing portion 530 (e.g., as shown in FIG. 28), although other variations are possible. The third housing portion 530 may comprise a side wall 588 extending from the rear wall 534 (e.g., at 90 degrees from the rear wall 534) at the first end 531 of the third housing portion 530. In some examples, the first housing portion 510, the second housing portion 520, and/or the third housing portion 530 may form a housing of the bottom bar module 505 for housing electrical circuitry of the bottom bar module 505. For example, the first and third housing portions 510, 530 may form a housing for the printed circuit board assembly 570, while the first and second housing portions 510, 520 may form a housing for the energy storage element 508. In some examples, the third housing portion 530 may operate as (e.g., define) a first cover of the bottom bar 500 (e.g., an exterior cover, such as a first cover 630a, described herein) located adjacent to one side of the printed circuit board 572 (e.g., the outer surface 571 of the printed circuit board 572), and the bottom bar 500 may comprise a second cover (e.g., an interior cover, such as a second cover 630b, described herein) located adjacent to the other side of the printed circuit board 572 (e.g., the inner surface 573 of the printed circuit board 572). The front cover (e.g., the third housing portion 530) and the rear cover may form at least a part of the housing of the bottom bar module 505 (e.g., at least part of the housing for the printed circuit board 572).

The bottom bar 500 (e.g., the bottom bar module 505) may comprise two or more electrical contacts 575 (e.g., three electrical contacts 575 as shown in FIGS. 25 and 26) at the rear surface 506 of the bottom bar 500 (e.g., at the first end 501 of the bottom bar 500). The electrical contacts 575 of the bottom bar 500 may be located next to each other (e.g., horizontally spaced apart from each other). For example, the electrical contacts 575 may be arranged (e.g., located) in bays 538 (e.g., recesses) formed in the rear wall 534 of the body 532 (e.g., on the rear surface 506 of the housing 502) of the third housing portion 530 (e.g., as shown in FIGS. 28 and 29). The electrical contacts 575 may comprise each comprise a plate (e.g., the electrical contacts 575 may comprise a portion that is a substantially planar metallic plate). The electrical contacts 575 may each comprise a respective pin 578 that extends through respective bays 538 and into a respective opening 579 (e.g., a slot) in the printed circuit board 572 when the electrical contacts 575 are received in the bays 538 in the rear wall 534 of the body 532 of the third housing portion 530. The pins 578 may be soldered to the printed circuit board 572 when the pins 578 are received in the respective openings 579 for electrically connecting the electrical contacts 575 to the electrical circuitry 574 of the solar power system of the bottom bar module 505 mounted to the printed circuit board 572. As such, the electrical contacts 575 may comprise a substantially planar plate portion and a pin 578. The body 532 of the third housing portion 530 may also comprise one or more spring arms 539 (e.g., biasing members) in each of the bays 538 (e.g., two spring arms 539 in each of the bays 538, as shown in FIGS. 27-29). The spring arms 539 may be configured to bias the electrical contacts 575 away from the printed circuit board 572, such that the electrical contacts 575 are flush with the rear surface 506 of the bottom bar 500. Other configurations are possible.

When the bottom bar 500 is docked with the motor drive unit (e.g., when the covering material is in the docked position P_{DOCKED}), the electrical contacts 575 of the bottom bar 500 may be configured to contact respective electrical contacts of the dock (e.g., such as the electrical contacts 285, 385 of the dock 280, 380 shown in FIGS. 8, 14, and 15). The electrical contacts of the dock may be, for example, biased (e.g., spring-loaded) towards the electrical contacts 575 of the bottom bar 500 to help establish and/or maintain the electrical contact between the electrical contacts 575 of the bottom bar 500 and the electrical contacts of the dock when the bottom bar 500 is docked.

In some examples, the electrical contacts 575 may be connected to the printed circuit board (e.g., soldered to the outer surface 571 of the printed circuit board 572) and may be configured to pass through respective openings (e.g., the bays 538) in the third housing portion 530. As such, the electrical contacts 575 may be accessible from (e.g., and located at the rear surface 506 of) the bottom bar 500. For example, the electrical contacts 575 may be accessible at the rear surface 506 of the bottom bar 500. Further, in some examples, the electrical contacts 575 may each comprise a respective arm (e.g., a spring arm, such as an arm 668, described herein) coupled to a respective base member (e.g., such as a base member 667, described herein). For example, the arm of each of the electrical contacts 575 may be connected to the respective base member such that the respective arm is biased away from the respective base member. The respective base members of the electrical contacts 575 may be mechanically coupled (e.g., mounted) to the printed circuit board 572 (e.g., to the outer surface 571 of the printed circuit board 572) and may be electrically coupled the electrical circuitry of the bottom bar module 505 mounted to the printed circuit board 572. In this way, the respective base member of each of the electrical contacts 575 may be electrically and mechanically coupled to the printed circuit board 572. As such, the respective arms of the electrical contacts 575 may extend through the respective openings (e.g., the bays 538) in the third housing portion 530. For example, the electrical contacts 575 (e.g., the respective arms of the electrical contacts 575) may be biased (e.g., spring-loaded) away from the printed circuit board 572 of the bottom bar module 505. In some examples (e.g., when the bottom bar 500 comprise a rear cover), the printed circuit board 572 may be mounted to the rear cover.

In some examples, the bottom bar module 505 may not comprise the electrical contacts 575, but may alternatively comprise one or more induction coils with one or more corresponding induction coils located on the dock (e.g., the dock 280 or 380) (e.g., a first induction coil included in the bottom bar 500 and a second induction coil included in the dock) to facilitate inductive coupling (e.g., magnetic coupling) between the bottom bar module 505 and the dock. In such examples, when the covering material is in the docked position P_{DOCKED} (e.g., when the bottom bar 500 is docked), the induction coil of the bottom bar module 505 may be inductively coupled to the induction coil of the dock, such that the energy storage element of the motor drive unit may be configured to charge from the energy storage element 508 of the bottom bar module 505 via the charging circuit.

The energy stored in the energy storage element 508 of the bottom bar 500 may be discharged into the energy storage elements of the motor drive unit when the bottom bar 500 is docked with the motor drive unit, for example, when the bottom bar 500 is in the docked position P_{DOCKED}. For example, the motor drive unit may comprise one or more energy storage elements (not shown) configured to charge from the energy storage element 508 of the bottom bar 500 when the covering material is in the docked position P_{DOCKED}. For example, the electrical circuitry 574 of the solar power system of the bottom bar module 505 mounted to the printed circuit board 572 (e.g., the printed circuit board assembly 570) may comprise a charging circuit electrically connected to the energy storage element 508 and the electrical contacts 575, such that the one or more energy storage elements of the motor drive unit are configured to charge from the energy storage element 508 of the bottom bar module 505 via the charging circuit of the solar power system when the bottom bar 500 is docked. In addition, the electrical circuitry 574 of the solar power system of the bottom bar module 505 mounted to the printed circuit board 572 (e.g., the printed circuit board assembly 570) may comprise a control circuit (e.g., a microprocessor or other suitable processing device, as described herein) configured to control the solar cell management circuit and/or the charging circuit mounted to the printed circuit board 572. In some examples, the energy storage element 508 may be electrically connected (e.g., directly connected) to the electrical contacts 575 of the bottom bar 500 (e.g., the motor drive unit may comprise a charging circuit for charging the energy storage elements 508 of the bottom bar 500).

The second housing portion 520, the third housing portion 530, and the spacer housing portion 545 may be attached to the first housing portion 510. The second housing portion 520 may comprise an attachment member, such as a catch 580 (e.g., a hook), that extends from the upper rear wall 524 and may be configured to be attached to (e.g., hooked over) the rear lip 594 of the first housing portion 510. For example, the catch 580 of the second housing portion 520 may be received in a notch 595 in and/or formed by the rear lip 594 of the first housing portion 510 (e.g., as shown in FIG. 31). In addition, the third housing portion 530 may comprise an attachment member, such as a catch 536 (e.g., a hook), that extends from the rear wall 534 along the upper end 535 of the third housing portion 530 and may be configured to be attached to (e.g., hooked over) the rear lip 594 of the first housing portion 510. Further, the spacer housing portion 545 may comprise an attachment member, such as a catch 547 (e.g., a hook), that extends from an upper end of the rear wall 546 and may be configured to be attached to (e.g., hooked over) the rear lip 594 of the first housing portion 510. For example, the catch 536 of the third housing portion 530 and the catch 547 of the spacer housing portion 545 may also be received in the notch 595 in and/or formed by the rear lip 594 of the first housing portion 510. Other variations are possible.

When the second housing portion 520, the third housing portion 530, and the spacer housing portion 545 are attached to the first housing portion 510, the second housing portion 520 may be located between the third housing portion 530 and the spacer housing portion 545 (e.g., as shown in FIG. 25). For example, the first end 521 of the second housing portion 520 may abut the second end 533 of the third housing portion 530, and the second end 523 of the second housing portion 520 may abut one of the side walls 548 of the spacer housing portion 545. The first and second end caps 540a, 540b may be configured to be attached to the first housing portion 510, the third housing portion 530 and/or the spacer housing portion 545. For example, the third housing portion 530 may be located between the second housing portion 520 and the first end cap 540a, and the spacer housing portion 545 may be located between the second housing portion 520 and the second end cap 540b. When the bottom bar 500 includes multiple spacer housing portions 545, the spacer housing portions 545 may be located (e.g., all located) between the second housing portion 520 and the second end cap 540b (e.g., side-by-side to each other). For example, the first and second end caps 540a, 540b may be attached to the first housing portion 510 (e.g., to the first end 511 and the second end 513 of the body 512, respectively). In addition, the first end cap 540a may be attached to the third housing portion 530 (e.g., to the first end 531 of the body 532) and the second end cap 540b may be attached to the spacer housing portion 545. The third housing portion 530 and the spacer housing portion 545 may be configured to hold the solar cell modules 560 within the recess 550 of the second housing portion 520 when the second housing portion 520, the third housing portion 530, and the spacer housing portion 545 are connected to the first housing portion 510, and when the first and second end caps 540a, 540b are attached to the first housing portion 510, the third housing portion 530, and/or the spacer housing portion 545. One will appreciate that the one or more spacer housing portions 545 may be used when the length of the second housing portion 520 and/or the bottom bar module 505 plus the length of the third housing portion 530 is shorter than the total length of the bottom bar 500. One will further appreciate that the length of the second housing portion 520 and/or the bottom bar module 505 may be variable in length (e.g., when more or fewer solar cell modules 560 may be needed). Thus, one will further appreciate that the spacer housing portions 545 may not be needed, in which case the second end cap 540b may connect to the second end 523 of the body 522 of the second housing portion 520.

The first and second end caps 540a, 540b may be, for example, identical to each other (e.g., as shown in FIGS. 26 and 27). The first and second end caps 540a, 540b may each comprise an end portion 541 (e.g., a plate portion). The first and second end caps 540a, 540b (e.g., the respective end portions 541) may be configured to cover (e.g., enclose) the recess 550 of the second housing portion 520 (e.g., respective portions of the recess 550 at the first end 521 and the second end 523 of the body 522 of the second housing portion 520) when the first and second end caps 540a, 540b are attached to the first housing portion 510, the third housing portion 530, and/or the spacer housing portion 545. The first and second end caps 540a, 540b may each comprise one or more attachment members 542 (e.g., two attachment members) extending from the respective end portion 541 (e.g., as shown in FIG. 30). The attachment members 542 of the first end cap 540a may be configured to be received in slots 589 formed in the side wall 588 of the third housing portion 530, and the attachment members 542 of the second end cap 540b may be configured to be received in slots 549 of the spacer housing portion 545.

In addition, the first and second end caps 540a, 540b may each comprise one or more tabs 543 (e.g., four tabs) extending from the respective end portion 541 (e.g., as shown in FIG. 30). Two of the tabs 543 of the first end cap 540a may be configured to be received in openings 587 in the side wall 588 of the third housing portion 530. Two of the tabs 543 of the second end cap 540b may be configured to be received in openings 544 formed in one of the side walls 548 of the spacer housing portion 545. In addition, two of the tabs 543 of each of the first and second end caps 540a, 540b may be configured to engage with the first housing portion 510. For example, the first housing portion 510 may comprise a ledge 516 that extends from the front wall 514 (e.g., towards the second housing portion 520). The first housing portion 510 may further comprise a first flange 518a extending from the first curved wall 592 and a second flange 518b extending from the ledge 516. The front wall 514, the first curved wall 592, and the first flange 518a may form a first channel 519a of the first housing portion 510. The front wall 514, the ledge 516, and the second flange 518b may form a second channel 519b of the first housing portion 510. One of the tabs 543 of the first end cap 540a may be configured to be received within the first channel 519a at the first end 511 of the first housing portion 510, and one of the tabs 543 of the second end cap 540b may be configured to be received within the first channel 519a at the second end 513 of the first housing portion 510. One of the tabs 543 of the first end cap 540a may be configured to be received within the second channel 519b at the first end 511 of the first housing portion 510, and one of the tabs 543 of the second end cap 540b may be configured to be received within the second channel 519b at the second end 513 of the first housing portion 510. Other configurations are possible to secure the first and second end caps 540a, 540b to the first housing portion 510, the third housing portion 530, and/or the spacer housing portion 545. One will appreciate that second end 523 of the second housing portion 520 may be configured similar to the spacer housing portion 545 to allow second end cap 540b to connect to the second housing portion 520 if the spacer housing portion 545 is not present.

The bottom bar module 505 (e.g., the second housing portion 520 and/or the third housing portion 530) and possibly the spacer housing portion(s) 545 may be removably attached to the first housing portion 410. For example, the second housing portion 520 and/or the third housing portion 530 and/or the spacer housing portion 545 may be detached from the first housing portion 510 while the first housing portion 510 remains coupled to the covering material to allow for servicing of the solar power system of the bottom bar module 505. The second housing portion 520 may comprise a releasable attachment structure, such as a clip 581, which may be configured to engage with the first housing portion 510 to attach (e.g., removably attach) the second housing portion 520 to the first housing portion 510. For example, the clip 581 may be located at the lower end 527 of the second housing portion 520 and may extend from the lower rear wall 526. The first housing portion 510 may define an indentation 586 configured to engage (e.g., receive) the clip 581 of the second housing portion 520. For example, the first housing portion 510 may comprise an angled wall 584 extending from the second curved wall 598, and a flange 585 extending from the angled wall 584 (e.g., at approximately a right angle). The indentation 586 of the first housing portion 510 may be formed by the second curved wall 598, the angled wall 584, and the flange 585.

The clip 581 of the second housing portion 520 may be configured to engage with the indentation 586 of the first housing portion 510. For example, the clip 581 may define a wedge portion 582 that may extend into and engage the indentation 586 of the first housing portion 510 for attaching the second housing portion 520 to the first housing portion 510. The clip 581 may comprise an actuation portion 583 that may be actuated or flexed by a user to detach the wedge portion 582 from the indentation 586 and thus detach the second housing portion 520 from the first housing portion 510 (e.g., disengage the second housing portion 520 from attachment with the first housing portion 510). For example, when the actuation portion 583 of the clip 581 is pulled down, the lower rear wall 526 of the second housing portion 520 may flex, such that the wedge portion 582 of the clip 581 is pulled out of the indentation 586 of the first housing portion 510 (e.g., out of engagement with the indentation 586 of the first housing portion 510). At this time, the lower end 527 of the second housing portion 520 may be pulled away from the first housing portion 510 and the catch 580 may be decoupled (e.g., unhooked) from the rear lip 594 of the first housing portion 510. The third housing portion 530 and the spacer housing portion 545 may be similarly configured as the second housing portion 520 to enable the third housing portion 530 and the spacer housing portion 545 to be coupled and/or decoupled from the indentation 586 of the first housing portion 510 and to thus enable detachable and/or attachable connection of the third housing portion 530 and the spacer housing portion 545 from the first housing portion 510.

The bottom bar module 505 (e.g., the second and third housing portions 520, 530) may be an assembly for housing and/or supporting the solar power system. The bottom bar module 505 may comprise the second housing portion 520, the third housing portion 530, the solar cell modules 560 (e.g., located in the recess 550), the energy storage element 508 (e.g., located within the cavity 566), and the printed circuit board assembly 570 (e.g., located within the recess 550 and including the electrical contacts 575). Since the bottom bar module 505 (e.g., the second housing portion 520 and/or the third housing portion 530) may be removed from the first housing portion 510 without removing the first housing portion 510 from the covering material, the solar power system of the bottom bar 500 may be easily serviced after the motorized window treatment is installed. For example, the bottom bar module 505 may be removed from the first housing portion 510 and replaced with a new bottom bar module to replace the solar cell modules 560 and/or the energy storage element 508. For example, if one or more of the solar cell modules 560 or another component of the bottom bar module 505 needs to be replaced, or if upgraded components are available, the bottom bar module 505 (e.g., one or more components of the bottom bar module 505) may be accessed, serviced, and/or removed by a technician. As another example, such removal would allow for upgrading the operation of the bottom bar module 505 (e.g., new software, or newer solar cells or energy storage elements having a greater capacity). One will appreciate that other configurations of the first, second, and third housing portions 510, 520, 530 are possible to allow for the bottom bar module 505 and/or the second and third housing portions 520, 530 to be detached from the first housing portion 510 (which may remain attached to the covering material) to allow for servicing of the bottom bar module 505.

In some examples, the bottom bar 500 may include one or more sensors, such as an occupancy sensor, a vacancy sensor, a photosensor, etc. The bottom bar 500 may be configured to control the motorized window treatment and/or external devices (e.g., such as lighting loads) based on feedback from the sensor(s). Such sensors may be located on and/or connected to the printed circuit board 572. The sensors may be powered by the solar cells 562 of the bottom bar 500 (e.g., via the energy storage element 508). Further, the housing 502 of the bottom bar 500 may include one or more openings for the sensors (e.g., such as through the third housing portion 530). In some examples, the motor drive unit may be configured to move the covering material to the raised position P_{RAISED} or to the lowered position P_{LOWERED} based on feedback from the one or more sensors of the bottom bar 500, e.g., if the sensors detect that the window is open.

Although it is described herein that the bottom bar 500 that includes the solar cells 562 and that is configured to charge a motor drive unit, other configurations of the bottom bar 500 may be possible. In some examples, the bottom bar 500 may not be configured to charge the motor drive unit (e.g., the solar cells 564 may power elements such as sensors that may be located on or in the bottom bar 500). Further, in some examples, the bottom bar 500 may not include the electrical contacts 575 (e.g., in examples where the bottom bar does not charge the motor drive unit, but instead the solar cells 564 may be used to power the printed circuit board 572 and/or the sensors).

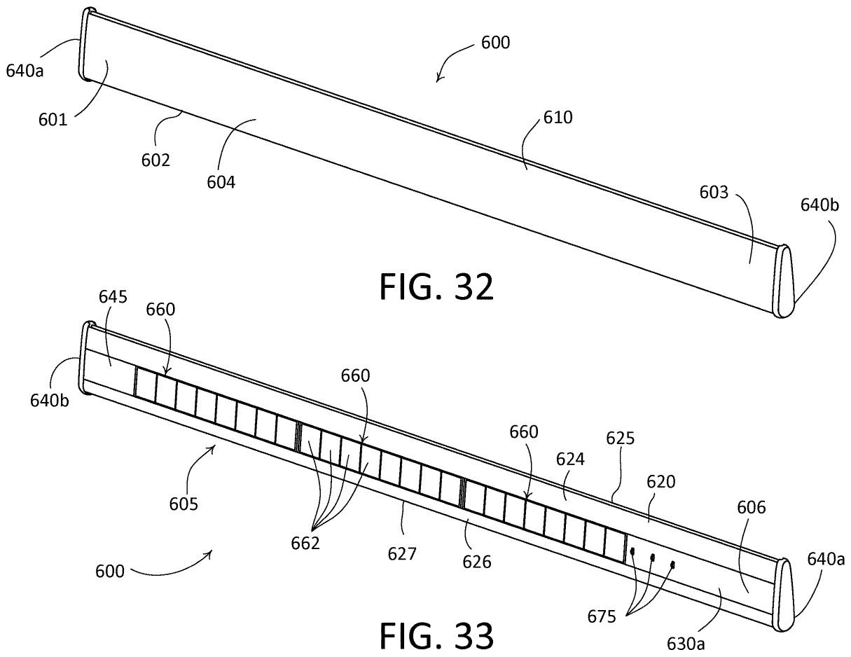

FIG. 32 is a front perspective view and FIG. 33 is a rear perspective view of another example of a bottom bar 600 (e.g., similar to the bottom bars 240, 340) for use in a covering system, such as a motorized window treatment (e.g., the motorized window treatments 150 of the load control system 100 and/or the motorized window treatment 200). The motorized window treatment may comprise a covering assembly, such as a window treatment assembly (e.g., window treatment assemblies 210, 310), and one or more mounting brackets (e.g., such as the first and second mounting brackets 220, 222). The one or more mounting brackets may be configured to be coupled to or otherwise mounted to a structure (e.g., such as a window frame, a wall, a ceiling, or other structure of a building), such that the motorized window treatment may be mounted proximate to an opening (e.g., over the opening or in the opening), such as a window for example. The one or more mounting brackets may be configured to be mounted to a vertical structure (e.g., wall-mounted to a wall) and/or mounted to a horizontal structure (e.g., ceiling-mounted to a ceiling). The window treatment assembly may be coupled to (e.g., supported by) the one or more mounting brackets. The window treatment assembly may include a roller tube (e.g., similar to the roller tubes 212, 312), a covering material (e.g., similar to the covering materials 230, 330), the bottom bar 600, a motor drive unit (e.g., similar to the motor drive units 250, 350), and an idler (e.g., similar to the idler 260). One will appreciate that other variations of a motorized window treatment that are functionally operative with the bottom bar 600 are possible.

The bottom bar 600 may be configured to be connected to a bottom edge of the covering material. The bottom bar 600 may comprise a housing 602 having first and second ends 601, 603. In some examples, the bottom edge of the covering material may be received within the housing 602 and secured to the bottom bar 600 inside the housing 602. The bottom bar 600 may also comprise, for example, end caps, such as a first end cap 640a connected to the first end 601 of the bottom bar 600 and a second end cap 640b connected to the second end 603 of the bottom bar 600. In addition, the bottom bar 600 (e.g., the housing 602) may be configured, for example weighted, to cause the covering material to hang vertically. The bottom bar 600 (e.g., the housing 602) may comprise a front surface 604 and a rear surface 606.

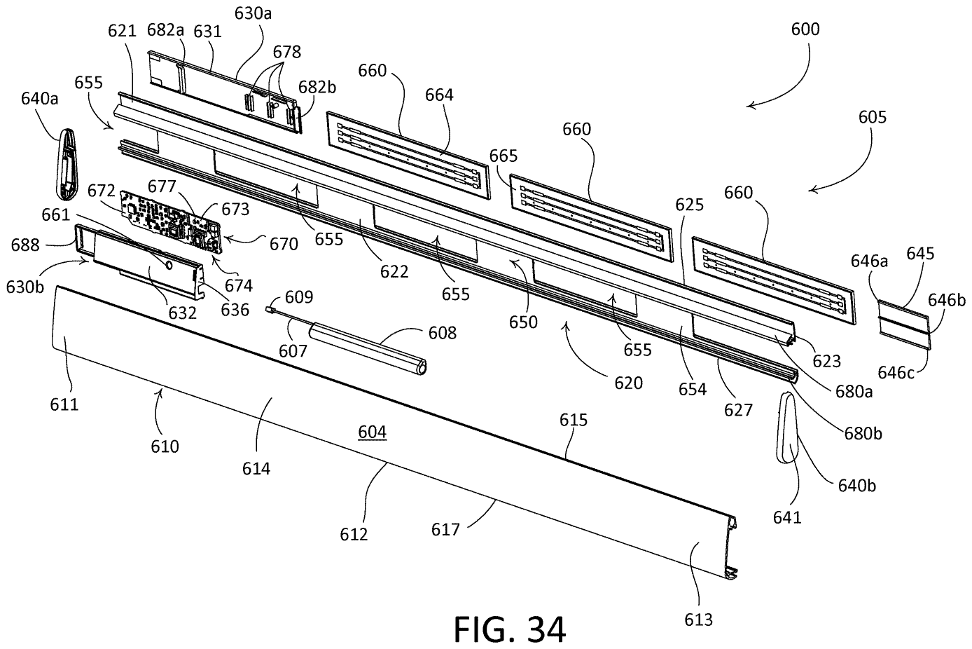

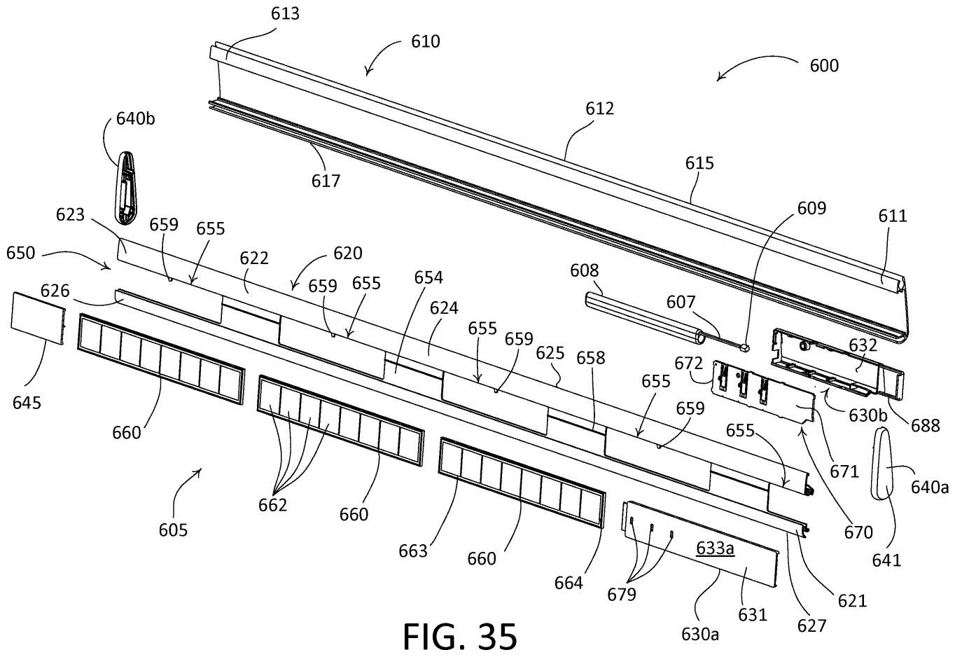

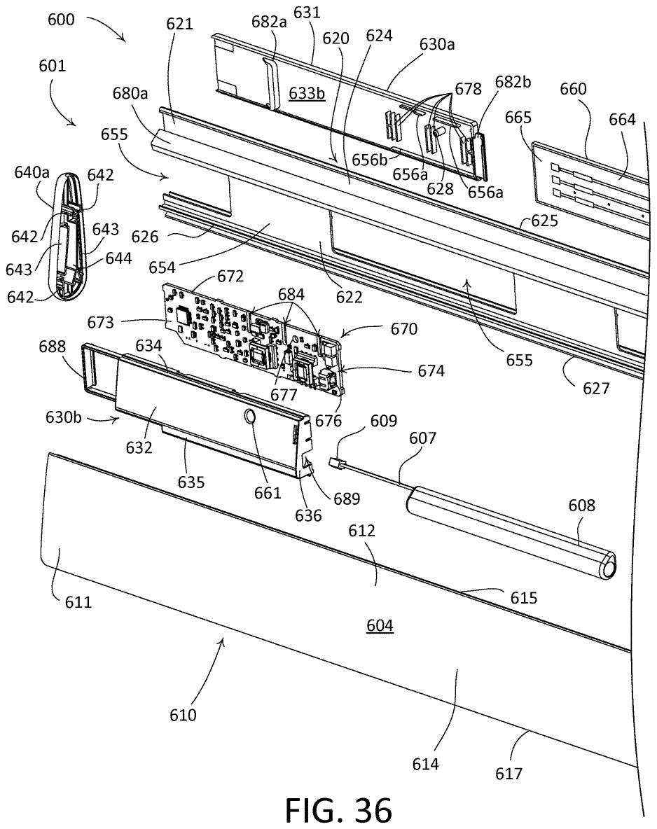

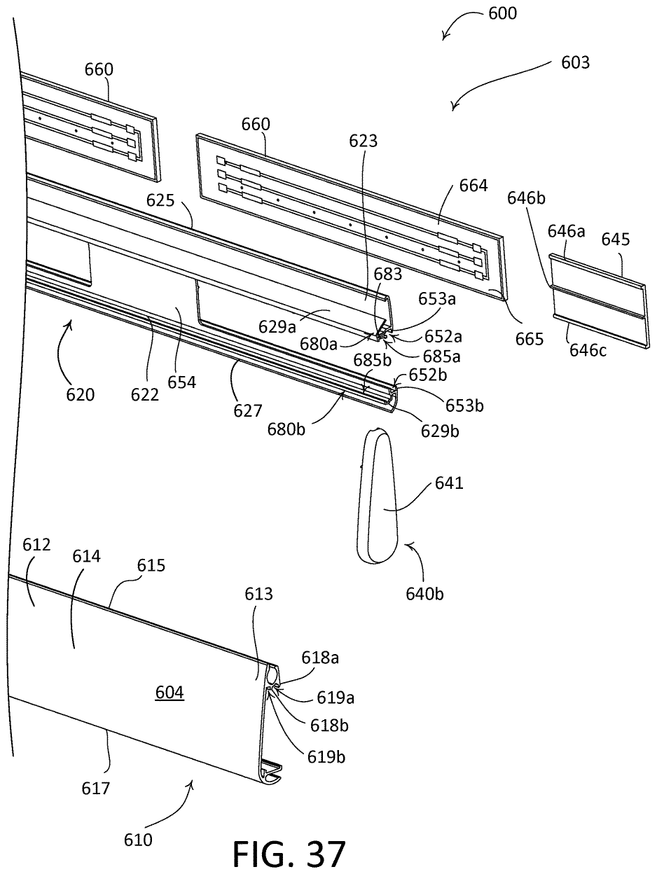

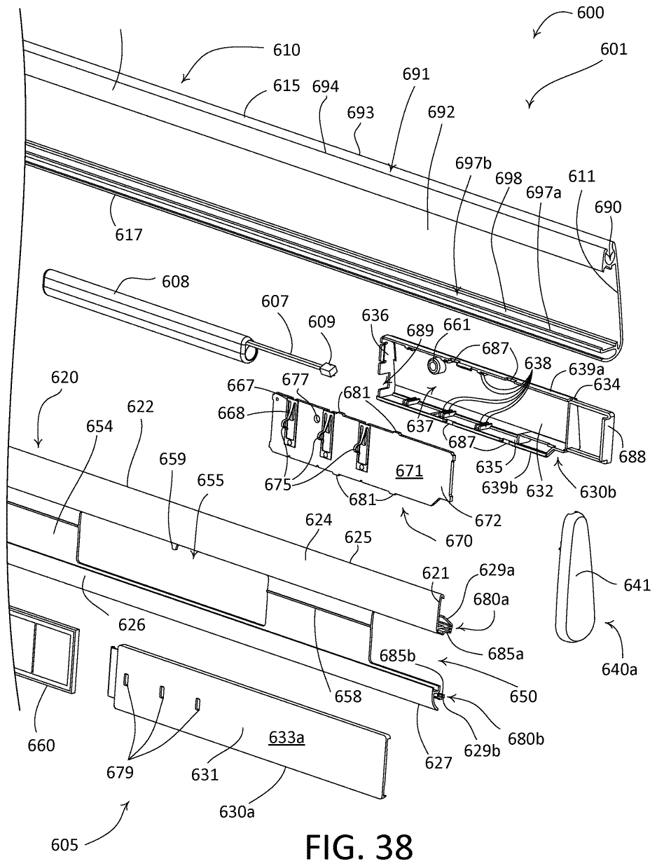

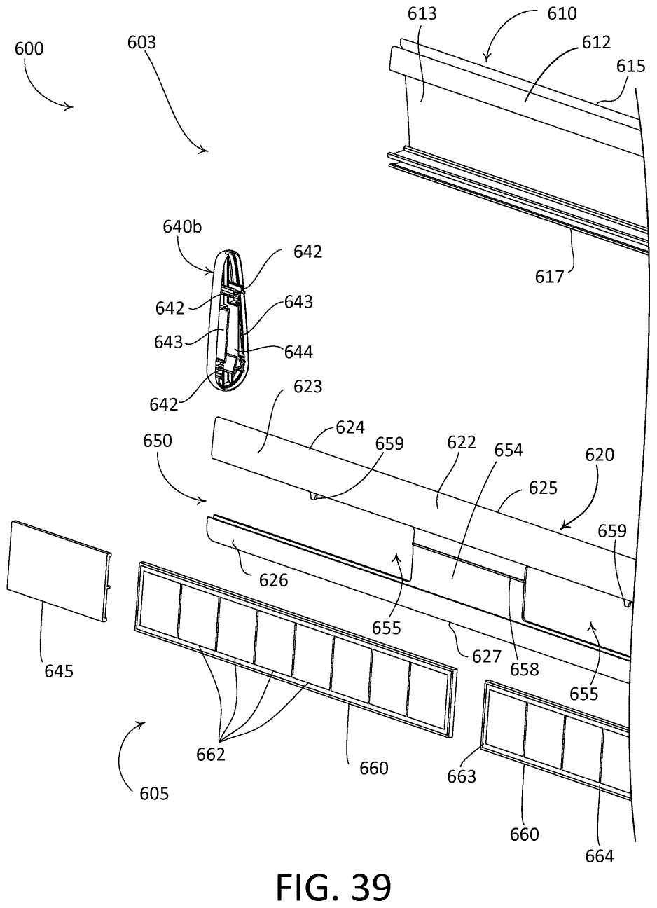

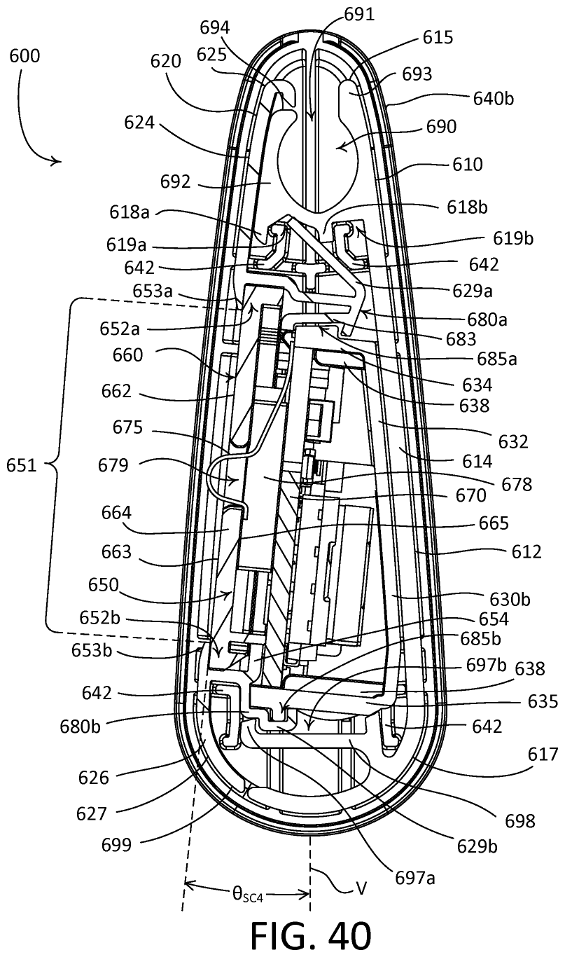

FIG. 34 is a front exploded view and FIG. 35 is a rear exploded view of the bottom bar 600. The housing 602 of the bottom bar 600 may comprise a first housing portion 610 (e.g., a front housing portion) and a second housing portion 620 (e.g., a rear housing portion). The second housing portion 620 may be configured to be attached (e.g., removably attached) to the first housing portion 610. The first housing portion 610 may comprise a body 612 extending from a first end 611 to a second end 613. The body 612 of the first housing portion 610 may comprise a front wall 614 that may extend from an upper end 615 to an opposing lower end 617 of the body 612, and that may define the front surface 604 of the bottom bar 600. The second housing portion 620 may comprise a body 622 extending from a first end 621 to a second end 623. The second housing portion 620 may comprise an upper wall 624 at an upper end 625 of the body 622 and an opposing lower wall 626 at an opposing lower end 627 of the body 622. The upper wall 624 and the lower wall 626 of the body 622 of the second housing portion 620 may define at least a portion of the rear surface 606 of the bottom bar 600. The body 622 of the second housing portion 620 may be configured to be connected to the body 612 of the first housing portion 610 (e.g., as will be described in greater detail below). FIGS. 36 and 38 are enlarged partial exploded views of the first end 601 of the bottom bar 600 (e.g., showing the first end 611 of the body 612 of the first housing portion 610 and the first end 621 of the body 622 of the second housing portion 620 in greater detail). FIGS. 37 and 39 are enlarged partial exploded views of the second end 603 of the bottom bar 600 (e.g., showing the second end 613 of the body 612 of the first housing portion 610 and the second end 623 of the body 622 of the second housing portion 620 in greater detail). FIG. 40 is a side cross-section view of the bottom bar 600.

The first housing portion 610 may be a main housing element (e.g., a primary housing element) of the bottom bar 600. In some examples, the first housing portion 610 (e.g., the front wall 614) may provide an aesthetically-pleasing appearance, such that the first housing portion 610 may be a decorative element of the bottom bar 600. In addition, the first housing portion 610 may operate as a weighting element of the bottom bar 600. For example, the first housing portion 610 may be made of metal. The first housing portion 610 may be configured to be connected to (e.g., attached to) the covering material of the motorized window treatment (e.g., even when the first housing portion 610 is decoupled from the remaining portions of the bottom bar 600, including the second housing portion 620). The body 612 of the first housing portion 610 may comprise a first cavity 690 proximate to the upper end 615 and defined by a first wall 692 (e.g., a curved wall, an oval-shaped wall, etc.), and that may extend along the length of the first housing portion 610 (e.g., from the first end 611 to the second end 613 of the body 612). The first cavity 690 may be configured to receive the bottom edge of the covering material of the motorized window treatment. For example, the first wall 692 may define a slot 691 proximate to the upper end 615 (e.g., an elongated slot) that may extend along the length of the first housing portion 610 (e.g., from the first end 611 to the second end 613 of the body 612). The first wall 692 may define a front lip 693 and a rear lip 694 located on both sides of the slot 691. The covering material (e.g., the bottom edge of the covering material) may be received through the slot 691 and into the first cavity 690 (e.g., between the front and rear lips 693, 694 defined by the first wall 692). The first housing portion 610 (e.g., the body 612) may further comprise a second wall 698 (e.g., a lower wall) that may extend from the front wall 614 near the lower end 617 of the body 612 towards the second housing portion 620. The first housing portion 610 (e.g., the body 612) may also comprise a flange 697a extending upwards from the second wall 698 (e.g., in the transverse direction T as shown in FIG. 40). The first housing portion 610 may comprise (e.g., define) a channel 697b formed by the front wall 614, the second wall 698, and the flange 697a.

In some examples, the bottom bar 600 (e.g., the first housing portion 610) may be fabric-wrapped, for example, by the covering material. In such an example, the first housing portion 610 may comprise a second cavity of the first housing portion 610 (e.g., such as the second cavity 596 of the first housing portion 510 of the bottom bar 500) that is proximate to the lower end 617. The covering material may extend from the first cavity 690 of the first housing portion 610 to a second cavity of the first housing portion 610, such that the covering material extends across the front surface 604 of the bottom bar 600 (e.g., across the front wall 614 of the first housing portion 610). For example, the covering material (e.g., an intermediate portion of the covering material above the bottom end of the covering material) may enter the first cavity 690 through the slot 691 of the first wall 692, wrap around an element (e.g., a spline) within the first cavity 690, then exit the first cavity 690 through the slot 691 of the first wall 692. The covering material (e.g., the bottom edge of the covering material) may then enter the second cavity. Additionally or alternatively, in some examples, the covering material may be wrapped around the bottom bar 600 (e.g., the first housing portion 610) using an adhesive.

The bottom bar 600 may comprise a bottom bar module 605 that includes a solar power system that includes one or more solar cell modules 660, one or more energy storage elements 608, a solar cell management circuit, a charging circuit, and a control circuit as further described herein. The solar power system may be configured to charge an energy storage element of the motor drive unit of the motorized window treatment (e.g., as will be described in greater detail below).

The bottom bar module 605 and the second housing portion 620 may be configured such that, in one aspect, the bottom bar module 605 may be considered to include the second housing portion 620 of the housing 602 of the bottom bar 600. The second housing portion 620 of the housing 602 may operate as a support element of the bottom bar 600 and may be configured to support one or more components of the bottom bar module 605 (e.g., as will be described in greater detail below).

The one or more solar cell modules 660 of the bottom bar module 605 may each include one or more solar cells 662 (e.g., photovoltaic cells). The solar cells 662 may be located at the bottom bar module 605. Each of the solar cell modules 660 may comprise a substrate 664 (e.g., such as a printed circuit board), which may have an outer surface 663 and an opposing inner surface 665. The outer surface 663 may face the window and/or be on the same side as the rear surface of the covering material, and the inner surface 665 may face a recess 650 of the second housing portion 620 of the housing 602. The solar cells 662 of each of the solar cell modules 660 may be mounted to the outer surface 663 of the respective substrate 664. Each of the solar cell modules 660 may comprise, for example, eight solar cells 662, although other variations are possible. For example, the solar cell modules 660 may each comprise four pairs of solar cells 662, where each solar cell 662 of the pair of solar cells 662 is series-coupled, and where the four pairs of solar cells 662 are coupled in parallel (e.g., in a 2S4P configuration). The solar cell modules 660 may be supported by the second housing portion 620 of the housing 602 of the bottom bar 600. For example, the solar cell modules 660 may be received in the recess 650 of the second housing portion 620 of the housing 602. The recess 650 may be located proximate to the rear surface 606 of the housing 602/opposite the front wall 614 of the first housing portion 610 (e.g., facing the window and/or on the same side as the rear surface of the covering material), and may be further located between the upper wall 624 and the lower wall 626 of the second housing portion 620.

The second housing portion 620 may include opposing first and second channels 652a, 652b proximate the upper wall 624 and the lower wall 626, respectively, and that may be located within the recess 650 and may be configured to receive the substrates 664 of the respective solar cell modules 660 (e.g., as shown in FIG. 40). The second housing portion 620 may comprise an upper flange 653a extending from the upper wall 624 and into the recess 650. The second housing portion 620 may comprise a lower flange 653b (that opposes the upper flange 653a) extending from the lower wall 626 and into the recess 650 towards the upper flange 653a. The first and second channels 652a, 652b may be formed by the upper and lower flanges 653a, 653b, respectively, and a surface of an interior wall 654 of the second housing portion 620, where the surface of the interior wall 654 forms part of the recess 650 of the second housing portion 620 of the housing 602. The recess 650 and the first and second channels 652a, 652b may extend along the length of the second housing portion 620 (e.g., from the first end 621 to the second end 623 of the body 622). One will appreciate that other variations are possible (e.g., the first and/or second channels 652a, 652b may extend intermittently along the length of the second housing portion 620).

The solar cell modules 660 (e.g., the substrates 664 of the respective solar cell modules 660) may be received in the first and second channels 652a, 652b and may be located in the recess 650. The solar cell modules 660 (e.g., the substrates 664 of the respective solar cell modules 660) may be retained in the recess 650 by the upper and lower flanges 653a, 653b. The second housing portion 620 may define a gap 651 between the upper and lower flanges 653a, 653b (e.g., as shown in FIG. 40). The solar cells 662 of the respective solar cell modules 660 may be located within the gap 651 between the upper and lower flanges 653a, 653b and may be exposed to sunlight received through the gap 651. The solar cells 662 and the outer surfaces 663 of the respective substrates 664 (e.g., that are located within the gap 651) may form at least a portion of the rear surface 606 of the bottom bar 600. For example, the substrate 664 of each of the solar cell modules 660 may be configured to slide into the recess 650 (e.g., via the first and second channels 652a, 652b) from either the first end 621 or the second end 623 of the second housing portion 620 of the bottom bar 600.

The interior wall 654 of the second housing portion 620 may comprise (e.g., define) one or more cutouts 655. For example, the interior wall 654 may comprise a cutout 655 located at the first end 621 of the body 622 of the second housing portion 620, a cutout 655 located at the second end 623 of the body 622 of the second housing portion 620, and three cutouts 655 located intermittently along the interior wall 654 between the first end 621 and the second end 623 of the body 622 of the second housing portion 620 (e.g., as shown in FIGS. 34 and 35). The interior wall 654 may further comprise one or more projections 659 extending from the upper end 625 of the body 622 of the second housing portion 620 into a respective cutout 655. The projections 659 may be configured to support the solar cell modules 660 (e.g., the substrates 664) within the recess 650 where the interior wall 654 comprises the cutouts 655.

The second housing portion 620 may further comprise first and second attachment members 680a, 680b. The first attachment member 680a may be connected to the upper wall 624 of the body 622 of the second housing portion 620. The first attachment member 680a may be connected to the interior wall 654 along the length of the second housing portion 620. In some examples, the first attachment member 680a may be attached to the interior wall 654 along portions of the length of the second housing portion 620 where there is not a cutout 655 in the interior wall 654. The first attachment member 680a may be configured to extend along the length of the second housing portion 620, and at least a portion of the first attachment member 680a may extend towards the gap 651. For example, the first attachment member 680a may comprise a support arm 683 that may extend towards the gap 651. The first attachment member 680a (e.g., the support arm 683) may be configured to contact the inner surfaces 665 of the substrates 664 of the respective solar cell modules 660 to push the substrates 664 against the upper and lower flanges 653a, 653b (e.g., as shown in FIG. 40), and thereby maintain alignment of the solar cell modules 660 within the recess 650. One will appreciate that other configurations are possible to maintain alignment of the solar cell modules 660 within the recess 650. The first and second end caps 640a, 640b may be attached to the bottom bar 600 once the solar cell modules 660 are slid into the recess 650, and may further contain the solar cell modules 660 in the recess 650.

The rear surface 606 of the housing 602 of the bottom bar 600 (e.g., the solar cells 662 and/or the outer surfaces 663 of the substrates 664 of the respective solar cell modules 660) may be oriented at an angle θ_{SC4} from a vertical axis V (e.g., with respect to the covering material of the motorized window treatment), such that the solar cells 662 of the respective solar cell modules 660 may be angled upwards (e.g., angled up slightly towards the sky to increase the amount of sunlight that may shine on the solar cells 662). The housing 602 and the end caps 640a, 640b may define, for example, a teardrop shape as shown in FIG. 40, but could define other shapes, such as a triangular shape or a polygon shape having an angled rear surface. For example, the angle θ_{SC4} at which the solar cells 662 are oriented may be in the range of approximately 2° to 30°. In some examples, the solar cells 662 may be oriented vertically (e.g., in parallel with the shade fabric). Further, in some examples, the bottom bar 600 may include one or more solar cells attached to the front surface 604 of the housing 602 of the bottom bar 600 (e.g., receiving solar energy from inside the building), for instance, in addition to the solar cells 662 of the solar cell modules 660 mounted to the rear surface 606 of the housing 602 of the bottom bar 600. Other variations are possible.

The one or more energy storage elements 608 of the bottom bar module 605 may be charged from the solar cells 662 of the respective solar cell modules 660 by the solar power system (e.g., as will be described in greater detail below). The one or more energy storage elements 608 of the bottom bar module 605 may be, for example, a single energy storage element 608 (e.g., as shown in FIGS. 34-36 and 38. For example, the energy storage element 608 of the bottom bar 600 may comprise a supercapacitor and/or a rechargeable battery. In some examples, the energy storage element 608 may comprise one or more of supercapacitors and/or rechargeable batteries coupled in parallel and/or in series. The energy storage element 608 may comprise a cable 607 that may include two or more electrical conductors (e.g., wires) to allow for electrical connection of the energy storage element 608 to electrical circuitry of the solar power system of the bottom bar module 605. The cable 607 may comprise a plug 609 for detachable connection to the electrical circuitry of the solar power system. The solar cells 662 may be configured to convert the received solar energy into a photovoltaic output voltage, which may be used to charge the energy storage element 608 (e.g., to generate a storage voltage across the energy storage element 608).

The energy storage element 608 may be received within the housing 602 (e.g., between the first housing portion 610 and the second housing portion 620) of the bottom bar 600. In some examples, the energy storage element 608 may be supported by the housing 602 (e.g., the first housing portion 610 and/or the second housing portion 620). For example, the energy storage element 608 may be received in a cavity within the housing 602 of the bottom bar 600 (e.g., such as the cavity 566 of the second housing portion 520 of the bottom bar 500). The energy storage element 608 may be configured such that the energy storage element 608 fits within the cavity, and may be further configured such that the energy storage element 608 slides into the cavity from either the first end 621 or the second end 623 of the body 622 of the second housing portion 620. In some examples, the energy storage element 608 may be secured in the cavity by friction fit. One will appreciate that other configurations are possible. According to a further aspect, the energy storage elements 608 may be removable from the cavity.

The interior wall 654 of the second housing portion 620 may comprise one or more ribs 658, such as a single rib 658 that may extend along the length (or intermittently along the length) of the second housing portion 620 (e.g., from the first end 621 to the second end 623 of the body 622, or along a portion of this length). For example, the rib 658 may extend from the interior wall 654 along portions of the length of the second housing portion 620 where there is not a cutout 655 in the interior wall 654. In some examples, the rib 658 may be configured to contact the inner surfaces 665 of the substrates 664 of the respective solar cell modules 660 to push the substrates 664 against the upper and lower flanges 653a, 653b, and thereby maintain alignment of the solar cell modules 660 within the recess 650.

In some examples, the interior wall 654 of the second housing portion 620 may comprise one or more grooves (e.g., such the groove 559 in the rear wall 554 of the recess 550 of the second housing portion 520) that may extend along the length (or intermittently along the length) of the second housing portion 620 (e.g., from the first end 621 to the second end 623 of the body 622, or along a portion of this length). When the second housing portion 620 is detached from the first housing portion 610, the second housing portion 620 may be flexed to enlarge the gap 651 between the upper and lower flanges 653a, 653b, such that the solar cell modules 660 may be removed from and installed into the recess 650 via the gap 651 rather than slid into the recess 650, as described above. For example, the groove in the interior wall 654 may improve the flexibility of the second housing portion 620 to allow for such installation and/removal of the solar cell modules 660. Other configurations of the second housing portion 620 are possible to provide such flexibility.

The bottom bar module 605 may further comprise a printed circuit board assembly 670 (e.g., a bottom bar printed circuit board assembly). The printed circuit board assembly 670 may comprise a printed circuit board 672, which may have an outer surface 671 and an opposing inner surface 673. The outer surface 671 may face the window and/or be on the same side as the rear surface of the covering material, and the inner surface 673 may face the first housing portion 610. For example, the printed circuit board assembly 670 may comprise electrical circuitry 674 of the solar power system of the bottom bar module 605, which may be mounted to the printed circuit board 672 (e.g., to the inner surface 673 of the printed circuit board 672). The electrical circuitry 674 of the solar power system of the bottom bar module 605 mounted to the printed circuit board 672 (e.g., the printed circuit board assembly 670) may comprise a solar cell management circuit configured to charge the energy storage element 608 of the bottom bar module 605 from the photovoltaic output voltage generated by the solar cells 662 of the solar cell modules 660. For example, the plug 609 of the energy storage element 608 may be plugged into a connector 676 of the printed circuit board assembly 670 to electrically connect the energy storage element 608 to the solar cell management circuit on the printed circuit board 672, although other variations are possible.

In addition, the solar cells 662 of the solar cell modules 660 may be electrically connected to the solar cell management circuit on the printed circuit board 672 via two or more electrical conductors (e.g., wires-not shown). For example, the electrical conductors may be electrically connected to (e.g., soldered to) electrical contacts (e.g., electrical pads) on the inner surfaces 665 of the substrates 664 of the respective solar cell modules 660. The electrical conductors may extend from the solar cell modules 660 to the printed circuit board 672 of the printed circuit board assembly 670 through the cutouts 655 in the interior wall 654 of the second housing portion 620. In one example, the electrical conductors between the printed circuit board 672 and the solar cells 662 of the solar cell modules 660 may include connectors and/or plugs in various configurations that allow the solar cells 662 and/or the printed circuit board 672 to be detached from one another in order to be replaced, for example. In some example, the two or more of the electrical conductors (e.g., wires) that extend between the solar cell modules 660 and the printed circuit board 672 of the printed circuit board assembly 670 may extend through the groove in the interior wall 654 of the second housing portion 620, although other variations are possible. The printed circuit board assembly 670 may further comprise one or more electrical contacts 675 (e.g., three electrical contacts 675, as shown in FIG. 38) connected to the outer surface 671 of the printed circuit board 672, as described in greater detail below, and one or more slits 684 (e.g., three slits 684, as shown in FIG. 36) in the inner surface 673 of the printed circuit board 672. The slits 684 may be located opposite (e.g., behind) a respective electrical contact 675 (e.g., on the outer surface 671 of the printed circuit board 672).

The bottom bar module 605 may comprise a first cover 630a (e.g., an exterior cover or third housing portion) and a second cover 630b (e.g., an interior cover or fourth housing portion). The first cover 630a and the second cover 630b may form a housing of the bottom bar module 605 for housing electrical circuitry (e.g., the printed circuit board assembly 670) of the bottom bar module 605. For example, the first cover 630a may be configured to be coupled (e.g., attached) to the second cover 630b with the printed circuit board 672 captured between the first cover 630a and the second cover 630b. The first cover 630a may comprise a peripheral wall 631 having a first surface 633a (e.g., an exterior surface) and a second surface 633b (e.g., an interior surface). The first cover 630a (e.g., the peripheral wall 631) may be configured to be received in the recess 650 of the second housing portion 620 (e.g., at the first end 621 of the second housing portion 620). The first surface 633a of the peripheral wall 631 of first cover 630a may form at least a portion of the rear surface 606 of the bottom bar 600. The first cover 630a may have one or more ribs 678 (e.g., support ribs or walls) extending from the second surface 633b of the peripheral wall 631 (e.g., in the lateral direction A). In addition, the first cover 630a may have a curved wall 682a extending from the second surface 633b of the peripheral wall 631, as described in greater detail below.

The second cover 630b may comprise a peripheral wall 632. The second cover 630b may also comprise an upper wall 634, a lower wall 635, and a sidewall 636 extending from the peripheral wall 632 to form a cavity 637 of the second cover 630b. The second cover 630b may comprise one or more ribs 638 (e.g., support ribs or walls) extending from the upper wall 634 and the lower wall 635 into the cavity 637. In addition, the ribs 638 may extend from the peripheral wall 632. The printed circuit board assembly 670 (e.g., the printed circuit board 672) may be supported by the second cover 630b (e.g., by the ribs 638). For example, the printed circuit board assembly 670 (e.g., the printed circuit board 672) may be received within the cavity 637 and the printed circuit board 672 (e.g., the inner surface 665) may contact the ribs 638 (e.g., as shown in FIG. 38). Furthermore, the side wall 636 may comprise a cutout 689 that may be configured to receive the plug 609 of the energy storage element 608 such that the plug 609 may be plugged into the connector 676 of the printed circuit board assembly 670, as described above. The second cover 630b may further comprise an extension portion 688 configured to attach to the first cover 630a, for example, by clipping into the curved wall 682a of the first cover 630a.

The peripheral wall 632 may further comprise one or more recesses 687 (e.g., four recesses 687, as shown in FIG. 38). For example, two recesses 687 may be spaced along the upper wall 634 of the second cover 630b, and two recesses 687 may be spaced along the lower wall 635 of the second cover 630b. The printed circuit board assembly 670 (e.g., the printed circuit board 672) may comprise one or more tabs 681 (e.g., four tabs 681, as shown in FIG. 38). For example, two tabs 681 may be spaced along a top edge of the printed circuit board 672, and two tabs 681 may be spaced along a bottom edge of the printed circuit board 672. Each of the tabs 681 may correspond to a respective recess 687 of the second cover 630b such that the printed circuit board assembly 670 may be aligned with the second cover 630b by inserting the tabs 681 into the recesses 687.

The second cover 630b may be coupled to (e.g., supported by) the second housing portion 620. For example, the second cover 630b may comprise a first projection 639a (e.g., a first ridge) extending from the upper wall 634 (e.g., away from the cavity 637) and a second projection 639b (e.g., a second ridge) extending from the lower wall 635 (e.g., away from the cavity 637). The first and second projections 639a, 639b of the second cover 630b may be received in first and second channels 685a, 685b of the first and second attachment members 680a, 680b of the second housing portion 620 for coupling (e.g., attaching) the second cover 630b to the second housing portion 620. The second cover 630b is attached to the second housing portion 620 with the printed circuit board 672 captured between the second housing portion 620 and the second cover 630b. When the first cover 630a is attached to the second housing portion 620 (e.g., within the recess 650), the printed circuit board assembly 670 may be enclosed by the first and second covers 630a, 630b. In addition, one or more fasteners (e.g., screws—not shown) may be received through an opening 661 in the second cover 630b, an opening 677 in the printed circuit board 672, and an opening 628 of the first cover 630a for securing the first cover 630a, the second cover 630b, and the printed circuit board 672 to the second housing portion 620 (e.g., as shown in FIG. 36). When the first and second covers 630a, 630b are attached to the second housing portion 620, the ribs 678 of the first cover 630a may contact (e.g., abut) the outer surface 671 of the printed circuit board 672 and the ribs 638 of the second cover 630b may contact (e.g., abut) the inner surface 673 of the printed circuit board 672, such that the printed circuit board 672 may be captured between the first and second covers 630a, 630b (e.g., as shown in FIG. 40).

In addition, the bottom bar module 605 may comprise one or more spacer boards 645 (e.g., one spacer board 645, as shown in FIG. 33) located between the second end cap 640b and the solar cell module 660. The spacer board 645 may form at least a portion of the rear surface 606 of the bottom bar 600 (e.g., as shown in FIG. 33). For example, the spacer board 645 may be a substrate, such as a printed circuit board (e.g., the spacer board 645 may be made from the same material as the printed circuit board 672 of the printed circuit board assembly 670). The spacer board 645 may comprise an upper rail 646a, a middle rail 646b, and a lower rail 646c (e.g., as shown in FIG. 34), each of which may be used to attach the spacer board 645 to the second housing portion 620 (e.g., within the recess 650). For example, the upper rail 646a and the lower rail 646c of the spacer board 645 may be configured to fit in the first and second channels 652a, 652b, respectively, within the recess 650 of the second housing portion 620. In this way, the spacer board 645 may be secured within the recess 650 of the second housing portion 620. One will further appreciate that the length of the second housing portion 620 and/or the bottom bar module 605 may be variable in length (e.g., when more or fewer solar cell modules 660 may be needed). Thus, one will further appreciate that the spacer housing portion 645 may not be needed, in which case the second end cap 640b may connect to the second end 623 of the body 622 of the second housing portion 620.

The bottom bar 600 (e.g., the bottom bar module 605) may comprise two or more electrical contacts 675 (e.g., three electrical contacts 675 as shown in FIG. 33) at the rear surface 606 of the bottom bar 600 (e.g., at the first end 601 of the bottom bar 600). For example, the electrical contacts 675 may be accessible at the rear surface 606 of the bottom bar 600. The electrical contacts 675 may be electrically connected to the electrical circuitry of the solar power system of the bottom bar module 605 mounted to the printed circuit board 672. For example, each of the electrical contacts 675 may be soldered onto the printed circuit board 672 (e.g., the outer surface 671 of the printed circuit board 672) via a respective base member 667, and may be configured to pass through respective openings 679 (e.g., three openings, as shown in FIG. 33) in the peripheral wall 631 the first cover 630a of the bottom bar 600. As such, the electrical contacts 675 may extend through the second housing portion 620 of the bottom bar 600. The electrical contacts 675 of the bottom bar 600 may be located next to each other (e.g., horizontally spaced apart from each other). The electrical contacts 675 may each comprise a respective arm 668 (e.g., a spring arm) coupled to the respective base member 667 (e.g., as shown in FIG. 38). For example, the arm 668 of each of the electrical contacts 675 may be connected to the respective base member 667 such that the respective arm 668 is biased away from the respective base member 667. The respective base members 667 of the electrical contacts 675 may be mechanically coupled (e.g., mounted) to the printed circuit board 672 (e.g., to the outer surface 671 of the printed circuit board 672) and may be electrically coupled the electrical circuitry of the bottom bar module 605 mounted to the printed circuit board 672. In this way, the respective base member 667 of each of the electrical contacts 675 may be electrically and mechanically coupled to the printed circuit board 672. When the printed circuit board 672 is captured between the first and second covers 630a, 630b, the respective arms 668 of the electrical contacts 675 may extend through the respective openings 679 in the peripheral wall 631 of the first cover 630a. Further, the respective arms 668 of the electrical contacts 675 may extend through at least one of the cutouts 655 in the interior wall 654 of the second housing portion 620. For example, the electrical contacts 675 (e.g., the respective arms 668 of the electrical contacts 675) may be biased (e.g., spring-loaded) away from the printed circuit board 672 of the bottom bar module 605.

The first cover 630a may be located between the solar cell modules 660 and the first end cap 640a at the first end 601 of the bottom bar 600. The electrical contacts 675 may be configured to bias the first cover 630a away from the printed circuit board 672, such that the first cover 630a is flush with the rear surface 606 of the bottom bar 600. Furthermore, the ribs 678 of the first cover 630a may be configured to guide respective electrical contacts 675 through the respective opening 679. For example, the first cover 630a may comprise two ribs 678 surrounding a respective opening 679 such that the respective electrical contact 675 may pass between the two ribs 678 and through the opening 679. Furthermore, the curved wall 682a of the first cover 630a may be configured to abut a curved edge of the interior wall 654 defining the cutout 655 located at the first end 621 of the body 622 of the second housing portion 620. The first cover 630a may further comprise an extension 682b projecting from a side edge of the peripheral wall 631. The curved wall 682a and/or the extension 682b may be configured to fit between upper and lower edges of the cutout 655 in the interior wall 654 of the second housing portion 620. The first cover 630a may also comprise one or more upper projections 656a (e.g., two planar projections) and one or more lower projections 656b (e.g., one planar projection) extending from the second surface 633b of the peripheral wall 631 (e.g., as shown in FIG. 36). The upper and lower projections 656a, 656b may be configured to extend into the cutout 655 and abut an upper edge and a lower edge of the cutout 655, respectively. In this way, each of the curved wall 682a, the extension 682b, the upper projection 656a, and/or the lower wall 656b of the first cover 630a may be configured to align the first cover 630a within the recess 650 of the second housing portion 620. Other configurations are possible.

In some examples, the printed circuit board assembly 670 may be attached to the first cover 630a (e.g., a surface opposite the first surface 633a of the peripheral wall 631 of the first cover 630a) via a fastener (e.g., a screw—not shown) received through an opening (not shown) in the printed circuit board 672 and an opening (not shown) in the peripheral wall 631 of the first cover 630a.

Further, in some examples, the electrical contacts 675 may be located at the first surface 633a of the peripheral wall 631 of the first cover 630a. The electrical contacts 675 may be arranged (e.g., located) in bays (e.g., similar to the bays 538) formed in the first surface 633a of the peripheral wall 631 of the first cover 630a. The electrical contacts 675 may each comprise a respective pin (e.g., not shown, but could be similar to the pins 578) that extends through respective bays (e.g., not shown, but could be similar to the bays 538) and into a respective opening (e.g., not shown, but could be similar to the openings 579) in the printed circuit board 672 when the electrical contacts 675 are received in the bays in the first surface 633a of the peripheral wall 631 of the first cover 630a. The pins may be soldered to the printed circuit board 672 when the pins are received in the respective openings for electrically connecting the electrical contacts 675 to the electrical circuitry 674 of the solar power system of the bottom bar module 605 mounted to the printed circuit board 672. In some examples (e.g., when the printed circuit board assembly 670 is attached to the first cover 630a), the bottom bar 600 may not comprise the rear cover 630b.

Further, in some examples, the printed circuit board assembly 670 may be attached to the first housing portion 610. For example, the printed circuit board assembly 670 may be attached to a surface that is opposite the front surface 604 of the first housing portion 610. In such examples, the electrical contacts 675 may be accessible via the front surface 604 of the first housing portion 610. For example, the front surface 604 of the first housing portion 610 may include one or more openings (e.g., similar to the opening 679), and the electrical contacts 675 (e.g., the respective arms 668) may be configured to extend through the openings in the front surface 604 of the first housing portions 610. Further, in such examples, the first cover 630a and/or the second cover 630b may be omitted and/or the openings 679 in the first cover 630a may be omitted.

When the bottom bar 600 is docked with the motor drive unit (e.g., when the covering material is in the docked position P_{DOCKED}), the electrical contacts 675 of the bottom bar 600 may be configured to contact respective electrical contacts of the dock (e.g., such as the electrical contacts 285, 385 of the dock 280, 380 shown in FIGS. 8, 14, and 15). The electrical contacts of the dock may be, for example, biased (e.g., spring-loaded) towards the first cover 630a of the bottom bar 600 to help establish and/or maintain electrical contact between the electrical contacts 675 of the bottom bar 600 and the electrical contacts of the dock when the bottom bar 600 is docked.

In some examples, the bottom bar module 605 may not comprise electrical contacts, but may alternatively comprise one or more induction coils with one or more corresponding induction coils located on the dock (e.g., the dock 280 or 380) (e.g., a first induction coil included in the bottom bar 600 and a second induction coil included in the dock) to facilitate inductive coupling (e.g., magnetic coupling) between the bottom bar module 605 and the dock. In such examples, when the covering material is in the docked position P_{DOCKED} (e.g., when the bottom bar 600 is docked), the induction coil of the bottom bar module 605 may be inductively coupled to the induction coil of the dock, such that the energy storage element of the motor drive unit may be configured to charge from the energy storage element 608 of the bottom bar module 605 via the charging circuit.

The energy stored in the energy storage element 608 of the bottom bar 600 may be discharged into the energy storage elements of the motor drive unit when the bottom bar 600 is docked with the motor drive unit, for example, when the bottom bar 600 is in the docked position P_{DOCKED}. For example, the motor drive unit may comprise one or more energy storage elements (not shown) configured to charge from the energy storage element 608 of the bottom bar 600 when the covering material is in the docked position P_{DOCKED}. For example, the electrical circuitry 674 of the solar power system of the bottom bar module 605 mounted to the printed circuit board 672 (e.g., the printed circuit board assembly 670) may comprise a charging circuit electrically connected to the energy storage element 608 and the electrical contacts 675, such that the one or more energy storage elements of the motor drive unit are configured to charge from the energy storage element 608 of the bottom bar module 605 via the charging circuit of the solar power system when the bottom bar 600 is docked. In addition, the electrical circuitry 674 of the solar power system of the bottom bar module 605 mounted to the printed circuit board 672 (e.g., the printed circuit board assembly 670) may comprise a control circuit (e.g., a microprocessor or other suitable processing device, as described herein) configured to control the solar cell management circuit and/or the charging circuit mounted to the printed circuit board 672. In some examples, the energy storage element 608 may be electrically connected (e.g., directly connected) to the electrical contacts 675 of the bottom bar 600 (e.g., the motor drive unit may comprise a charging circuit for charging the energy storage elements 608 of the bottom bar 600).

The second housing portion 620 (e.g., including the solar cell modules 660, the spacer board 645, and/or the first cover 630a that may be attached thereto) may be attached to the first housing portion 510. As described above, the first projection 639a of the upper wall 634 of the second cover 630b may be configured to fit within the first channel 685a defined by the first attachment member 680a of the second housing portion 620, and the second projection 639b of the lower wall 635 of the second cover 630b may be configured to fit within the second channel 685b defined by the second attachment member 680b of the second housing portion 620. As shown in FIG. 40, the first housing portion 610 may be configured to abut the second attachment member 680b of the second housing portion 620 and the second cover 630b. Other variations are possible.

The first and second end caps 640a, 640b may be configured to be attached to the first housing portion 610 (e.g., to the first end 611 and the second end 613 of the body 612, respectively) and/or to the second housing portion 620 (e.g., to the first end 621 and the second end 623 of the body 622, respectively). For example, the second end cap 640b (e.g., as shown in FIG. 39) may be a mirror image of the first end cap 640a (e.g., as shown in FIG. 36). The first and second end caps 640a, 640b may each comprise an end portion 641 (e.g., a plate portion). The first and second end caps 640a, 640b (e.g., the respective end portions 641) may be configured to hold the solar cell modules 660, the first cover 630a, and the spacer boards 645 within the recess 650 of the second housing portion 620 when the second housing portion 620 and the first and second end caps 640a, 640b are attached to the first housing portion 610. The first and second end caps 640a, 640b may be further configured to hold the second cover 630b (e.g., including the printed circuit board assembly 670) within the housing 602 of the bottom bar 600 (e.g., between the first housing portion 610 and the second housing portion 620). The first and second end caps 640a, 640b (e.g., the respective end portions 641) may be configured to cover (e.g., enclose) the recess 650 of the second housing portion 620 (e.g., respective portions of the recess 650 at the first end 621 and the second end 623 of the body 622 of the second housing portion 620) when the first and second end caps 640a, 640b are attached to the first housing portion 610.

The first and second end caps 640a, 640b may each comprise one or more attachment members 642 (e.g., four attachment members 642, as shown in FIG. 40), one or more outer walls 643 (e.g., two outer walls 643, as shown in FIGS. 36 and 39), and an interior wall 644. Each of the attachment members 642, the outer walls 643, and the interior wall 644 may be configured to extend from the respective end portion 641. One of the outer walls 643 may be configured to fit within the first and second channels 652a, 652b of the second housing portion 620 (e.g., such that the one of the outer walls 643 is parallel to the interior wall 654 of the second housing portion 620), and the other of the outer walls 643 may be configured to fit within a second channel 619b of the first housing portion 610 (e.g., such that the other of the outer walls 643 is parallel to the front wall 614 of the first housing portion 610).

The first housing portion 610 may comprise first and second flanges 618a, 618b extending from the first wall 692. The first flange 618a, the first wall 692, and the second flange 618b may form a first channel 619a of the first housing portion 610. The front wall 614, the first wall 692, and the second flange 618b may form the second channel 619b of the first housing portion 610. One of the attachment members 642 of the first end cap 640a may be received within the first channel 619a at the first end 611 of the first housing portion 610, and another of the attachment members 642 of the first end cap 640a may be received within the second channel 619b at the first end 611 of the first housing portion 610. Similarly, one of the attachment members 642 of the second end cap 640b may be received within the first channel 619a at the second end 613 of the first housing portion 610, and another of the attachment members 642 of the second end cap 640b may be received within the second channel 619b at the second end 613 of the first housing portion 610 (e.g., as shown in FIG. 40). Furthermore, another of the attachment members 642 of the first end cap 640a may be received between the lower wall 626 and the second attachment member 680b of the second housing portion 620, and yet another of the attachment members 642 of the first end cap 640a may be received between the front wall 614 and the second wall 698 of the first housing portion 610. Similarly, another of the attachment members 642 of the second end cap 640b may be received between the lower wall 626 and the second attachment member 680b of the second housing portion 620, and yet another of the attachment members 642 of the second end cap 640b may be received between the front wall 614 and the second wall 698 of the first housing portion 610 (e.g., as shown in FIG. 40). Other configurations are possible to secure the first and second end caps 640a, 640b to the first and second housing portions 610, 620.

The bottom bar module 605 (e.g., the second housing portion 620) may be removably attached to the first housing portion 610. For example, the second housing portion 620 may be detached from the first housing portion 610 while the first housing portion 610 remains coupled to the covering material to allow for servicing of the solar power system of the bottom bar module 605. The second housing portion 620 may comprise a releasable attachment structure, such as the first and second attachment members 680a, 680b, which may be configured to engage with the first housing portion 610 to attach (e.g., removably attach) the second housing portion 620 to the first housing portion 610. The first attachment member 680a may be configured to engage with the first channel 619a of the first housing portion 610 (e.g., as shown in FIG. 40). For example, the first attachment member 680a may comprise a spring arm 629a that may extend into and engage the first channel 619a of the first housing portion 610 for attaching the second housing portion 620 to the first housing portion 610. The second attachment member 680b may be configured to engage with the flange 697a and/or the recess 697b of the first housing portion 610 (e.g., as shown in FIG. 40). For example, the second attachment member 680b may comprise an engagement portion 629b that may extend (e.g., extend downward in the transverse direction) into the recess 697b and/or engage with the flange 697a extending from the second wall 698 of the first housing portion 610 when the second housing portion 620 is attached to the first housing portion 610.

The lower wall 626 of the second housing portion 620 may comprise an actuation portion 699 that may be actuated or flexed by a user to detach the second attachment member 630b from the second cover 630b and the second wall 698, thus detaching the second housing portion 620 from the first housing portion 610 and the second cover 630b (e.g., disengaging the second housing portion 620 from attachment with the first housing portion 610). For example, when the actuation portion 699 of the lower wall 626 is pushed up and/or pulled away from the first housing portion 610, the spring arm 629a of the first attachment member 680a may push against a surface of the first channel 619a (e.g., the first wall 692) and may flex, which may cause the second housing portion 620 (e.g., and the second cover 630b) to move up (e.g., in the transverse direction T). The second attachment member 680b (e.g., the engagement portion 629b) may be pulled out from the recess 659c and may disengage with the flange 659b (e.g., out of engagement with the first housing portion 610). At this time, the second housing portion 620 may be pulled away from the first housing portion 610.

The bottom bar module 605 (e.g., the second housing portion 620) may be an assembly for housing and/or supporting the solar power system. The bottom bar module 605 may comprise the second housing portion 620, the solar cell modules 660 (e.g., located in the recess 650), the energy storage element 608, and the printed circuit board assembly 670 (e.g., located within the second cover 630b and including the electrical contacts 675). Since the bottom bar module 605 (e.g., the second housing portion 620) may be removed from the first housing portion 610 without removing the first housing portion 610 from the covering material, the solar power system of the bottom bar 600 may be easily serviced after the motorized window treatment is installed. For example, the bottom bar module 605 may be removed from the first housing portion 610 and replaced with a new bottom bar module to replace the solar cell modules 660 and/or the energy storage element 608. For example, if one or more of the solar cell modules 660 or another component of the bottom bar module 605 needs to be replaced, or if upgraded components are available, the bottom bar module 605 (e.g., one or more components of the bottom bar module 605) may be accessed, serviced, and/or removed by a technician. As another example, such removal would allow for upgrading the operation of the bottom bar module 605 (e.g., new software, or newer solar cells or energy storage elements having a greater capacity). One will appreciate that other configurations of the first and second housing portions 610, 620 are possible to allow for the bottom bar module 605 and/or the second housing portion 620 to be detached from the first housing portion 610 (which may remain attached to the covering material) to allow for servicing of the bottom bar module 605.

In some examples, the bottom bar 600 may include one or more sensors, such as an occupancy sensor, a vacancy sensor, a photosensor, etc. The bottom bar 600 may be configured to control the motorized window treatment and/or external devices (e.g., such as lighting loads) based on feedback from the sensor(s). Such sensors may be located on and/or connected to the printed circuit board 672. The sensors may be powered by the solar cells 662 of the bottom bar 600 (e.g., via the energy storage element 608). Further, the housing 602 of the bottom bar 600 may include one or more openings for the sensors (e.g., such as through the first cover 630a). In some examples, the motor drive unit may be configured to move the covering material to the raised position P_{RAISED} or to the lowered position P_{LOWERED} based on feedback from the one or more sensors of the bottom bar 600, e.g., if the sensors detect that the window is open.

Although it is described herein that the bottom bar 600 that includes the solar cells 662 and that is configured to charge a motor drive unit, other configurations of the bottom bar 600 may be possible. In some examples, the bottom bar 600 may not be configured to charge the motor drive unit (e.g., the solar cells 664 may power elements such as sensors that may be located on or in the bottom bar 600). Further, in some examples, the bottom bar 600 may not include the electrical contacts 675 (e.g., in examples where the bottom bar does not charge the motor drive unit, but instead the solar cells 664 may be used to power the printed circuit board 672 and/or the sensors).

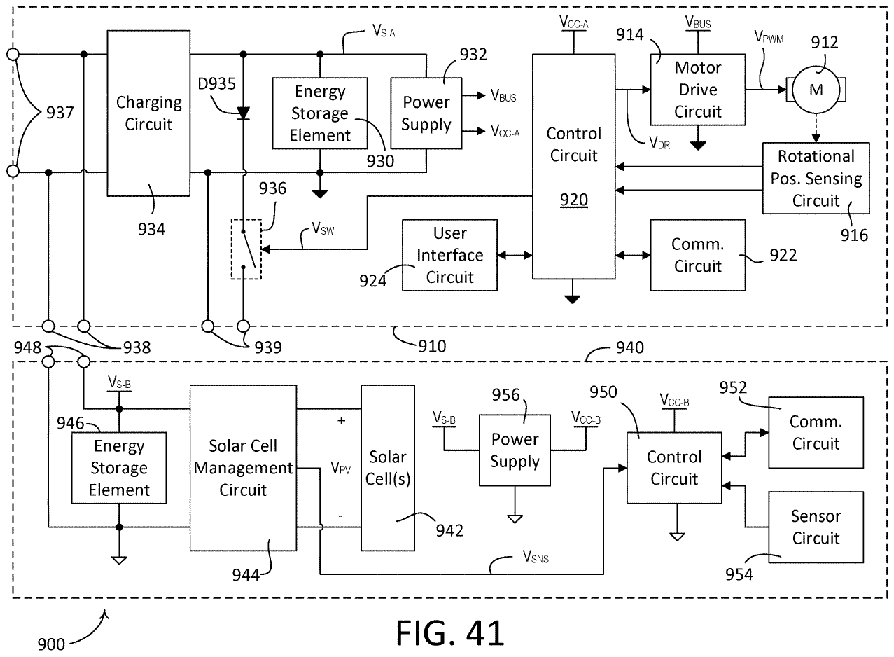

FIG. 41 is a simplified block diagram of a covering system, such as a motorized window treatment control system 900 for controlling a motorized window treatment (e.g., the motorized window treatments 150 of the load control system 100, the motorized window treatment 200, the bottom bar 340, the bottom bar 400, the bottom bar 500, and/or the bottom bar 600). The motorized window treatment may comprise a covering material (e.g., the covering material 152, 230, 330) that may be wound around a roller tube (e.g., the roller tubes 154, 212, 312) and may extend to a bottom bar (e.g., the bottom bars 155, 240, 340, 400, 500, 600). The motorized window treatment control system 900 may comprise a motor drive unit 910 (e.g., the motor drive units 156, 250, 350) for rotating the roller tube for raising and lowering the covering material to adjust a present position P_{PRES} of the covering material (e.g., the bottom bar). The motor drive unit 910 may include a motor 912 (e.g., a direct-current motor) that may be coupled to the roller tube for rotating the roller tube. The motor drive unit 910 may include a motor drive circuit 914 (e.g., an H-bridge drive circuit) that receives a bus voltage V_{BUS} and may generate a pulse-width modulated (PWM) voltage V_{PWM} for driving the motor 912. For example, the motor drive circuit 914 may comprise an H-bridge drive circuit and/or an H-bridge controller (e.g., an integrated circuit) for controlling the H-bridge drive circuit to generate the PWM voltage V_{PWM} across the motor 912.

The motor drive unit 910 may include a control circuit 920 (e.g., a motor control circuit) for controlling the operation of the motor 912. The control circuit 920 may include, for example, a microprocessor, a programmable logic device (PLD), a microcontroller, an application specific integrated circuit (ASIC), a field-programmable gate array (FPGA), or any suitable processing device or control circuit. The motor drive unit 910 may include instructions (e.g., software instructions) that configure the control circuit 920 to generate at least one drive signal V_{DR} for controlling the motor drive circuit 914. The motor drive circuit 914 may be configured to control the rotational speed and the direction of rotation of the motor 912 in response to the drive signal V_{DR}. The control circuit 920 may be configured to control the motor drive circuit 914 to rotate the motor 912 to adjust a present position P_{PRES} of the covering material (e.g., of the bottom bar). The motor drive unit 910 may be configured to control the covering material between a raised position P_{RAISED} (e.g., a fully-raised position and/or a fully-open position) and a lowered position P_{LOWERED} (e.g., a fully-lowered position and/or a fully-closed position). The motor drive unit 910 (e.g., the control circuit 920) may be configured to cause the covering material to be moved into a docked position P_{DOCKED}, which may be the position of the covering material when a bottom bar module 940 is adjacent to (e.g., in electrical connection with) a dock of the motorized window treatment. The docked position P_{DOCKED} may be, in some examples, above the raised position P_{RAISED} such that the raised position P_{RAISED} is between the lowered position P_{LOWERED} and the docked position P_{DOCKED}. The covering material may be fully wound around the roller tube in the docked position P_{DOCKED} and fully extended in the lowered position P_{LOWERED}. The control circuit 920 may be configured to set limits (e.g., an upper limit position P_{UP-LIMIT} and a lower limit position P_{LO-LIMIT}) for limiting a range across which the present position P_{PRES} of the covering material may be adjusted (e.g., to be less than a full range between the raised position P_{RAISED} and lowered position P_{LOWERED}.

The motor drive unit 910 may comprise a memory (not shown), e.g., such as a non-volatile memory. The memory may be communicatively coupled to the control circuit 920 for the storage and/or retrieval of, for example, operational settings of the motor drive unit 910. In addition, the memory may be configured to store software for execution by the control circuit 920 to operate the motor drive unit 910 as described herein. The memory may be implemented as an internal circuit of the control circuit 920 or as an external integrated circuit (IC). The memory may comprise a computer-readable storage media or machine-readable storage media that maintains computer-executable instructions for performing one or more of the procedures and/or routines as described herein. For example, the memory may comprise computer-executable instructions or machine-readable instructions that include one or more portions of the procedures and/or routines described herein. The control circuit 920 may access the instructions from memory for being executed to cause the control circuit 920 to operate as described herein, or to operate one or more other devices as described herein. The memory may comprise computer-executable instructions for executing configuration software. In addition, the memory may have stored thereon one or more settings and/or control parameters associated with the motor drive unit 910. The control circuit 920 may store the present position of the covering material and/or limits for controlling the position of the covering material (e.g., the fully-raised position P_{RAISED} and/or the fully-lowered position P_{LOWERED}) in the memory. The control circuit 920 may be configured to store a record of a movement of the covering material each time that the control circuit 920 controls the motor 912 to adjust the present position P_{PRES} of the covering material.

The motor drive unit 910 may include a rotational position sensing circuit 916, such as, for example, a Hall effect sensor (HES) circuit, which may be configured to generate first and second rotational position sensing signals V_{S1}, V_{S2}. The first and second rotational position sensing signals V_{S1}, V_{S2} may indicate the rotational speed and/or the direction of rotation of the motor 912 to the control circuit 920. The rotational position sensing circuit 916 may include other suitable position sensors, such as, for example, magnetic, optical, and/or resistive sensors. The control circuit 920 may be configured to determine the rotational position of the motor 912 in response to the first and second rotational position sensing signals V_{S1}, V_{S2} generated by the rotational position sensing circuit 916. The control circuit 920 may be configured to determine the present position P_{PRES} of the covering material in response to the rotational position of the motor 912. The operation of a motor drive circuit (e.g., the motor drive circuit 914) and a rotational position sensing circuit (e.g., the rotational position sensing circuit 916) of a motor drive unit (e.g., the motor drive unit 910) is described in greater detail in commonly-assigned U.S. Pat. No. 5,848,934, issued Dec. 15, 1998, entitled MOTORIZED WINDOW SHADE SYSTEM, and commonly-assigned U.S. Pat. No. 7,839,109, issued Nov. 23, 2010, entitled METHOD OF CONTROLLING A MOTORIZED WINDOW TREATMENT, the entire disclosures of which are hereby incorporated by reference.

The motor drive unit 910 may include a communication circuit 922 that may allow the control circuit 920 to transmit and receive messages (e.g., digital messages) via signals, e.g., wired signals and/or wireless signals, such as RF signals. For example, the control circuit 920 may be configured to communicate messages via the RF signals using a wireless communication protocol (e.g., a proprietary RF protocol, such as the CLEAR CONNECT protocol (e.g., CLEAR CONNECT TYPE A and/or CLEAR CONNECT TYPE X protocols), and/or a standard protocol, such as one of WIFI, cellular (e.g., 3G, 4G LTE, 5G NR, or other cellular protocol), BLUETOOTH, BLUETOOTH LOW ENERGY (BLE), ZIGBEE, Z-WAVE, THREAD, KNX-RF, ENOCEAN RADIO protocols, or a different standard protocol). The communication circuit 922 may be implemented as an internal circuit of the control circuit 920 or as an external integrated circuit.

The control circuit 920 may be configured to control the motor 912 to control the movement of the covering material in response to a shade movement command received in messages received via the communication circuit 922 from a remote control device. For example, the shade movement command may include a commanded position P_{CMD} to which the control circuit 920 will control the covering material. In addition, the control circuit 920 may be configured to receive messages from external devices. For example, the control circuit 920 may be configured to receive messages including indications of occupancy conditions and/or vacancy conditions in the space in which the motorized window treatment is installed from occupancy sensors and/or vacancy sensors, and messages including indications of an ambient light level in the space in which the motorized window treatment is installed form daylight sensors. Further, the control circuit 920 may be configured to transmit messages including a status of the motorized window treatment control system 900, such as the present position P_{PRES} of the covering material. During a configuration procedure (e.g., an association procedure), the motor drive unit 910 may be associated with a remote control device, such that the control circuit 920 may be responsive to the messages transmitted by the remote control device (e.g., via wireless signals).

The motor drive unit 910 may include a user interface circuit 924 having one or more buttons, for example, that allow a user to provide inputs to the control circuit 920 during setup and/or configuration of the motorized window treatment. The control circuit 920 may be configured to control the motor 912 to control the movement of the covering material in response to a shade movement command received via the communication circuit 922 and/or the user inputs received via the buttons of the user interface circuit 924. The user interface circuit 924 may also include one or more light-emitting diodes (LEDs) that may be illuminated by the control circuit 920, for example, to provide feedback to a user of the motorized window treatment.

The motor drive unit 910 may include a sensor circuit (not shown) coupled to the control circuit 920. For example, the sensor circuit may comprise a photosensor configured to generate a signal that indicates a light level, such as a daylight level L_{DL} outside the window that the motorized window treatment is covering and/or an ambient light level L_{AMB} inside the space in which the motorized window treatment is located. The control circuit 920 of the motor drive unit 910 may be configured to control the motor 912 to control the movement of the covering material in response to the daylight level L_{DL} and/or the ambient light level L_{AMB} indicated by the sensor circuit. In addition, the sensor circuit may comprise an occupancy detection circuit configured to detect when the space in which the motorized window treatment is installed is occupied and/or vacant. For example, the occupancy detection circuit may comprise a passive infrared (PIR) detection circuit for detecting movement of occupants in the space. The control circuit 920 of the motor drive unit 910 may be configured to control the motor 912 to control the movement of the covering material in response to an occupancy condition and/or a vacancy condition detected by the occupancy detection circuit.

The electrical circuitry of the motor drive unit 910 may be powered from a first storage voltage V_{S-A} produced across an energy storage element 930 of the motor drive unit 910. For example, the energy storage element 930 may comprise one or more individual storage elements electrically coupled in parallel. The individual storage elements of the energy storage element 930 may comprise, for example, one or more of rechargeable batteries and/or supercapacitors. In some examples, the energy storage element 930 may be external to the motor drive unit 910 (e.g., external to an enclosure of the motor drive unit 910, such as the enclosure 252 of the motor drive unit 250). The motor drive unit 910 may comprise a power supply 932 configured to receive the first storage voltage V_{S-A} and generate one or more supply voltages for powering the electrical circuitry of the motor drive unit 910. For example, the power supply 932 may be configured to generate a low-voltage supply voltage V_{CC-A} for powering the control circuit 920, the memory, the communication circuit 922, and/or the user interface circuit 924. In addition, the power supply 932 may be configured to generate the bus voltage V_{BUS} for powering the motor drive circuit 914. In some examples, the motor drive circuit 914 may be configured to be powered directly from the first storage voltage V_{S-A} produced across the energy storage element 930. The energy storage element 930 of the motor drive unit 910 may be configured to charge through a charging circuit 934 from a second storage voltage V_{S-B} received via electrical connections 938.

The motor drive unit 910 may further comprise electrical connections 939 that may be connected to a power bus (e.g., the power bus 158 shown in FIG. 1) for coupling the motor drive unit 910 to the motor drive units of other motorized window treatments (e.g., nearby motorized window treatments). For example, the power bus may comprise two electrical conductors (e.g., wires) coupled between the motor drive units, which may be coupled in parallel with each other. The motor drive unit 910 may be configured to provide the first storage voltage V_{S-A} produced across the energy storage element 930 at the electrical connections 939 (e.g., to provide the first storage voltage V_{S-A} on the power bus). For example, the motor drive unit 910 may comprise a diode D935 coupled in series with a switching circuit 936 between the first storage voltage V_{S-A} and one of the electrical connections 939 (e.g., with the other electrical connection 939 coupled to circuit common). The control circuit 920 may be configured to generate a switch control signal V_{SW} for rendering the switching circuit 936 conductive and non-conductive for controllably providing the first storage voltage V_{S-A} to the electrical connections 939. The control circuit 920 may be configured to generate the switch control signal V_{SW} to render the switching circuit 936 to charge energy storage elements of one or more of the other motor drive units coupled to the power bus.

The motorized window treatment control system 900 may further comprise a bottom bar module 940 that may be located in the bottom bar. For example, the electrical circuitry of the bottom bar module 940 may be mounted to a printed circuit board (e.g., the printed circuit boards 272, 472, 572, 672) in the bottom bar. The bottom bar module 940 may comprise one or more solar cells 942 (e.g., photovoltaic cells) that may be mounted to a rear surface of the bottom bar (e.g., such as the solar cells 270, 370, 462, 562, 662 are mounted to the bottom bars 240, 340, 400, 500, 600 respectively). The solar cells 942 may be configured to convert received solar energy into a photovoltaic output voltage V_{PV}. The bottom bar module 940 may also comprise a solar cell management circuit 944 configured to charge an energy storage element 946 of the bottom bar for producing the second storage voltage V_{S-B} across the energy storage element 946. For example, the solar cell management circuit 944 may be configured to control the charging of the energy storage element 946. The energy storage element 946 of the bottom bar module 940 may, for instance, comprise one or more individual storage elements electrically coupled in parallel. The individual storage elements of the energy storage element 946 may comprise, for example, one or more of rechargeable batteries and/or supercapacitors. For example, the solar cell management circuit 944 may comprise a boost converter for generating the second storage voltage V_{S-B} from the photovoltaic output voltage V_{PV}. The solar cell management circuit 944 may include, for example, a maximum power point tracking (MPPT) solar charge controller. The solar cell management circuit 944 may be characterized by a duty cycle DC_{SCM} for driving a transistor of the boost converter to generate the second storage voltage V_{S-B} from the photovoltaic output voltage V_{PV}. The solar cell management circuit 944 may be configured to adjust the duty cycle DC_{SCM} to track a maximum power point for charging the energy storage element 946.

The bottom bar module 940 may comprise electrical connections 948 configured to be coupled to (e.g., electrically and/or inductively coupled to) the electrical connections 938 of the motor drive unit 910, for example, via electrical connections of a dock. For example, the electrical connections 938 of the motor drive unit 910 may represent the electrical contacts 285 of the dock 280 and/or the electrical contacts 385 of the dock 380. In addition, the electrical connections 948 of the bottom bar module 940 may represent the electrical contacts 275 of the bottom bar 240, the electrical contacts 375 of the bottom bar 340, the electrical contacts 475 of the bottom bar 400, the electrical contacts 575 of the bottom bar 500, and/or the electrical contacts 675 of the bottom bar 600.

In some examples, the motor drive unit 910 and the bottom bar module 940 may not comprise the respective electrical connections 938, 948, but may alternatively comprise respective induction coils to facilitate inductive coupling (e.g., magnetic coupling) between the bottom bar module 940 and the motor drive unit 910. When the covering material is in the docked position P_{DOCKED} (e.g., when the bottom bar is docked), the electrical connections 948 of the bottom bar module 940 may be coupled to (e.g., electrically and/or inductively coupled to) the electrical connections 938 of the motor drive unit 910, such that the energy storage element 930 of the motor drive unit 910 is configured to charge from the energy storage element 946 of the bottom bar module 940 via the charging circuit 934. While the charging circuit 934 is shown in FIG. 41 as a part of the motor drive unit 910, the charging circuit 934 could alternatively or additionally be included in the bottom bar module 940.

The bottom bar module 940 may include a control circuit 950 (e.g., a bottom bar control circuit), which may include, for example, a microprocessor, a programmable logic device (PLD), a microcontroller, an application specific integrated circuit (ASIC), a field-programmable gate array (FPGA), or any suitable processing device or control circuit. The control circuit 950 of the bottom bar module 940 may be configured to monitor the operation of the solar cells 942 and/or the energy storage element 946. The control circuit 950 of the bottom bar module 940 may be configured to receive one or more sense signals V_{SNS} from the solar cell management circuit 944. The one or more sense signals V_{SNS} received from the solar cell management circuit 944 may indicate, for example, a magnitude of the photovoltaic output voltage V_{PV} generated by the solar cells 942 and/or a magnitude of the second storage voltage V_{S-B} generated across the energy storage element 946. For example, the one or more sense signals V_{SNS} generated by the solar cell management circuit 944 may comprise DC signals having magnitudes that indicate the magnitude of the photovoltaic output voltage V_{PV} and/or the magnitude of the second storage voltage V_{S-B} (e.g., the solar cell management circuit 944 may comprise one or more resistive divider circuits for generating the one or more sense signals V_{SNS}). In addition, the one or more sense signals V_{SNS} generated by the solar cell management circuit 944 may comprise messages (e.g., digital messages) including indications of the magnitude of the photovoltaic output voltage V_{PV} and/or the magnitude of the second storage voltage V_{S-B}.

In some examples, the bottom bar module 940 may comprise a memory (not shown), e.g., such as a non-volatile memory. The memory may be communicatively coupled to the control circuit 950 for the storage and/or retrieval of, for example, operational settings of the bottom bar module 940. In addition, the memory may be configured to store software for execution by the control circuit 950. The memory may be implemented as an internal circuit of the control circuit 950 or as an external integrated circuit. The memory may comprise a computer-readable storage medium or machine-readable storage media that maintains computer-executable instructions for performing one or more of the procedures and/or routines as described herein. For example, the memory may comprise computer-executable instructions or machine-readable instructions that include one or more portions of the procedures and/or routines described herein. The control circuit 950 may access the instructions from the memory for being executed to cause the control circuit 920 to operate as described herein, or to operate one or more other devices as described herein. The memory may comprise computer-executable instructions for executing configuration software. In addition, the memory may have stored thereon one or more settings and/or control parameters associated with the motor drive unit 910. The control circuit 950 may store measurements (e.g., the magnitude of the photovoltaic output voltage V_{PV} and/or the magnitude of the second storage voltage V_{S-B}) and/or operational characteristics (e.g., the duty cycle DC_{SCM} of the solar cell management circuit 944) in the memory.

The bottom bar module 940 may include a communication circuit 952 that may allow the control circuit 950 to communicate messages (e.g., digital messages) with the communication circuit 922 of the motor drive unit 910 via a communication link, such as a wired communication link and/or a wireless communication link, e.g., an RF communication link. The control circuit 950 of the bottom bar module 940 may be configured to communicate messages with the control circuit 920 of the motor drive unit 910, for example, via RF signals using a short-range wireless communication protocol (e.g., the BLUETOOTH LOW ENERGY (BLE) protocol, the Thread wireless communication protocol, etc.). In addition, the communication circuit 922 of the motor drive unit 910 and the communication circuit 952 of the bottom bar module 940 may be coupled together via a wired communication link, for example, when the bottom bar is docked. For example, the communication circuit 922 of the motor drive unit 910 may be coupled to the electrical connections 938 and the communication circuit 952 of the bottom bar module 940 may be coupled to the electrical connections 948, such that the communication circuits 922, 952 are configured to communicate with each other via the electrical connections 938, 948 when the bottom bar is docked. In addition, the motor drive unit 910 and/or the bottom bar module 940 may comprise additional electrical connections to allow the communication circuits 922, 952 to communicate with each other via the wired communication link.

In some examples, the communication circuit 922 and the communication circuit 952 may be configured for infrared (IR) communication. For example, the communication circuit 952 may comprise an IR emitter, and the communication circuit 922 may comprise an IR receiver. As such, the communication circuit 952 may allow the control circuit 950 to communicate messages (e.g., digital messages) with the communication circuit 922 of the motor drive unit 910 via an IR communication link. In some examples, the communication circuit 922 of the motor drive unit 910 may include an IR receiver that may be located at an end portion of the motor drive unit 910, and the communication circuit 952 of the bottom bar module 940 may include an IR transmitter that may be located at a corresponding (e.g., aligned) end portion of the bottom bar. Alternatively or additionally, the communication circuit 922 of the motor drive unit 910 may be an IR dongle that, for example, may be coupled to the control circuit 920 of the motor drive unit 910 via a USB connection.

The control circuit 950 of the bottom bar module 940 may be configured to transmit messages including measurements recorded by the bottom bar module 940 and/or one or more operational characteristics of the bottom bar module 940. For example, the control circuit 950 of the bottom bar module 940 may be configured to transmit a message including an indication of a measurement of the magnitude of the photovoltaic output voltage V_{PV} generated by the solar cells 942 and/or an indication of a measurement of the magnitude of the second storage voltage V_{S-B} generated across the energy storage element 946 to the control circuit 920 of the motor drive unit 910. In addition, the control circuit 950 of the bottom bar module 940 may be configured to transmit a message including an indication of an operational characteristic of the solar cell management circuit 944, such as the duty cycle DC_{SCM} of the solar cell management circuit 944.

The bottom bar module 940 may include a sensor circuit 954 coupled to the control circuit 950. For example, the sensor circuit 954 may comprise a photosensor configured to generate a signal that indicates a light level, such as the daylight level L_{DL} outside the window that the motorized window treatment is covering and/or the ambient light level L_{AMB} inside the space in which the motorized window treatment is located. The control circuit 950 of the bottom bar module 940 may be configured to transmit a message including the daylight level L_{DL} and/or the ambient light level L_{AMB} indicated by the sensor circuit 954 to the motor drive unit 910. In addition, the sensor circuit 954 may comprise one or more orientation detection sensors, such as an accelerometer and/or a gyroscope. For example, the control circuit 950 of the bottom bar module 940 may be configured to determine when the motor drive unit 910 is adjusting the present position P_{PRES} (e.g., the bottom bar is moving) in response to the accelerometer and/or the gyroscope of the sensor circuit 954. Further, the sensor circuit 954 may comprise an occupancy detection circuit configured to detect when the space in which the motorized window treatment is installed is occupied and/or vacant. For example, the occupancy detection circuit may comprise a passive infrared (PIR) detection circuit for detecting movement of occupants in the space. The control circuit 950 of the bottom bar module 940 may be configured to transmit a message including an indication of an occupancy condition and/or a vacancy condition to the motor drive unit 910.

The bottom bar module 940 may also comprise a power supply 956 configured to receive the second storage voltage V_{S-B} and generate a low-voltage supply voltage V_{CC-B} for powering the control circuit 950, the memory, the communication circuit 952, and/or the sensor circuit 954.

The control circuit 920 of the motor drive unit 910 and/or the control circuit 950 of the bottom bar module 940 may be configured to determine a magnitude of a solar power P_{SOLAR} being received (e.g., presently being received) by the solar cells 942. The control circuit 920 of the motor drive unit 910 and/or the control circuit 950 of the bottom bar module 940 may be configured to calculate the solar power P_{SOLAR} as a function of the magnitude of the photovoltaic output voltage V_{PV}, the magnitude of the second storage voltage V_{S-B}, and/or the duty cycle DC_{SCM} of the solar cell management circuit 944 (e.g., as received from the bottom bar module 940).

The control circuit 920 of the motor drive unit 910 may be configured to adjust the present position P_{PRES} of the covering material in response to the magnitude of the solar power P_{SOLAR} being received (e.g., presently being received) by the solar cells 942 of the bottom bar module 940. The control circuit 920 of the motor drive unit 910 may be configured to adjust the present position P_{PRES} of the covering material to improve the magnitude of the solar power P_{SOLAR} being received by the solar cells 942. For example, the control circuit 920 of the motor drive unit 910 may be configured to adjust present position P_{PRES} of the covering material to move the bottom bar out of a location of low sunlight to a location of higher sunlight. The control circuit 920 may be configured to compare the magnitude of the solar power P_{SOLAR} being received by the solar cells 942 to a low-power threshold P_{TH-LP} and may be configured to move the covering material until the magnitude of the solar power P_{SOLAR} being received by the solar cells 942 of the bottom bar module 940 has increased above an acceptable-power threshold P_{TH-ACC}.

The control circuit 920 of the motor drive unit 910 may be configured to control the motor drive circuit 914 to move the covering material to the docked position P_{DOCKED}, such that the bottom bar is docked and the electrical connections 948 of the bottom bar module 940 may be coupled to (e.g., electrically and/or inductively coupled to) the electrical connections 938 of the motor drive unit 910. When the control circuit 920 is moving the covering material to dock the bottom bar, the control circuit 920 may control the covering material through a docking movement (e.g., a docking sequence) as the bottom bar nears the dock. For example, the control circuit 920 may ramp down a rotational speed at which the motor is rotating as the bottom bar nears the dock.

The control circuit 920 of the motor drive unit 910 and/or the control circuit 950 of the bottom bar module 940 may be configured to determine that the bottom bar is docked by determining if the electrical connections 938 of the motor drive unit 910 are electrically connected to the electrical connections 948 of the bottom bar module 940. For example, the control circuit 920 of the motor drive unit 910 may be configured to determine that the bottom bar is docked by detecting that the second storage voltage V_{S-B} is present at the electrical connections 938. In addition, the control circuit 950 of the bottom bar module 940 may be configured to determine that the bottom bar is docked by detecting that the motor drive unit 910 is drawing current from the energy storage element 946 via the electrical connections 948. Further, the control circuit 920 of the motor drive unit 910 may be configured to determine that the bottom bar is docked in response to receiving a message from the bottom bar module 940, and the control circuit 950 of the bottom bar module 940 may be configured to determine that the bottom bar is docked in response to receiving a message from the motor drive unit 910. The control circuit 920 of the motor drive unit 910 may be configured to transmit a query message to the bottom bar module 940, and the control circuit 950 of the bottom bar module 940 may be configured to transmit a response to the query message to the motor drive unit 910. For example, the control circuit 920 of the motor drive unit 910 may be configured to transmit the query message to the bottom bar module 940 via a wired communication link (e.g., via the electrical connections 938, 948 and/or via separate electrical connections on the dock) and/or via a wireless communication link (e.g., where the query message may indicate that the bottom bar is docked).

The control circuit 920 of the motor drive unit 910 and/or the control circuit 950 of the bottom bar module 940 may be configured to determine (e.g., automatically determine) when the motor drive unit 910 should dock the bottom bar (e.g., move the covering material to the docked position P_{DOCKED}) to charge the energy storage element 930 from the energy storage element 946 of the bottom bar module 940. For example, the control circuit 920 of the motor drive unit 910 may be configured to determine that the bottom bar should be docked when the magnitude of the first storage voltage V_{S-A} produced across the energy storage element 930 falls too low (e.g., is less than a low-charge threshold V_{TH-LC}). The control circuit 920 of the motor drive unit 910 may be configured to move (e.g., automatically move) the covering material to the docked position P_{DOCKED} when the magnitude of the first storage voltage V_{S-A} drops below the low-charge threshold V_{TH-LC}. Although described in the context of storage voltages, the control circuit 920 of the motor drive unit 910 may be configured to determine whether or not the bottom bar should be docked (e.g., whether to charge the energy storage element 930 of the motor drive unit 910) based on the state of charge of the energy storage elements of the motorized window treatment, for instance, when the state of charge of the energy storage element 930 falls below a threshold. For example, the control circuit 920 may be configured to calculate the state of charge of the energy storage element 930 based on the first storage voltage V_{S-A}. In some examples, the control circuit 920 may use the magnitude of the first storage voltage V_{S-A} as an indication of the state of charge of the energy storage element 930.

In addition, the control circuit 950 of the bottom bar module 940 may be configured to determine that the bottom bar should be docked when the magnitude of the second storage voltage V_{S-B} produced across the energy storage element 946 is greater than a high-charge threshold V_{TH-HC}. For example, the control circuit 950 of the bottom bar module 940 may be configured to transmit a message indicating that the bottom bar should be docked to the motor drive unit 910 via the communication circuit 952 when the magnitude of the second storage voltage V_{S-B} rises above the high-charge threshold V_{TH-HC}. The control circuit 920 of the motor drive unit 910 may be configured to move the covering material to the docked position P_{DOCKED} in response to receiving the message from the bottom bar module 940 via the communication circuit 922. In addition, the control circuit 950 of the bottom bar module 940 may be configured to transmit a message including an indication of the magnitude of the second storage voltage V_{S-B} to the motor drive unit 910, and the motor drive unit 910 may be configured to move the covering material to the docked position P_{DOCKED} when the magnitude of the second storage voltage V_{S-B} rises above the high-charge threshold V_{TH-HC}.

The control circuit 920 of the motor drive unit 910 may be configured to determine when to dock the bottom bar in response to occupancy conditions or vacancy conditions in the space in which the motorized window treatment is located. The control circuit 920 may receive messages including indications of occupancy conditions and/or vacancy conditions in the space from the bottom bar module 940 (e.g., as determined by the sensor circuit 954) and/or from external occupancy sensors. For example, the control circuit 920 may be configured to dock the bottom bar when the control circuit 920 has determined that the bottom bar should be docked (e.g., when the magnitude of the second storage voltage V_{S-B} has risen above the high-charge threshold V_{TH-HC}) and when (e.g., only when) the space is vacant. In addition, the control circuit 920 may be configured to dock the bottom bar when the control circuit 920 has determined that the bottom bar should be docked (e.g., when the magnitude of the first storage voltage V_{S-A} has dropped below the low-charge threshold V_{TH-LC}) and when (e.g., only when) the space is vacant. In some examples, the control circuit 920 may be configured to dock the bottom bar when the space is occupied, but the magnitude of the first storage voltage V_{S-A} has dropped below a critical-charge threshold V_{TH-CRIT} (e.g., which may be smaller than the low-charge threshold V_{TH-LC}). Further, in some examples, the control circuit 920 may use the status of one or more lighting loads as a proxy or indicator that the space is occupied or vacant. For instance, the control circuit 920 may determine that the space is occupied when the lighting loads are on, and determine that the space is vacant when the lighting loads are off. Alternatively or additionally, the control circuit 920 may determine that the space is occupied or vacant based on external feedback, such as indications as to whether a meeting is scheduled for the space. For instance, the control circuit 920 may receive data from one or more calendar programs (e.g., such as Microsoft® Outlook®) and may determine that the space is vacant based on there not being a meeting scheduled for the space at a particular day and time.

The control circuit 920 of the motor drive unit 910 may be configured to determine when to dock the bottom bar in response to the present day of the week and/or the time of the day. For example, the control circuit 920 may be configured to not dock the bottom bar during a nighttime period (e.g., during a privacy mode, which may be between sunset and sunrise), for example, to maintain the covering material at a lowered position P_{LOWER} to provide privacy for occupants of the space. In addition, the control circuit 920 may be configured to dock the bottom bar at a predetermined docking time. For example, the motor drive unit 910 (e.g., the control circuit 920) may comprise a timeclock for keeping track of the day of the week and/or the time of the day. In addition, the control circuit 920 may be configured to determine the present day of the week and/or the time of the day from messages received via the communication circuit 922 (e.g., from the Internet). Further, the control circuit 950 of the bottom bar module 940 may be configured to estimate the time of the day in response to the sensor circuit 954. For example, the control circuit 950 may be configured to determine that the present time of the day is during the nighttime period when the ambient light level L_{AMB} indicated by the sensor circuit 954 is less than a nighttime threshold L_{TH-NIGHT}, and may transmit a message indicating that the present time of the day is during the nighttime period to the motor drive unit 910.

Further, in some examples, the control circuit 920 may schedule one or more docking events (e.g., periodic and/or reoccurring docking events) based on occupancy and/or vacancy information for the space. The control circuit 920 may be configured to determine the occupancy and/or vacancy of the space over time, for instance, based on occupancy and/or vacancy messages received from one or more occupancy and/or vacancy sensors. As noted herein, the control circuit 920 may receive messages including indications of occupancy conditions and/or vacancy conditions in the space from the bottom bar module 940 (e.g., as determined by the sensor circuit 954) and/or from external occupancy sensors. For instance, the control circuit 920 may determine, over time, that the space is vacant at certain days and/or times (e.g., Sundays from 8-10 am), and may schedule a docking event for those days/times. Further, in some examples, the control circuit 920 may use the status of one or more lighting loads as a proxy or indicator that the space is occupied or vacant. For instance, the control circuit 920 may determine that the space is occupied when the lighting loads are on, and may determine that the space is vacant when the lighting loads are off. In some examples, the control circuit 920 may determine that the space is vacant on certain days and/or times (e.g., Sundays from 8-10 am) based on the lighting loads within the space consistently being off during those days and/or times, and may schedule a docking event for those days/times. Alternatively or additionally, the control circuit 920 may determine that the space is occupied or vacant based on external feedback, such as indications as to whether a meeting is scheduled for the space. For instance, the control circuit 920 may receive data from one or more calendar programs (e.g., such as Microsoft® Outlook®) and may determine that the space is vacant based on there not being a meeting scheduled for the space at a particular day and time.

In addition, the control circuit 920 of the motor drive unit 910 may be configured to determine when to dock the bottom bar in response to one or more other factors. For example, after determining that the control circuit 920 should dock the bottom bar (e.g., based on the magnitude of the first storage voltage V_{S-A}, the magnitude of the second storage voltage V_{S-B}, the occupancy or vacancy status of the space, and/or the present day of the week and/or the time of the day), the control circuit 920 may also consider one or more factors to determine if the control circuit 920 should dock the bottom bar. For example, the control circuit 920 may determine whether or not to dock the bottom bar based on the position of the sun. If the sun is not shining on a façade on which the motorized window treatment 900 is installed, for instance, the control circuit 920 may determine to dock the bottom bar to take advantage of instances where the solar cells 942 are less likely to be missing out on collecting a relatively large amount of solar energy. In addition, the control circuit 920 may determine whether or not to dock the bottom bar based on weather information (e.g., temperature, cloud coverage, precipitation, barometric pressure, etc.). For example, the control circuit 920 may determine to dock the bottom bar if it is cloudy to take advantage of instances where the solar cells 942 are less likely to be missing out on collecting a relatively large amount of solar energy. The control circuit 920 may determine whether or not to dock the bottom bar based on feedback from the photosensor of the sensor circuit 954 of the motor drive unit 910. For example, the control circuit 920 may determine to dock the bottom bar if there is less daylight as indicated by the photosensor of the motor drive unit 910 to take advantage of instances where the solar cells 942 are less likely to be missing out on collecting a relatively large amount of solar energy.

The control circuit 920 of the motor drive unit 910 and/or the control circuit 950 of the bottom bar module 940 may be configured to measure and/or collect solar data regarding the operation of the motorized window treatment control system 900. The solar data may comprise one or more measurements recorded by the motor drive unit 910 and/or the bottom bar module 940, and/or one or more operational characteristics of the motor drive unit 910 and/or the bottom bar module 940. For example, the measurements included in the solar data may comprise measurements of the magnitude of the photovoltaic output voltage V_{PV}, the magnitude of the second storage voltage V_{S-B}, and/or the ambient light level L_{AMB} (e.g., as measured by the sensor circuit 954). For example, the operational characteristics included in the solar data may comprise the duty cycle DC_{SCM} of the solar cell management circuit 944 and/or other operational characteristics of the solar cell management circuit 944. The solar data may also comprise tracking information associated with each of the measurements and/or operational characteristics. For example, the tracking information may include timing information (e.g., a time stamp indicating a time at which the respective measurement and/or operational characteristic was recorded) and/or position information (e.g., the present position P_{PRES} of the covering material at the time at which the respective measurement and/or operational characteristic was recorded).

The control circuit 920 of the motor drive unit 910 and/or the control circuit 950 of the bottom bar module 940 may be configured to determine the solar power P_{SOLAR} (e.g., as received by the solar cells 942) with respect to the commanded position P_{CM} of the covering material (e.g., determine a relationship between the solar power P_{SOLAR} and the commanded position P_{CM} of the covering material). The control circuit 920 of the motor drive unit 910 and/or the control circuit 950 of the bottom bar module 940 may be configured to calculate the solar power P_{SOLAR} using the solar data. For example, the control circuit 920 of the motor drive unit 910 and/or the control circuit 950 of the bottom bar module 940 may be configured to calculate the solar power P_{SOLAR} as a function of the magnitude of the photovoltaic output voltage V_{PV}, the magnitude of the second storage voltage V_{S-B}, and/or the duty cycle DC_{SCM} of the solar cell management circuit 944. The control circuit 920 of the motor drive unit 910 and/or the control circuit 950 of the bottom bar module 940 may be configured to determine the solar power P_{SOLAR} at each of a plurality of intermediate positions between the raised position P_{RAISED} and the lowered position P_{LOWERED}. The control circuit 920 of the motor drive unit 910 and/or the control circuit 950 of the bottom bar module 940 may be configured to store data defining the relationship between the solar power P_{SOLAR} and the commanded position P_{CM} of the covering material in the solar data.

The control circuit 920 of the motor drive unit 910 and/or the control circuit 950 of the bottom bar module 940 may be configured to measure and/or collect solar data regarding the operation of the motorized window treatment control system 900 during a configuration procedure of the motorized window treatment control system 900. During the configuration procedure, the control circuit 920 of the motor drive unit 910 and/or the control circuit 950 of the bottom bar module 940 may be configured to measure and/or collect the solar data. In addition, the control circuit 920 of the motor drive unit 910 and/or the control circuit 950 of the bottom bar module 940 may be configured to determine the solar power P_{SOLAR} with respect to the commanded position P_{CM} of the covering material (e.g., the relationship between the solar power P_{SOLAR} and the commanded position P_{CM} of the covering material) during the configuration procedure. For example, the configuration procedure may be completed when the motorized window treatment control system 900 is first installed (e.g., prior to normal operation). In some examples, the control circuit 920 of the motor drive unit 910 may be configured to execute the configuration procedure in response to an actuation of one or more of the buttons of the user interface circuit 924 and/or a message received via the communication circuit 922, and the control circuit 950 of the bottom bar module 940 may be configured to execute the configuration procedure in response to a message received via the communication circuit 952. In addition, the control circuit 920 of the motor drive unit 910 and/or the control circuit 950 of the bottom bar module 940 may be configured to execute the configuration procedure during normal operation (e.g., continuously and/or periodically over time). Further, the control circuit 920 of the motor drive unit 910 and/or the control circuit 950 of the bottom bar module 940 may be configured to execute the configuration procedure in response to determining a change in the solar power P_{SOLAR} received by the solar cells 942 (e.g., as compared to an expected solar power).

When the communication circuit 952 of the bottom bar module 940 is configured to communicate with the communication circuit 922 of the motor drive unit 910 via a wireless communication link (e.g., via RF signals using a short-range wireless communication protocol), the control circuit 950 of the bottom bar module 940 may be configured to periodically transmit the solar data (e.g., one or more measurements and/or operational characteristics) to the control circuit 920 of the motor drive unit 910 at a transmission rate T_{TX}. In some examples, the wireless communication link between the control circuit 920 of the motor drive unit 910 and the control circuit 950 of the bottom bar module 940 may be a one-way communication link (e.g., from the control circuit 950 of the bottom bar module 940 to the control circuit 920 of the motor drive unit 910) to facilitate reporting of the solar data to the control circuit 920 of the motor drive unit 910. In some examples, the communication circuit 952 of the bottom bar module 940 may be configured to communicate with the communication circuit 922 of the motor drive unit 910 via a wired communication link (e.g., as described herein). The control circuit 920 of the motor drive unit 910 may be configured to store the solar data received from the control circuit 950 of the bottom bar module 940 in the memory of the motor drive unit 910. For each of the measurements and/or operational characteristics of the solar data, the control circuit 920 of the motor drive unit 910 may be configured to add to the solar data a respective position P_{DATA} of the covering material at the time at which the solar data was received. In some examples, the control circuit 950 may be configured to adjust the transmission rate T_{TX} of the communication circuit 952 based on the magnitude of the second storage voltage V_{S-B} across the energy storage element 946. For example, the control circuit 950 may be configured to decrease the transmission rate T_{TX} when the magnitude of the second storage voltage V_{S-B} is high, such that the control circuit 950 transmits the solar data at a higher rate when the magnitude of the second storage voltage V_{S-B} is high than when the magnitude of the second storage voltage V_{S-B} is low.

When the communication circuit 952 of the bottom bar module 940 is configured to communicate with the communication circuit 922 of the motor drive unit 910 via a wired communication link (e.g., via the electrical connections 938, 948), the control circuit 950 of the bottom bar module 940 may be configured to collect and store the solar data in the memory of the bottom bar module 940, and then transmit the solar data to the communication circuit 922 of the motor drive unit 910 via the wired communication link when the bottom bar is docked. Since the control circuit 950 of the bottom bar module 940 may not have access to the present position P_{PRES} of the covering material (e.g., which is maintained by the control circuit 920 of the motor drive unit 910), the control circuit 950 may be configured to store in the solar data timing information (e.g., a time stamp indicating a time at which the respective measurement and/or operational characteristic was recorded). After receiving the solar data from the control circuit 950 of the bottom bar module 940, the control circuit 920 of the motor drive unit 910 may be configured to determine the respective position P_{DATA} of the covering material for each of the measurements and/or operational characteristics of the solar data by comparing the respective time stamp with the record of movements of the covering material that are stored in the memory of the motor drive unit 910. In some examples, the control circuit 950 of the bottom bar module 940 may be configured to estimate the present position P_{PRES} of the covering material in response to the accelerometer and/or the gyroscope of the sensor circuit 954 and add to the solar data the respective position P_{DATA} of the covering material at the time at which the measurement and/or operational characteristic was recorded.

The control circuit 950 of the bottom bar module 940 may be configured to record the measurements and/or operational characteristics of the solar data at a timing interval T_{TIM}. For example, the transmission rate T_{TX} of the communication circuit 952 may be equal to the timing interval T_{TIM}, such the control circuit 950 is configured to record the measurements and/or operational characteristics of the solar data and/or transmit the measurements and/or operational characteristics of the solar data at the same time (e.g., at the timing interval T_{TIM}). The control circuit 950 may be configured to set the timing interval T_{TIM} based on whether the covering material is moving or not. For example, the control circuit 950 may be configured to increase the timing interval T_{TIM} when the covering material is not moving and decrease the timing interval T_{TIM} when the covering material is moving. The control circuit 950 may be configured to set the timing interval T_{TIM} to an inactive interval value T_{INACTIVE} when the covering material is not moving and to an active interval value T_{ACTIVE} when the covering material is moving, where the inactive interval value T_{INACTIVE} is longer than the active interval value T_{ACTIVE}. For example, the control circuit 950 of the bottom bar module 940 may be configured to determine that the covering material is moving in response to the accelerometer and/or the gyroscope of the sensor circuit 954. In addition, the control circuit 950 may be configured to determine that the covering material is moving in response to a message received from the control circuit 920 of the motor drive unit 910 (e.g., which may include an indication that the control circuit 920 is presently moving the covering material).

The control circuit 920 of the motor drive unit 910 may be configured to use the solar data to configure the motor drive unit 910 (e.g., to configure the behavior of the motor drive unit 910 during normal operation). For example, the control circuit 920 may be configured to analyze the solar data to determine a charging position P_{CHRG} (e.g., a maximum-solar-power position) at which the solar cells 942 of the bottom bar module 940 may appropriately charge. For example, the charging position P_{CHRG} may be a position at which the solar cells 942 of the bottom bar module 940 may receive a maximum magnitude of solar power P_{SOLAR} between the lowered position P_{LOWER} and the raised position P_{RAISED}. The control circuit 920 may be configured to control the covering material to the charging position P_{CHRG} at one or more predetermined times (e.g., when the space is vacant and/or over the weekends). In addition, the control circuit 920 may be configured to analyze the solar data to set the upper limit position P_{UP-LIMIT} of the motorized window treatment. For example, the control circuit 920 may be configured to determine a position between the lowered position P_{LOWER} and the raised position P_{RAISED} above which the solar cells 942 of the bottom bar module 940 may not receive an appropriate amount of sunlight and set that position as the upper limit position P_{UP-LIMIT}.

Further, the control circuit 920 may be configured to analyze the solar data to identify one or more dead-bands (e.g., dead regions) between the lowered position P_{LOWER} and the raised position P_{RAISED} (e.g., positions of the covering material between which the solar cells 942 of the bottom bar module 940 may not receive an appropriate amount of sunlight, e.g., below a defined threshold). For example, each dead-band may be characterized by an upper dead-band limit position P_{DB-UL} and a lower dead-band limit position P_{DB-LL}. During normal operation, the control circuit 920 may be configured to not maintain the present position P_{PRES} of the covering material within any of the dead regions between the lowered position P_{LOWER} and the raised position P_{RAISED}. For example, when a commanded position P_{CMD} of a received message falls between the upper dead-band limit position P_{DB-UL} and the lower dead-band limit position P_{DB-LL} of a dead-band, the control circuit 920 may be configured to adjust the present position P_{PRES} of the covering material to the closest position outside of the respective dead region (e.g., to either the upper dead-band limit position P_{DB-UL} and/or the lower dead-band limit position P_{DB-LL} of the respective dead-band). In addition, the control circuit 920 may be configured to adjust the present position P_{PRES} of the covering material to a position that is at least an offset amount Δ_{OFFSET} away from the respective dead-band (e.g., either P_{DB-UL}+Δ_{OFFSET} Or P_{DB-LL}−Δ_{OFFSET}).

In some examples, the motor drive unit 910 may include electrical terminals 937 that are configured to allow for an external power source to charge the energy storage element 930 of the motor drive unit 910. For example, the energy storage element 930 of the motor drive unit 910 may be charged (e.g., jump started) when the motorized window treatment control system 900 is first installed and the motor drive unit is first powered up. In addition, the energy storage element 930 of the motor drive unit 910 may be charged (e.g., recharged) when the energy storage element 930 is in a condition in which the energy storage element 930 is not able to properly charge from the energy storage element 946 of the bottom bar module 940 (e.g., if the solar cells 942 are not receiving an appropriate amount of solar energy. In some examples, the electrical terminals 937 may be a standard power supply connector, e.g., such as a USB connector. In some examples, the motor drive unit 910 (e.g., the energy storage element 930) may be configured to receive power from an external power source via the electrical terminals 937. For example, in the condition that the energy storage element 930 is not able to properly charge from the energy storage element 946 of the bottom bar module 940, the motor drive unit 910 (e.g., the energy storage element 930) may be configured to receive power (e.g., continuously receive power) from an external power source, such as an external power supply and/or an external battery pack.

In some examples, the control circuit 920 of the motor drive unit 910 of the motorized window treatment control system 900 may be configured to detect trends in storage level of the energy storage element 930 (e.g., based on the magnitude of the first storage voltage V_{S-A}). For example, the control circuit 920 may process the storage level (e.g., the first storage voltage V_{S-A}) of the energy storage element 930 to determine a trend of changes in the storage level over time. For example, the control circuit 920 may determine whether the storage level of the energy storage element 930 is greater than or less than the storage level over a previous time period. Further, the control circuit 920 may be configured to determine whether a rolling average of the storage level of a predetermined number of previous storage level measurements is increasing or decreasing to, for example, determine whether the energy storage element 930 is starting to degrade (e.g., fail). In some examples, the control circuit 920 may perform an action in response to a determination that the energy storage element 930 is starting to degrade. For instance, the control circuit 920 may send an alert to a mobile device and/or a system controller (e.g., indicating that the motorized window treatment control system 900 should be serviced). Alternatively or additionally, the control circuit 920 may move the covering material to the docked position P_{DOCKED} and start to shut down some of the internal components of the motorized window treatment control system 900 (e.g., the communication circuit 922). In response, a technician may change out the energy storage element 930, charge the energy storage element 930 (e.g., via the electrical terminals 937 using a USB connector), and/or connect the energy storage element 930 to an external power source, such as an external power supply and/or an external battery pack (e.g., via the electrical terminals 937 using the USB connector).

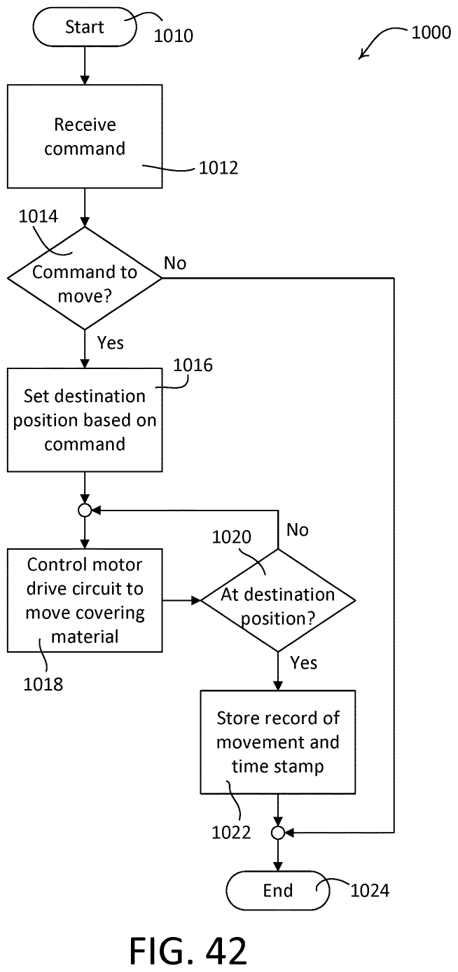

FIG. 42 is a flowchart of an example procedure 1000 for adjusting a present position P_{PRES} of a covering material of a covering system, such as a motorized window treatment (e.g., the motorized window treatments of the embodiments shown in FIGS. 1-15). The procedure 1000 may be executed by a control circuit of a motor drive unit of the motorized window treatment (e.g., the control circuit 920 of the motor drive unit 910 shown in FIG. 41 and/or control circuits of the motor drive units shown in FIGS. 1-15). For example, the control circuit may execute the procedure 1000 periodically starting at 1010. In addition, the control circuit may execute the procedure 1000 in response to receiving a message via a communication circuit at 1010.

At 1012, the control circuit of the motor drive unit may receive a command. For example, the control circuit may receive a message including a command via a communication circuit (e.g., the communication circuit 922). The command may be, for example, a command to move the covering material (e.g., a shade movement command to adjust the present position P_{PRES} of the covering material). For example, the command may include a commanded position P_{CMD} to which the control circuit of the motor drive unit should control the present position P_{PRES} of the covering material. In addition, the command may include a command to raise or lower the present position P_{PRES} of the covering material, and the control circuit may be configured to adjust the present position P_{PRES} of the covering material by a predetermined amount ΔP in response to receiving the command. In some examples, the control circuit may be configured to start raising or lowering the covering material in response to receiving a message including a raise command or a lower command, respectively, and may stop raising or lowering the present position P_{PRES} of the covering material in response to receiving a message including a stop command. Further, the command in the message received at 1012 may not be a command to move the covering material, but may be a command to enter a mode (e.g., a configuration mode), a command to transmit status information of the motor drive unit, and/or other commands that are not movement commands. Additionally or alternatively, the command may be received in response to an actuation of one or more of the buttons of the motor drive unit (e.g., the button of the user interface circuit 924). For example, the control circuit may be configured to raise or lower the present position P_{PRES} of the covering material by the predetermined amount ΔP in response to detecting an actuation of a first button or a second button, respectively, of the motor drive unit. In addition, the control circuit may be configured to start raising or lowering the covering material in response to detecting a first actuation of the first button or the second button, respectively, and may stop raising or lowering the present position P_{PRES} of the covering material in response to detecting a second subsequent actuation of the first button or the second button, respectively.

At 1014, the control circuit of the motor drive unit may be configured to determine if the command received at 1012 is a command to move the covering material (e.g., a shade movement command). When the command is not a command to move the covering material at 1014, the procedure 1000 may end at 1024. When the command is a command to move the covering material at 1014, the control circuit may at 1016 set a destination position P_{DEST} for the covering material based on the command in the message received at 1012. For example, when the message includes a commanded position P_{CMD}, the control circuit may set the destination position P_{DEST} equal to the commanded position P_{CMD} at 1016. In addition, when the message includes a raise command or a lower command, the control circuit may set the destination position P_{DEST} to be a predetermined amount ΔP from the present position P_{PRES} at 1016, before movement of the covering material starts (e.g., P_{DEST}=P_{PRES}+ΔP when the command is a raise command, or P_{DEST}=P_{PRES}−ΔP when the command is a lower command).

At 1018, the control circuit may control the motor drive circuit to rotate the motor to move the covering material. For example, the control circuit may be configured to generate at least one drive signal (e.g., the at least one drive signal V_{DR}) for controlling the motor drive circuit to control the rotational speed and the direction of rotation of the motor. At 1020, the control circuit of the motor drive unit may be configured to determine if the covering material is at the destination position P_{DES}T. When the control circuit determines that the covering material is not at the destination position P_{DEST} at 1020, the control circuit may continue to control the motor drive circuit to move the covering material towards the destination position P_{DEST} at 1018. When the control circuit determines that the covering material is at the destination position P_{DEST} at 1020, the control circuit may stop controlling the motor drive circuit to move the covering material and may store a record of the movement of the covering material along with timing information (e.g., a time stamp indicating a time at which the movement occurred) at 1022, before the procedure 1000 ends at 1024.

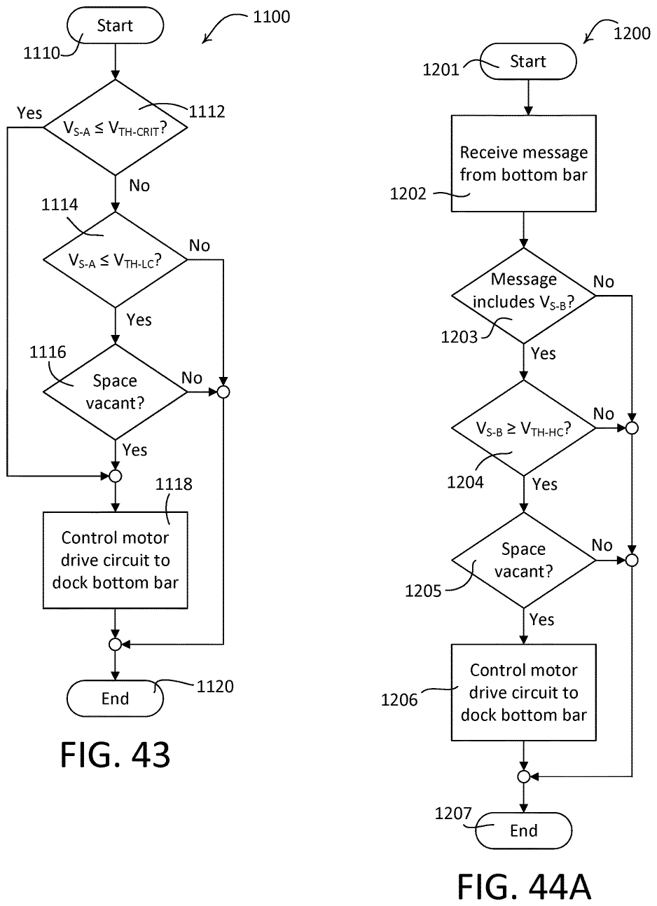

FIG. 43 is a flowchart of an example procedure 1100 for determining when to dock a bottom bar (e.g., the bottom bars 155, 240, 340, 400, 500, 600) of a covering system, such as a motorized window treatment (e.g., the motorized window treatments of the embodiments shown in FIGS. 1-15). For example, the bottom bar may be connected to a bottom end of a covering material of the motorized window treatment. The procedure 1100 may be executed by a control circuit of a motor drive unit of the motorized window treatment (e.g., the control circuit 920 of the motor drive unit 910 shown in FIG. 41 and/or control circuits of the motor drive units shown in FIGS. 1-15). The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}).

During the procedure 1100, the control circuit may determine whether or not to dock the bottom bar in response to a magnitude of a supply voltage generated across the one or more storage energy elements of the motor drive unit (e.g., the first storage voltage V_{S-A} produced across the energy storage element 930 of the motor drive unit 910). The control circuit may be configured to determine to dock the bottom bar when the magnitude of the first storage voltage V_{S-A} is less than (e.g., is less than or equal to) a low-charge threshold V_{TH-LC} and when (e.g., only when) the space is vacant. In addition, the control circuit may be configured to determine to dock the bottom bar when the magnitude of the first storage voltage V_{S-A} has dropped below a critical-charge threshold V_{TH-CRIT} (e.g., independent of whether the space is occupied or vacant). The critical-charge threshold V_{TH-CRIT} may be smaller than the low-charge threshold V_{TH-LC}. For example, the control circuit may execute the procedure 1100 periodically at 1110 to monitor the magnitude of the first storage voltage V_{S-A}. Further, it should be appreciated that in some examples, the control circuit may determine not to dock the bottom bar when the magnitude of the supply voltage generated across the one or more energy storage elements of the motor drive unit is above an upper threshold (e.g., irrespective of whether other procedures may suggest that the bottom bar should be docked).

At 1112, the control circuit may determine if the magnitude of the first storage voltage V_{S-A} is less than (e.g., less than or equal to) the critical-charge threshold V_{TH-CRIT}. If so, the control circuit may control a motor drive circuit of the motor drive unit (e.g., the motor drive circuit 914) to dock the bottom bar (e.g., to adjust the present position P_{PRES} of the covering material to the docked position P_{DOCKED}) at 1118, before the procedure 1100 ends at 1120. If the magnitude of the first storage voltage V_{S-A} is greater than the critical-charge threshold V_{TH-CRIT} at 1112, the control circuit may determine if the magnitude of the first storage voltage V_{S-A} is less than (e.g., less than or equal to) the low-charge threshold V_{TH-LC} at 1114. If the magnitude of the first storage voltage V_{S-A} is greater than the low-charge threshold V_{TH-LC} at 1114, the procedure 1100 may end at 1120 (e.g., without docking the bottom bar).

If the magnitude of the first storage voltage V_{S-A} is less than (e.g., less than or equal to) the low-charge threshold V_{TH-LC} at 1114, the control circuit may determine if the space is vacant at 1116. For example, the control circuit may be configured to determine whether the space is occupied or vacant in response to receiving a message indicating an occupancy condition or a vacancy condition in the space. If the magnitude of the first storage voltage V_{S-A} is less than (e.g., less than or equal to) the low-charge threshold V_{TH-LC} at 1114 and the space is vacant at 1116, the control circuit may control the motor drive circuit of the motor drive unit to dock the bottom bar (e.g., to adjust the present position P_{PRES} of the covering material to the docked position P_{DOCKED}) at 1118, before the procedure 1100 ends at 1120. If the magnitude of the first storage voltage V_{S-A} is less than (e.g., less than or equal to) the low-charge threshold V_{TH-LC} at 1114 and the space is not vacant at 1116, the procedure 1100 may end at 1120 (e.g., without docking the bottom bar).

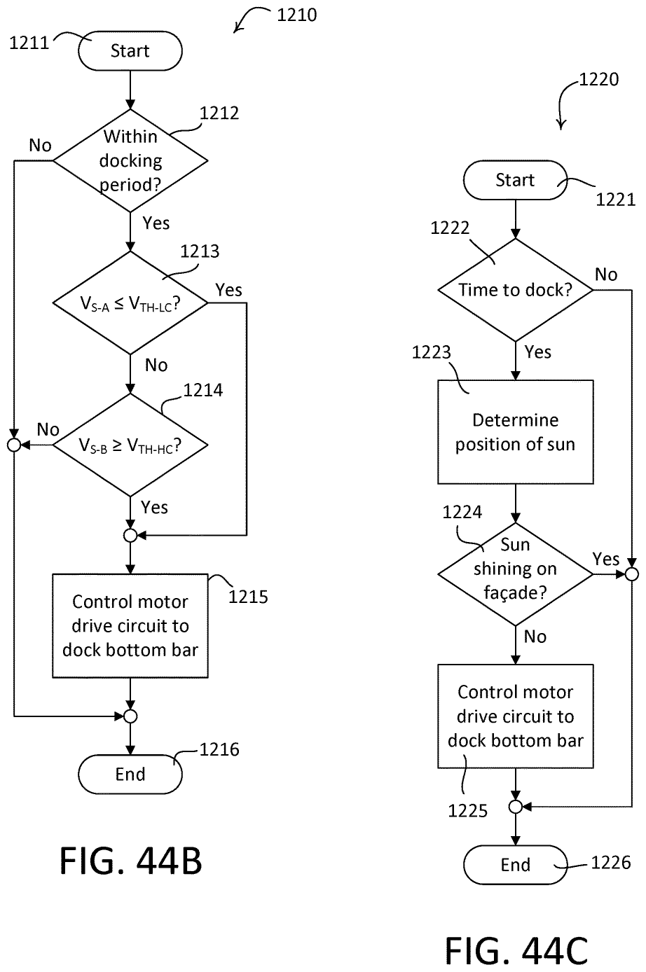

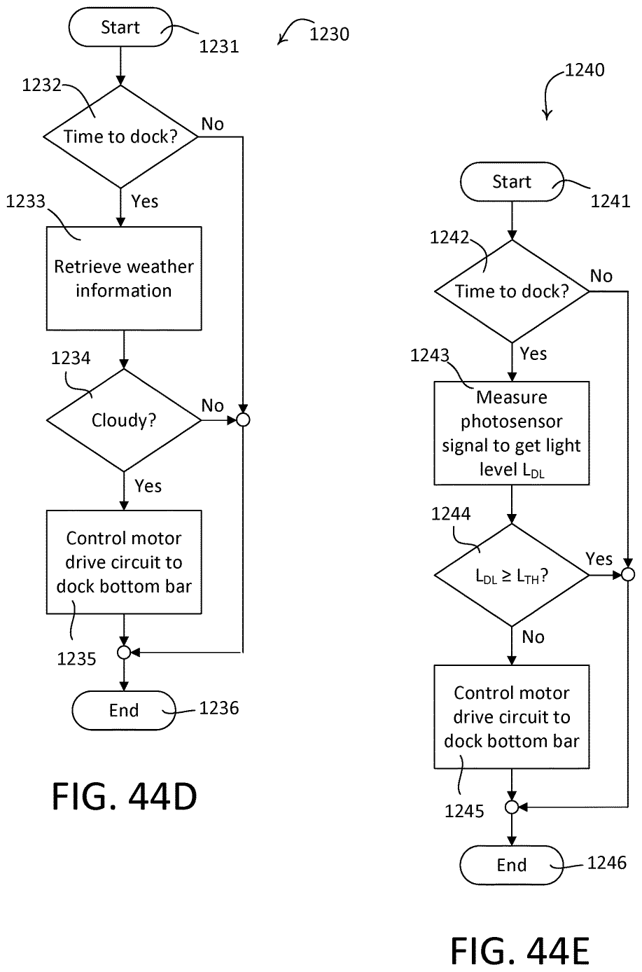

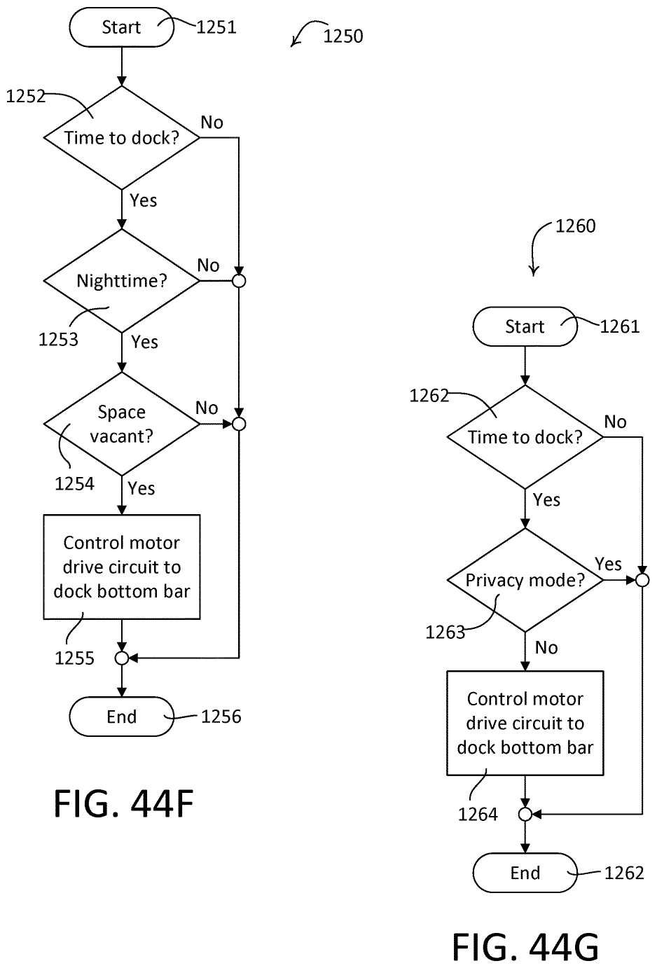

FIG. 44A is a flowchart of an example procedure 1200 for determining when to dock a bottom bar (e.g., the bottom bars 155, 240, 340, 400, 500, 600) of a covering system, such as a motorized window treatment (e.g., the motorized window treatments of the embodiments shown in FIGS. 1-15). For example, the bottom bar may be connected to a bottom end of a covering material of the motorized window treatment. The procedure 1200 may be executed by a control circuit of a motor drive unit of the motorized window treatment (e.g., the control circuit 920 of the motor drive unit 910 shown in FIG. 41 and/or control circuits of the motor drive units shown in FIGS. 1-15). The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}).

During the procedure 1200, the control circuit may determine whether or not to dock the bottom bar in response to a magnitude of a supply voltage generated across the one or more energy storage elements of the bottom bar (e.g., the second storage voltage V_{S-B} produced across the energy storage element 946 of the bottom bar module 940). The control circuit may be configured to determine to dock the bottom bar when the magnitude of the second storage voltage V_{S-B} is greater than (e.g., is greater than or equal to) a high-charge threshold V_{TH-HC} and when (e.g., only when) the space is vacant. The bottom bar module may be configured to transmit a message including an indication of the magnitude of the second storage voltage V_{S-B} to the motor drive unit. For example, the control circuit may execute the procedure 1200 periodically at 1201 to monitor the magnitude of the second storage voltage V_{S-B}. In addition, the control circuit may execute the procedure 1200 in response to receiving a message from the bottom bar module at 1201.

At 1202, the control circuit may receive a message from the bottom bar module. For example, the message may include an indication of the magnitude of the second storage voltage V_{S-B}. If the message includes the magnitude of the second storage voltage V_{S-B} at 1203, the control circuit may determine if the magnitude of the second storage voltage V_{S-B} is greater than (e.g., greater than or equal to) the high-charge threshold V_{TH-HC} at 1204. If the message does not include the magnitude of the second storage voltage V_{S-B} at 1203 or if the magnitude of the second storage voltage V_{S-B} is not greater than (e.g., greater than or equal to) the high-charge threshold V_{TH-HC} at 1204, the procedure 1200 may end at 1207.

If the magnitude of the second storage voltage V_{S-B} is greater than (e.g., greater than or equal to) the high-charge threshold V_{TH-HC} at 1204, the control circuit may determine if the space is vacant at 1205. For example, the control circuit may be configured to determine whether the space is occupied or vacant in response to receiving a message indicating an occupancy condition or a vacancy condition in the space. If the magnitude of the second storage voltage V_{S-B} is greater than (e.g., greater than or equal to) the high-charge threshold V_{TH-HC} at 1204 and the space is vacant at 1205, the control circuit may control a motor drive circuit of the motor drive unit (e.g., the motor drive circuit 914) to dock the bottom bar (e.g., to adjust the present position P_{PRES} of the covering material to the docked position P_{DOCKED}) at 1206, before the procedure 1200 ends at 1207. If the magnitude of the second storage voltage V_{S-B} is greater than (e.g., greater than or equal to) the high-charge threshold V_{TH-LC} at 1204 and the space is not vacant at 1205, the procedure 1200 may end at 1207 (e.g., without docking the bottom bar).

Rather than transmitting a message that indicates the magnitude of the second storage voltage V_{S-B}, the bottom bar module may be configured to determine if the magnitude of the second storage voltage V_{S-B} is greater than (e.g., greater than or equal to) the high-charge threshold V_{TH-HC} and transmit a message indicating that the motor drive unit should dock the bottom bar when the magnitude of the second storage voltage V_{S-B} is greater than (e.g., greater than or equal to) the high-charge threshold V_{TH-HC}. In such an example, the control circuit of the motor drive unit may determine if the message includes an indication to dock the bottom bar at 1203 of the procedure 1200, and the determination of whether the magnitude of the second storage voltage V_{S-B} is greater than (e.g., greater than or equal to) the high-charge threshold V_{TH-HC} at 1204 may be omitted.

FIG. 44B is a flowchart of an example procedure 1210 for determining when to dock a bottom bar (e.g., the bottom bars 155, 240, 340, 400, 500, 600) of a motorized window treatment (e.g., the motorized window treatments of the embodiments shown in FIGS. 1-15). For example, the bottom bar may be connected to a bottom end of a covering material of the motorized window treatment. The procedure 1210 may be executed by a control circuit of a motor drive unit of the motorized window treatment (e.g., the control circuit 920 of the motor drive unit 910 shown in FIG. 41 and/or control circuits of the motor drive units shown in FIGS. 1-15). The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}).

During the procedure 1210, the control circuit may determine whether or not to dock the bottom bar in response to a docking window (e.g., a docking time period), a magnitude of a supply voltage generated across the one or more energy storage elements of the motor drive unit (e.g., the first storage voltage V_{S-A} produced across the energy storage element 930 of the motor drive unit 910), and/or a magnitude of a supply voltage generated across the one or more energy storage elements of the bottom bar (e.g., the second storage voltage V_{S-B} produced across the energy storage element 946 of the bottom bar module 940). The docking window may be a scheduled time that, for example, may be configured by the user. The docking window may occur periodically (e.g., at a docking interval), such as every day (e.g., every night at 3:00 am). The control circuit may be configured to determine to dock the bottom bar during the docking window when the magnitude of the first storage voltage V_{S-A} is less than (e.g., is less than or equal to) a low-charge threshold V_{TH-LC} or when the magnitude of the second storage voltage V_{S-B} is greater than (e.g., is greater than or equal to) a high-charge threshold V_{TH-HC}. The bottom bar module may be configured to transmit a message including an indication of the magnitude of the second storage voltage V_{S-B} to the motor drive unit. For example, the control circuit may periodically receive a message that indicates the magnitude of the second storage voltage V_{S-B}. The control circuit may start the procedure 1210 at 1211. The control circuit may execute the procedure 1210 periodically. In some examples, the control circuit may execute the procedure 1210 at a particular time of day (e.g., at the beginning of the docking time period) and/or in response to receiving a message (e.g., a message indicating the beginning of the docking time period).

At 1212, the control circuit may determine whether the motorized window treatment is within the docking window (e.g., based on a timeclock of the control circuit and/or based on receiving a message indicating the beginning of the docking window). If the control circuit determines that the present time is not within the docking window, the control circuit may end the procedure 1210 at 1216 (e.g., without docking the bottom bar). However, if the control circuit determines that the present time is within the docking window, the control circuit may determine whether the first storage voltage V_{S-A} of the energy storage elements in the motor drive unit is less than (e.g., is less than or equal to) the low-charge threshold V_{TH-LC} at 1213. If the control circuit determines that the first storage voltage V_{S-A} is less than the low-charge threshold V_{TH-LC} at 1213, the control circuit may control a motor drive circuit of the motor drive unit (e.g., the motor drive circuit 914) to dock the bottom bar (e.g., to adjust the present position P_{PRES} of the covering material to the docked position P_{DOCKED}) at 1215, before the procedure 1210 ends at 1216. As such, if the control circuit determines that the first storage voltage V_{S-A} is less than the low-charge threshold V_{TH-LC} during the docking window, the control circuit may dock the bottom bar (e.g., to charge the energy storage element of the motor drive unit when the first storage voltage level _{VS-A} is low during the scheduled docking window).

If the control circuit determines that the first storage voltage V_{S-A} is greater than the low-charge threshold V_{TH-LC} at 1213, the control circuit may determine whether the magnitude of the second storage voltage V_{S-B} of the energy storage elements in the bottom bar is greater than (e.g., is greater than or equal to) the high-charge threshold V_{TH-HC} at 1214. If the control circuit determines that the magnitude of the second storage voltage V_{S-B} is greater than the high-charge threshold V_{TH-HC} at 1214, the control circuit may control the motor drive circuit of the motor drive unit to dock the bottom bar at 1215, before the procedure 1210 ends at 1216. As such, if the control circuit determines that the magnitude of the second storage voltage V_{S-B} is greater than the high-charge threshold V_{TH-HC} during the docking window, the control circuit may dock the bottom bar (e.g., to charge the energy storage element of the motor drive unit and discharge the energy storage elements of the bottom bar during the scheduled docking window). However, if the control circuit determines that the magnitude of the second storage voltage V_{S-B} is less than the high-charge threshold V_{TH-HC} at 1214, the control circuit may end the procedure 1210 at 1216 (e.g., without docking the bottom bar), for example, because there is little benefit to docking the bottom bar if the first storage voltage V_{S-A} is greater than the low-charge threshold V_{TH-LC} and the second storage voltage V_{S-B} is less than the high-charge threshold V_{TH-HC}.

FIG. 44C is a flowchart of an example procedure 1220 for determining when to dock a bottom bar (e.g., the bottom bars 155, 240, 340, 400, 500, 600) of a covering system, such as a motorized window treatment (e.g., the motorized window treatments of the embodiments shown in FIGS. 1-15). For example, the bottom bar may be connected to a bottom end of a covering material of the motorized window treatment. The procedure 1220 may be executed by a control circuit of a motor drive unit of the motorized window treatment (e.g., the control circuit 920 of the motor drive unit 910 shown in FIG. 41 and/or control circuits of the motor drive units shown in FIGS. 1-15). The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}).

During the procedure 1220, the control circuit may determine whether or not to dock the bottom bar based on the position of the sun. For example, the control circuit may determine to dock the bottom bar if the sun is not shining on a façade on which the motorized window treatment is installed, for instance, to take advantage of instances where the solar cells are less likely to be missing out on collecting a relatively large amount of solar energy. The control circuit (e.g., and/or a system controller that is in communication with the control circuit) may be configured to calculate a predicted position of the sun at a plurality of discrete times in a day. The position of the sun in the sky may be defined by a solar altitude angle θ_{S} and a solar azimuth angle θ_{Z}. The control circuit may determine the solar altitude angle θ_{S} and the solar azimuth angle θ_{Z} as functions of the date (e.g., a Julian date) and time (e.g., the standard time tₛ), as well as the position (e.g., longitude λ and latitude φ) of the building in which the window and/or motorized window treatment is located.

For example, the system controller and/or the control circuit may be configured to calculate the solar altitude angle θ_{S} and the solar azimuth angle θ_{Z} using the following equations. The difference in a solar time tₛₒₗₐᵣ (e.g., a time as given by a sundial) and the standard time tₛ (e.g., a time as given by a clock) due to the obliquity of the Earth's axis of rotation may be defined by an equation of time ET. The equation of time ET can be determined as a function of the present Julian date J using, for example, the equation:

Et=0.1644·sin(A)−0.1273·cos(B), (Equation 1)
where A=[4π·(J−81.6)]/365.25 and B=[2π·(J−2.5)]/365.25. The Julian date J may be a decimal number representing the present day in the year. For example, the Julian date J may equal one for January 1, two for January 2, three for January 3, and so on. The solar time tₛₒₗₐᵣ may be calculated as a function of the standard time tₛ, the equation of time ET, a standard meridian SM of the time zone of the location of the building, and the longitude λ, for example, using the equation:

tₛₒₗₐᵣ=tₛ+ET+[12·(SM−λ)]/π. (Equation 2)

The standard meridian SM may be determined from the time zone of the location of the building. Each time zone may have a unique standard meridian, which may define a particular line of latitude within the time zone. There may be approximately 15° between the standard meridians of adjacent time zones. The solar altitude angle θ_{S} and the solar azimuth angle θ_{Z} may be determined from a solar declination δ. The solar declination δ may define an angle of incidence of the rays of the sun on the equatorial plane of the Earth. The solar declination δ may be determined using, for example, the equation:

δ=0.4093·sin[2π·(J−81)/368]. (Equation 3)

The solar altitude angle δ_{S} at the standard time tₛ may be calculated as a function of the solar time tₛₒₗₐᵣ, the solar declination δ, and a local latitude Φ using, for example, the equation:

θ_{S}=arc sin [sin(Φ)·sin(δ)−cos(Φ)·cos(δ)·cos(π·tₛₒₗₐᵣ/12)]. (equation 4)

The solar azimuth angle ↓_{Z} at the standard time tₛ may be calculated as a function of the solar time tₛₒₗₐᵣ, the solar declination δ, and the local latitude Φ using, for example, the equation:

θ_{Z}=arc tan [−cos(δ)·sin(π·tₛₒₗₐᵣ/12)/C], (Equation 5)

where C=−[cos(φ)·sin(δ)+sin(φ)·cos(δ)·cos(π·tₛₒₗₐᵣ/12)].

An example of a motorized window treatment that is configured to determine the position of the sun is described in U.S. Patent Pub. No. 2021/0180399, which is hereby incorporated by reference in its entirety.

The procedure 1220 may start at 1221. At 1222, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1220 may end at 1226. In some examples, the determination of whether or not to dock at 1222 may be omitted from the procedure 1220.

If the control circuit determines that it is time to dock, the control circuit may determine the position of the sun at 1223. For example, the control circuit may calculate the position of the sun based on a predicted position of the sun. Alternatively, the control circuit may receive an indication of the predicted position of the sun from a system controller. At 1224, the control circuit may determine whether the sun may be shining on a facade of the building of which the motorized window treatment is installed. Since there may be cloud cover or another obstruction between the façade and the sun, the predicted position of the sun may indicate whether there is potentially sun shining on the façade of the building of which the motorized window treatment is installed. For example, the control circuit may be configured to determine whether the sun may be shining on the façade of which the motorized window treatment is installed at 1224 by comparing the calculated solar altitude angle θ_{S} and/or the calculated solar azimuth angle θ_{Z} to one or more thresholds to determine if the calculated solar altitude angle θ_{S} and/or the calculated solar azimuth angle θ_{Z} are within ranges that indicate that the sun may be shining on the façade. If the control circuit determines that the sun may be shining on the façade, the procedure 1220 may end at 1226.

If the control circuit determines that the sun is not shining on the façade at 1224, the control circuit may control the motor drive circuit to dock the bottom bar at 1225, before the procedure 1220 ends at 1226. For instance, the control circuit may control a motor drive circuit of the motor drive unit (e.g., the motor drive circuit 914) to dock the bottom bar (e.g., to adjust the present position P_{PRES} of the covering material to the docked position P_{DOCKED}) at 1225, before the procedure 1220 ends at 1226. As such, if the control circuit determines that the sun is not shining on the façade, the control circuit may dock the bottom bar because the solar cells of the bottom bar are unlikely to be receiving solar energy (e.g., or significant solar energy) from the sun at that moment in time. Therefore, docking the bottom bar when the sun is not shining on the façade will allow the bottom bar to dock when there is a lower likelihood or probability that the solar cells would be missing out on collecting a relatively large amount of solar energy.

FIG. 44D is a flowchart of an example procedure 1230 for determining when to dock a bottom bar (e.g., the bottom bars 155, 240, 340, 400, 500, 600) of a covering system, such as a motorized window treatment (e.g., the motorized window treatments of the embodiments shown in FIGS. 1-15). For example, the bottom bar may be connected to a bottom end of a covering material of the motorized window treatment. The procedure 1230 may be executed by a control circuit of a motor drive unit of the motorized window treatment (e.g., the control circuit 920 of the motor drive unit 910 shown in FIG. 41 and/or control circuits of the motor drive units shown in FIGS. 1-15). The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}).

During the procedure 1230, the control circuit may determine whether or not to dock the bottom bar based on weather information (e.g., temperature, cloud coverage, precipitation, barometric pressure, etc.). For example, the control circuit may determine to dock the bottom bar if it is cloudy, for instance, to take advantage of instances where the solar cells are less likely to be missing out on collecting a relatively large amount of solar energy. The control circuit (e.g., and/or a system controller that is in communication with the control circuit) may be configured to determine the weather in the location of the motorized window treatment from an external source, such as a weather service (e.g., via the Internet), a weather application, and/or a weather application programming interface (API).

The procedure 1230 may start at 1231. At 1232, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1230 may end at 1236. In some examples, the determination of whether or not to dock at 1232 may be omitted.

If the control circuit determines that it is time to dock, the control circuit may retrieve weather information at 1233. For example, the control circuit may retrieve the weather information (e.g., directly or indirectly, via a system controller) from a weather application. At 1234, the control circuit may determine whether it is cloudy at the location of the motorized window treatment. If the control circuit determines that it is not cloudy, the procedure 1230 may end at 1236.

If the control circuit determines that it is cloudy at 1234, the control circuit may control the motor drive circuit to dock the bottom bar at 1235, before the procedure 1230 ends at 1236. For instance, the control circuit may control a motor drive circuit of the motor drive unit (e.g., the motor drive circuit 914) to dock the bottom bar (e.g., to adjust the present position P_{PRES} of the covering material to the docked position P_{DOCKED}) at 1235, before the procedure 1230 ends at 1236. As such, if the control circuit determines that it is cloudy at the location of the motorized window treatment, the control circuit may dock the bottom bar because the solar cells of the bottom bar are unlikely to be receiving solar energy (e.g., or significant solar energy) from the sun at that moment in time. Therefore, docking the bottom bar when it is cloudy will allow the bottom bar to dock when there is a lower likelihood or probability that the solar cells would be missing out on collecting a relatively large amount of solar energy.

FIG. 44E is a flowchart of an example procedure 1240 for determining when to dock a bottom bar (e.g., the bottom bars 155, 240, 340, 400, 500, 600) of a covering system, such as a motorized window treatment (e.g., the motorized window treatments of the embodiments shown in FIGS. 1-15). For example, the bottom bar may be connected to a bottom end of a covering material of the motorized window treatment. The procedure 1240 may be executed by a control circuit of a motor drive unit of the motorized window treatment (e.g., the control circuit 920 of the motor drive unit 910 shown in FIG. 41—and/or control circuits of the motor drive units shown in FIGS. 1-15). The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}).

During the procedure 1240, the control circuit may determine whether or not to dock the bottom bar based on feedback from a photosensor. For instance, in some examples, the motorized window treatment (e.g., the motor drive unit and/or the bottom bar) may include a photosensor that is configured to measure light and generate a signal indicating the amount of light. As such, the control circuit may receive an indication of the amount of light from the photosensor and determine a light level L_{DL}. The photosensor may be oriented such that it faces towards the window to measure the amount of light (e.g., sunlight) hitting the window (e.g., which may be an indicator of the amount of light directed towards the solar cells of the motorized window treatment). For example, the control circuit may determine to dock the bottom bar if there is less light, for instance, to take advantage of instances where the solar cells are less likely to be missing out on collecting a relatively large amount of solar energy.

The procedure 1240 may start at 1241. At 1242, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1240 may end at 1246. In some examples, the determination of whether or not to dock at 1242 may be omitted.

If the control circuit determines that it is time to dock, the control circuit may measure the signal from the photosensor to determine the light level L_{DL} at 1243. For example, the photosensor may be oriented such that it faces towards the window, and as such, the light level L_{DL} may indicate the amount of light (e.g., sunlight) hitting the window (e.g., which may be an indicator of the amount of light directed towards the solar cells of the motorized window treatment). At 1244, the control circuit may determine whether the light level L_{DL} is greater than or equal to a threshold light level L_{TH}. If the control circuit determines that the light level L_{DL} is greater than or equal to the threshold light level L_{TH}, the procedure 1240 may end at 1246.

If the control circuit determines that the light level L_{DL} is less than the threshold light level L_{TH} at 1244, the control circuit may control the motor drive circuit to dock the bottom bar at 1245, before the procedure 1240 ends at 1246. For instance, the control circuit may control a motor drive circuit of the motor drive unit (e.g., the motor drive circuit 914) to dock the bottom bar (e.g., to adjust the present position P_{PRES} of the covering material to the docked position P_{DOCKED}) at 1245, before the procedure 1240 ends at 1246. As such, if the control circuit determines that the light level L_{DL} is less than the threshold light level L_{TH}, the control circuit may dock the bottom bar because the solar cells of the bottom bar are unlikely to receive solar energy (e.g., or significant solar energy) from the sun at that moment in time. Therefore, docking the bottom bar when the photosensor measures lower light levels will allow the bottom bar to dock when there is a lower likelihood or probability that the solar cells would be missing out on collecting a relatively large amount of solar energy.

FIG. 44F is a flowchart of an example procedure 1250 for determining when to dock a bottom bar (e.g., the bottom bars 155, 240, 340, 400, 500, 600) of a covering system, such as a motorized window treatment (e.g., the motorized window treatments of the embodiments shown in FIGS. 1-15). For example, the bottom bar may be connected to a bottom end of a covering material of the motorized window treatment. The procedure 1250 may be executed by a control circuit of a motor drive unit of the motorized window treatment (e.g., the control circuit 920 of the motor drive unit 910 shown in FIG. 41 and/or control circuits of the motor drive units shown in FIGS. 1-15). The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}).

During the procedure 1250, the control circuit may determine whether or not to dock the bottom bar based on whether it is nighttime and/or the space is vacant. The control circuit may determine it is nighttime based on a timeclock (e.g., nighttime may be defined by an hour range, such as between 9 pm and 5 am). The control circuit may determine the space is vacant based on feedback from one or more occupancy and/or vacancy sensors (e.g., directly or indirectly by way of a system controller). The control circuit may determine to dock the bottom bar if it is nighttime and the space is vacant, for instance, because nobody is in the space (e.g., it will cause less disruption to the user) and to take advantage of instances where the solar cells are less likely to be missing out on collecting a relatively large amount of solar energy.

The procedure 1250 may start at 1251. At 1252, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1250 may end at 1256. In some examples, the determination of whether or not to dock at 1252 may be omitted.

If the control circuit determines that it is time to dock, the control circuit may determine whether it is nighttime at 1253. For example, the control circuit may determine that it is nighttime based on a timeclock and/or based on a message received from a system controller. In some examples, the control circuit may determine that it is nighttime when it is within an hour range, such as between 9 pm and 5 am, and/or based on times of sunset and sunrise for the location of the motorized window treatment at the particular time of the year (e.g., when the timeclock is an astronomical timeclock). If the control circuit determines that it is not nighttime, the procedure 1250 may end at 1256.

If the control circuit determines that it is nighttime at 1253, the control circuit may determine whether the space is vacant at 1254. For example, the control circuit may receive an occupied command and/or a vacant command from an occupancy sensor (e.g., directly or indirectly, via a system controller). In some examples, the occupancy sensor may be located on the bottom bar. Alternatively or additionally, the control circuit may be configured to determine that the space is vacant based on data received from one or more calendar programs (e.g., no meeting is scheduled in the space at that time). If the control circuit determines that the space is not vacant, the procedure 1250 may end at 1256.

If the control circuit determines that the space is vacant at 1254, the control circuit may control the motor drive circuit to dock the bottom bar at 1255, before the procedure 1250 ends at 1256. For instance, the control circuit may control a motor drive circuit of the motor drive unit (e.g., the motor drive circuit 914) to dock the bottom bar (e.g., to adjust the present position P_{PRES} of the covering material to the docked position P_{DOCKED}) at 1255, before the procedure 1250 ends at 1256. As such, if the control circuit determines that it is nighttime and that the space is vacant, the control circuit may dock the bottom bar because the movement of the bottom bar will not bother the user (e.g., in the case of a commercial building) and the solar cells of the bottom bar are unlikely to be receiving solar energy (e.g., or significant solar energy) from the sun at that moment in time.

FIG. 44G is a flowchart of an example procedure 1260 for determining when to dock a bottom bar (e.g., the bottom bars 155, 240, 340, 400, 500, 600) of a covering system, such as a motorized window treatment (e.g., the motorized window treatments of the embodiments shown in FIGS. 1-15). For example, the bottom bar may be connected to a bottom end of a covering material of the motorized window treatment. The procedure 1260 may be executed by a control circuit of a motor drive unit of the motorized window treatment (e.g., the control circuit 920 of the motor drive unit 910 shown in FIG. 41 and/or control circuits of the motor drive units shown in FIGS. 1-15). The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}).

During the procedure 1260, the control circuit may determine whether or not to dock the bottom bar based on whether the motorized window treatment is in a privacy mode. The motorized window treatment may be configured to enter a privacy mode where, for example, the covering material will remain in the lowered position P_{LOWERED}. The privacy mode may be defined by a timeclock schedule (e.g., the privacy mode may be activated and deactivated based on the timeclock schedule). For example, the control circuit may determine that it is nighttime based on a timeclock and/or based on a message received from a system controller. For instance, the privacy mode may be defined by one or more time periods (e.g., a time period during the morning, such as between 6-8 am, and a time period at night, such as between 8-10 pm). In some examples, the time periods defined by the privacy mode may be based on sunrise and/or sunset times for the location of the motorized window treatment and at the particular time of the year (e.g., via an astronomical timeclock). When in the privacy mode, the control circuit of the motor drive unit may ensure that the covering material is in the lowered position P_{LOWERED} to ensure that the user has privacy. In some examples, during the privacy mode, the control circuit may disable certain docking movements and/or procedures to ensure that the covering material does not move from the lowered position P_{LOWERED} (e.g., unless a direct command from the user is received). The control circuit may determine not to dock the bottom bar if the motorized window treatment is in privacy mode to, for example, ensure that the covering material remains in the lowered position P_{LOWERED}.

The procedure 1260 may start at 1261. At 1262, the control circuit may determine whether it is time to dock the bottom bar of the motorized window treatment. For example, the control circuit may determine whether it is time to dock the bottom bar using one or more of the methods described herein, such as based on a timeclock, a docking window or interval, the charge of the energy storage elements of the motor drive unit and/or the bottom bar, etc. If the control circuit determines that it is not time to dock, the procedure 1260 may end at 1265. In some examples, the determination of whether or not to dock at 1262 may be omitted.

If the control circuit determines that it is time to dock, the control circuit may determine whether it is in privacy mode at 1263. The privacy mode may be defined by a timeclock schedule. For instance, the privacy mode may be defined by one or more time periods (e.g., a time period during the morning, such as between 6-8 am, and a time period at night, such as between 8-10 pm). In some examples, the time periods defined by the privacy mode may be based on sunrise and/or sunset times for the location of the motorized window treatment at the particular time of the year (e.g., via astronomical timeclock).

If the control circuit determines that it is not in privacy mode at 1263, the control circuit may control the motor drive circuit to dock the bottom bar at 1264, before the procedure 1260 ends at 1265. For instance, the control circuit may control a motor drive circuit of the motor drive unit (e.g., the motor drive circuit 914) to dock the bottom bar (e.g., to adjust the present position P_{PRES} of the covering material to the docked position P_{DOCKED}) at 1264, before the procedure 1260 ends at 1265. If the control circuit determines that it is in privacy mode at 1263, the procedure 1260 may end at 1265. As such, even though the control circuit determines that it is time to dock at 1262, the control circuit will not dock if the control circuit determines that it is in privacy mode at 1263.

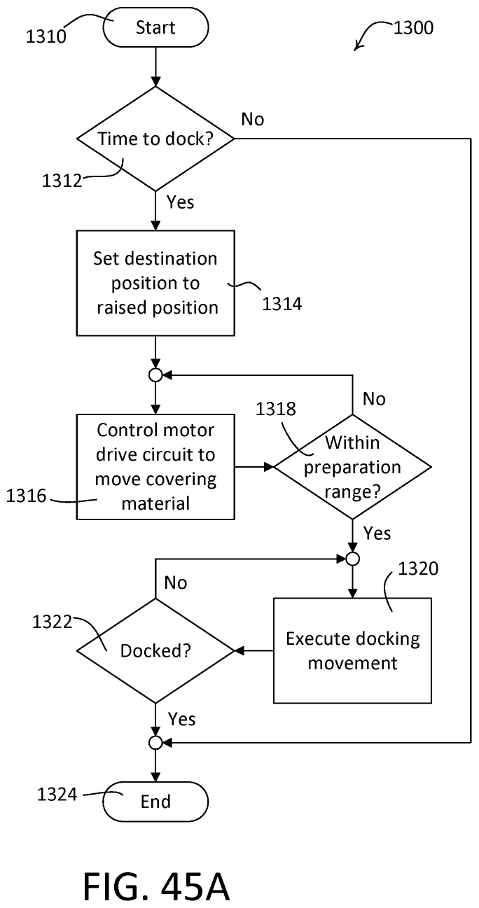

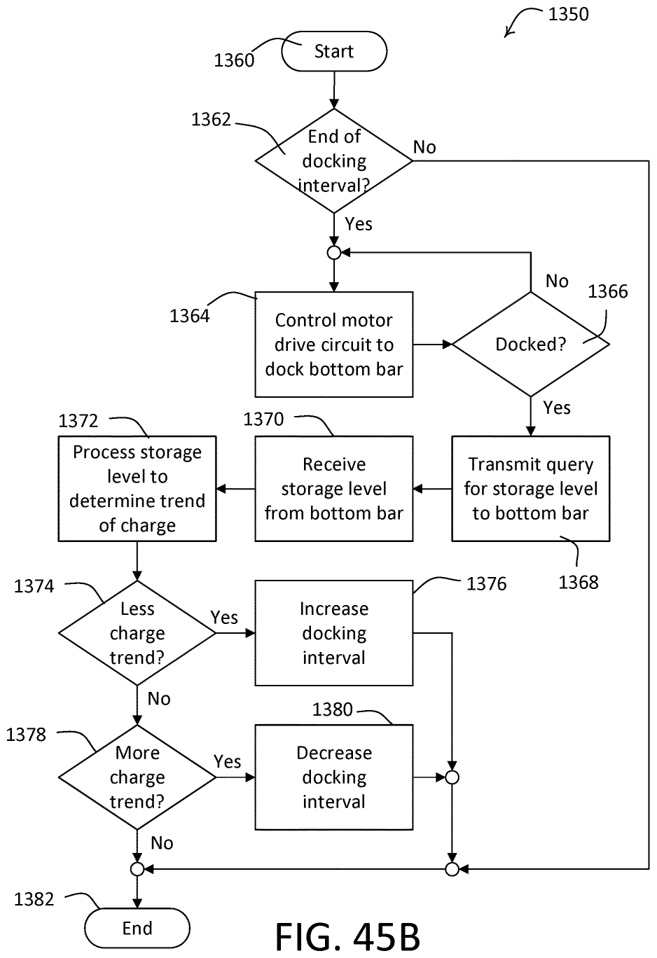

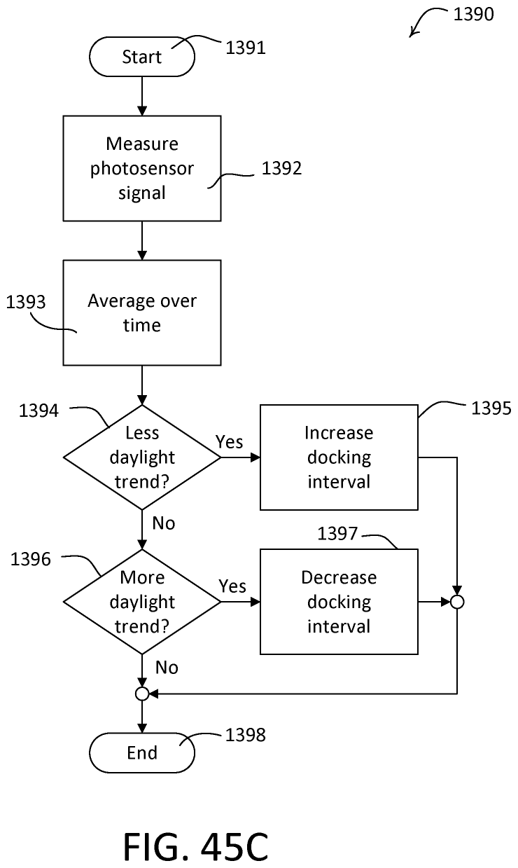

FIG. 45A is a flowchart of an example procedure 1300 for docking a bottom bar (e.g., the bottom bars 155, 240, 340, 400, 500, 600) of a covering system, such as a motorized window treatment (e.g., the motorized window treatments of the embodiments shown in FIGS. 1-15). For example, the bottom bar may be connected to a bottom end of a covering material of the motorized window treatment. The procedure 1300 may be executed by a control circuit of a motor drive unit of the motorized window treatment (e.g., the control circuit 920 of the motor drive unit 910 shown in FIG. 41 and/or control circuits of the motor drive units shown in FIGS. 1-15). The motor drive unit may be configured to control a present position P_{PRES} of the covering material. The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}). For example, the control circuit may execute the procedure 1300 periodically at 1310 to determine if the bottom bar should be docked (e.g., should control the present position P_{PRES} of the covering material to the docked position P_{DOCKED}).

At 1312, the control circuit of the motor drive unit may be configured to determine if the motor drive unit should presently dock the bottom bar. For example, the control circuit may be configured to determine that the bottom bar should be docked when the space in which the motorized window treatment is installed is vacant and the magnitude of a first storage voltage V_{S-A} produced across an energy storage element of the motor drive unit is less than a low-charge threshold V_{TH-LC}, and/or when the space is occupied and the magnitude of the first storage voltage V_{S-A} produced across the energy storage element of the motor drive unit is less than a critical-charge threshold V_{TH-CRIT} (e.g., as shown in FIG. 43). In addition, the control circuit may be configured to determine that the bottom bar should be docked when the magnitude of a second storage voltage V_{S-B} produced across an energy storage element of the bottom bar module is greater than a high-charge threshold V_{TH-HC} (e.g., as shown in FIG. 44A). Further, the control circuit of the motor drive unit may be configured to determine that the bottom bar should be docked in response to the present day of the week and/or the time of the day. When the control circuit determines that the motor drive unit should not presently dock the bottom bar at 1312, the procedure 1300 may end at 1324.

When the control circuit determines that the motor drive unit should presently dock the bottom bar at 1312, the control circuit may set a destination position P_{DEST} to the docked position P_{DOCKED} at 1314 and may control the motor drive circuit to rotate the motor to move the covering material at 1316. For example, the control circuit may be configured to generate at least one drive signal (e.g., the at least one drive signal V_{DR}) for controlling the motor drive circuit to control the rotational speed and the direction of rotation of the motor at 1316.

In some examples, even if the control circuit determines that the motor drive unit should dock the bottom bar at 1312, the control circuit may skip the docking event. For example, the control circuit may skip the docking event if the magnitude of the first storage voltage V_{S-A} produced across the energy storage element of the motor drive unit is above a charge threshold (e.g., the energy storage element of the motor drive unit has sufficient charge). Further, in some examples, even if the control circuit determines that the motor drive unit should dock the bottom bar at 1312, the control circuit may send a message (e.g., via email, text, an alert via a mobile app, etc.) to a user, and may wait to dock until a confirmation is received from the user that the motor drive unit should dock the bottom bar.

At 1318, the control circuit of the motor drive unit may determine if the present position P_{PRES} of the covering material is within a docking preparation range. For example, the docking preparation range may extend a predetermined distance from the docked position P_{DOCKED}. When the covering material is not within the docking preparation range at 1318, the control circuit may continue to control the motor drive circuit to rotate the motor to move the covering material at 1316. When the covering material is within the docking preparation range at 1318, the control circuit may control the motor through a docking movement (e.g., a docking sequence) at 1320. For example, the control circuit may ramp down the rotational speed at which the motor is rotating as the bottom bar nears the dock as part of the docking movement.

At 1322, the control circuit of the motor drive unit may determine if the bottom bar is docked. For example, the control circuit may be configured to determine if the bottom bar is docked by determining if electrical connections of the dock of the motor drive unit are electrically connected to the electrical connections of the bottom bar module at 1322. For example, the control circuit may be configured to determine that the bottom bar is docked by detecting that the second storage voltage V_{S-B} is present at the electrical connection of the dock (e.g., the electrical connections 938). When the control circuit determines that the bottom bar is not presently docked at 1322, the control circuit may continue to control the motor through the docking movement at 1320. When the control circuit determines that the bottom bar is presently docked at 1322, the procedure 1300 may end at 1324.

FIG. 45B is a flowchart of an example procedure 1350 for docking a bottom bar (e.g., the bottom bars 155, 240, 340, 400, 500, 600) of a covering system, such as a motorized window treatment (e.g., the motorized window treatments of the embodiments shown in FIGS. 1-15). For example, the bottom bar may be connected to a bottom end of a covering material of the motorized window treatment. The procedure 1350 may be executed by a control circuit of a motor drive unit of the motorized window treatment (e.g., the control circuit 920 of the motor drive unit 910 shown in FIG. 41 and/or control circuits of the motor drive units shown in FIGS. 1-15). The motor drive unit may be configured to control a present position P_{PRES} of the covering material. The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}). For example, the control circuit may execute the procedure 1350 periodically at 1360 to determine if a docking interval should be increased or decreased. The docking interval may indicate a scheduled time or interval of time at the conclusion of which the control circuit is configured to dock the bottom bar. In some examples, the docking interval may indicate the beginning of a docking window during which the window treatment may dock. The docking interval may be configured by the user and/or stored in memory of the motorized window treatment. The docking interval could be configured to end on a periodic basis, such as at a particular time every day (e.g., every night at 3:00 am). The procedure 1350 may be used in examples where there is no wireless communication between the motor drive unit and a hembar (e.g., the bottom bar) of the motorized window treatment, and docking is performed at a scheduled time (e.g., according to the docking interval). The procedure 1350 may be implemented to ensure that the energy storage elements of the bottom bar and/or of the motor drive unit do not overcharge (e.g., to extend the life of the energy storage elements).

At 1362, the control circuit of the motor drive unit may be configured to determine whether it is the end of the docking interval based on a timeclock (e.g., whether it is time for the control circuit to dock the bottom bar). In some examples, the control circuit may consider other factors when determining whether to dock the bottom bar (e.g., as described with reference to FIGS. 44A-44G). If the control circuit determines that it is not the end of the docking interval, the procedure may end at 1382. If the control circuit determines that it is the end of the docking interval, the control circuit may control the motor drive circuit of the motor drive unit (e.g., the motor drive circuit 914) to dock the bottom bar (e.g., to adjust the present position P_{PRES} of the covering material to the docked position P_{DOCKED}) at 1364.

At 1366, the control circuit of the motor drive unit may be configured to determine if the bottom bar is docked. When the control circuit determines that the bottom bar is not docked at 1366, the control circuit may continue to control the motor drive circuit to move the covering material towards the docked position P_{DOCKED} to dock the bottom bar at 1364. When the control circuit determines that the bottom bar is docked at 1366, the control circuit may transmit a query message at 1368 that includes a request for the magnitude of the second storage voltage Vs-B generated across the energy storage element of the bottom bar. The control circuit may transmit the query message via a wired communication link (e.g., via the electrical connections 938, 948 and/or via separate electrical connections on the dock). At 1370, the control circuit may receive the storage level of the energy storage element of the bottom bar (e.g., the magnitude of the second storage voltage V_{S-B}).

At 1372, the control circuit may process the storage level of the energy storage element of the bottom bar to determine a trend of any change in the storage level over time. For example, the control circuit may determine whether the storage level of the energy storage element of the bottom bar is greater than or less than the storage level the last time the bottom bar docked.

Further, the control circuit may be configured to determine whether a rolling average of the storage level of a predetermined number of previous storage level measurements is increasing or decreasing, for example, to determine whether the motor drive unit would benefit from more frequent or less frequent docking events.

At 1374, the control circuit may determine whether the determined trend of the storage level indicates that the motor drive unit would benefit from less frequent charging. As an example, the control circuit may determine that the trend indicates that the motor drive unit would benefit from less frequent charging when the trend indicates that the storage level is decreasing as compared to prior docking events (e.g., the trend is a “less charge” trend). Since the storage level is decreasing, the control circuit (e.g., the motor drive unit) is not receiving as much charge for each docking event as it could if it were to dock less frequently. As such, if the control circuit determines that the trend indicates that the motor drive unit would benefit from less frequent charging at 1374, the control circuit may increase the docking interval at 1376, and the procedure 1350 may end at 1382.

If the control circuit determines that the trend does not indicate that the motor drive unit would benefit from less frequent charging at 1374, the control circuit may determine whether the trend indicates that the motor drive unit would benefit from more frequent charging at 1378. As an example, the control circuit may determine that the trend indicates that the motor drive unit would benefit from more frequent charging when the trend indicates that the storage level is increasing as compared to prior docking events (e.g., the trend is a “more charge” trend). Since the energy storage element of the bottom bar has a limit charge capacity and since the storage level is increasing, the control circuit (e.g., the motor drive unit) could be receiving charge more often if the bottom bar were to dock more frequently. As such, if the control circuit determines that the trend indicates that the motor drive unit would benefit from more frequent charging at 1378, the control circuit may decrease the docking interval at 1380, and the procedure 1350 may end at 1382.

FIG. 45C is a flowchart of an example procedure 1390 for docking a bottom bar (e.g., the bottom bars 155, 240, 340, 400, 500, 600) of a covering system, such as a motorized window treatment (e.g., the motorized window treatments of the embodiments shown in FIGS. 1-15). For example, the bottom bar may be connected to a bottom end of a covering material of the motorized window treatment. The procedure 1390 may be executed by a control circuit of a motor drive unit of the motorized window treatment (e.g., the control circuit 920 of the motor drive unit 910 shown in FIG. 41 and/or control circuits of the motor drive units shown in FIGS. 1-15. The motor drive unit may be configured to control a present position P_{PRES} of the covering material. The motor drive unit may comprise a dock (e.g., the docks 280, 380) that is configured to facilitate discharging of one or more energy storage elements of the bottom bar into one or more energy storage elements of the motor drive unit, for example, when the bottom bar is located adjacent to the dock (e.g., when the covering material is in the docked position P_{DOCKED}). For example, the control circuit may execute the procedure 1390 periodically, at 1391, to determine if a docking interval should be increased or decreased. The docking interval may indicate a scheduled time or interval of time at the conclusion of which the control circuit is configured to dock the bottom bar (e.g., during the procedure 1210 of FIG. 44B and/or the procedure 1350 of FIG. 45B). The docking interval may be configured by the user and/or stored in memory of the motorized window treatment. The docking interval could be configured to end on a periodic basis, such as at a particular time every day (e.g., every night at 3:00 am). The procedure 1390 may be used in examples where there is no wireless communication between the motor drive unit and the bottom bar of the motorized window treatment, and docking is performed at a scheduled time (e.g., according to the docking interval).

At 1392, the control circuit may measure a photosensor signal. As described herein, the motor drive unit may include a photosensor circuit (e.g., the sensor circuit 954) coupled to the control circuit. For example, the photosensor circuit may be configured to generate a signal that indicates an ambient light level L_{AMB} in the space in which the motorized window treatment is located. The control circuit of the bottom bar module may be configured to transmit a message including the ambient light level L_{AMB} indicated by the sensor circuit to the motor drive unit (e.g., when docked). At 1393, the control circuit may be configured to determine an average amount of ambient light measured by the photosensor circuit. For example, the control circuit may determine an average, a rolling average, etc.

At 1394, the control circuit may determine whether the trend indicates that the bottom bar (e.g., the solar cells coupled to the bottom bar) is exposed to less sunlight over time. As an example, the control circuit may determine that the trend indicates that the bottom bar is exposed to more sunlight when the average of the ambient light measurement of the photosensor circuit is increasing with respect to time, and that the trend indicates that the bottom bar is exposed to less sunlight when the average of the ambient light measurement of the photosensor circuit is decreasing with respect to time. If the control circuit determines that the trend indicates that the bottom bar is exposed to less sunlight over time at 1394, the control circuit may increase the docking interval at 1395, and the procedure 1390 may end at 1398.

If the control circuit determines that the trend does not indicate that the bottom bar is exposed to less sunlight over time at 1394, the control circuit may determine whether the trend indicates that the bottom bar is exposed to more sunlight over time at 1396. If the control circuit determines that the trend indicates that the bottom bar is not exposed to more sunlight over time at 1396 (e.g., the trend has not changed), the procedure 1390 may end at 1398. If the control circuit determines that the trend indicates that the bottom bar is exposed to more sunlight over time at 1396, the control circuit may decrease the docking interval at 1397, and the procedure 1390 may end at 1398. Accordingly, the control circuit may determine that the trend indicates that the bottom bar would benefit from less frequent docking when the trend indicates that the bottom bar is exposed to less sunlight than before (e.g., the trend is a “less daylight” trend). In other words, because the solar cells of the bottom bar may be receiving less sunlight, the control circuit may control the bottom bar to dock less frequently. Conversely, the control circuit may determine that the trend indicates that the bottom bar would benefit from more frequent docking when the trend indicates that the bottom bar is exposed to more sunlight than before (e.g., the trend is a “more daylight” trend). In other words, because the solar cells of the bottom bar may be receiving more sunlight, the control circuit may control the bottom bar to dock more frequently.

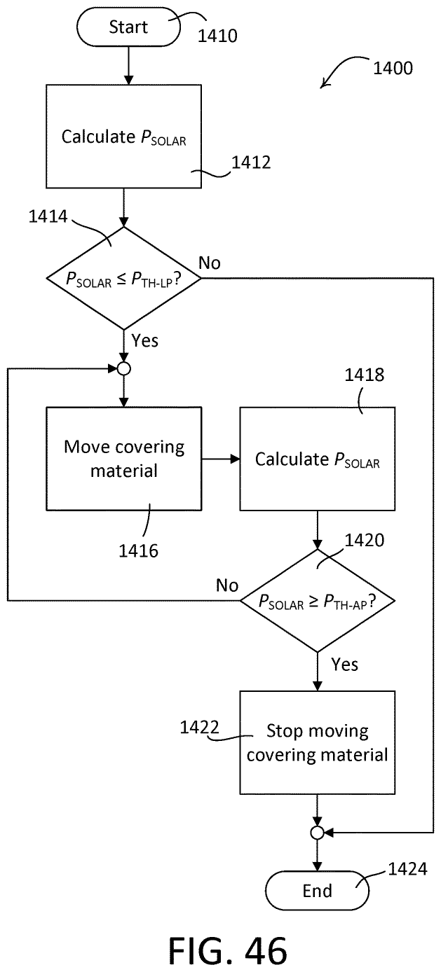

FIG. 46 is a flowchart of an example procedure 1400 for adjusting a present position P_{PRES} of a covering material of a covering system, such as a motorized window treatment (e.g., the motorized window treatments of the embodiments shown in FIGS. 1-15) in response to a solar power P_{SOLAR} being received by one or more solar cells (e.g., the solar cells 270, 370, 462, 562, 662, 942) of the motorized window treatment. For example, the solar cells may be located on a bottom bar (e.g., the bottom bar modules 405, 505, 605, 940) of the motorized window treatment, and the bottom bar may be connected to a bottom end of the covering material of the motorized window treatment. The bottom bar may comprise a bottom bar module having a solar cell management circuit configured to charge an energy storage element of the bottom bar (e.g., the energy storage element 946). The procedure 1400 may be executed by a control circuit of a motor drive unit of the motorized window treatment (e.g., the control circuit 920 of the motor drive unit 910 shown in FIG. 41 and/or control circuits of the motor drive units shown in FIGS. 1-15). For example, the control circuit may execute the procedure 1400 periodically at 1410 to monitor the solar power P_{SOLAR} being received by the one or more solar cells.

At 1412, the control circuit may be configured to calculate the solar power P_{SOLAR} being received by the one or more solar cells. For example, the control circuit may be configured to calculate the solar power P_{SOLAR} as a function of a magnitude of a photovoltaic output voltage V_{PV} of the one or more solar cells, a magnitude of a storage voltage of an energy storage element of the bottom bar (e.g., the second storage voltage V_{S-B}), and/or a duty cycle DC_{SCM} of the solar cell management circuit of the bottom bar (e.g., which may be received in one or more message from the bottom bar module). At 1414, the control circuit may be configured to determine if the magnitude of the solar power P_{SOLAR} is less than (e.g., less than or equal to) a low-power threshold P_{TH-LP}. When the magnitude of the solar power P_{SOLAR} is greater than the low-power threshold P_{TH-LP} at 1414, the procedure 1400 may end at 1424.

When the magnitude of the solar power P_{SOLAR} is less than (e.g., less than or equal to) the low-power threshold P_{TH-LP} at 1414, the control circuit may start moving the covering material at 1416 to adjust the present position P_{PRES} of the covering material. For example, the control circuit may be configured to adjust the present position P_{PRES} of the covering material in a direction (e.g., either raise or lower) that may move the bottom bar into direct sunlight, which may be determined from the solar data. At 1418, the control circuit may be configured to calculate the solar power P_{SOLAR} being received by the one or more solar cells at the new present position P_{PRES} of the covering material (e.g., an adjusted position of the covering material as compared to when the solar power P_{SOLAR} was calculated at 1412). At 1420, the control circuit may determine if the magnitude of the solar power P_{SOLAR} is greater than (e.g., greater than or equal to) an acceptable-power threshold P_{TH-AP}. When the magnitude of the solar power P_{SOLAR} is less than the acceptable-power threshold P_{TH-AP} at 1420, the control circuit may continue to move the covering material at 1416 to adjust the present position P_{PRES} of the covering material and to calculate the solar power P_{SOLAR} being received by the one or more solar cells at 1418. When the magnitude of the solar power P_{SOLAR} is greater than (e.g., greater than or equal to) the acceptable-power threshold P_{TH-AP} at 1420, the control circuit may stop moving the covering material at 1422 and the procedure 1400 may end at 1424.

While the motor drive unit (e.g., the motor drive unit 250, 350) having the dock (e.g., the docks 280, 380 shown in FIGS. 2-15) has been shown with the bottom bar having solar cells, the motor drive unit could also be used with motorized window treatments without solar cells in order to charge an energy storage element (e.g., the energy storage element 946) in the bottom bar (e.g., the bottom bar module 940), rather than charging an energy storage element (e.g., the energy storage element 930) in the motor drive unit from solar energy collected by one or more solar cells, for example, as described herein. In such a system, the bottom bar may not have any solar cells (e.g., the bottom bar module 940 may simply include the control circuit 950, the communication circuit 952, and/or the sensor circuit 954). For example, the motor drive unit may be configured to dock the bottom bar to charge the energy storage element of the bottom bar from the energy storage element of the motor drive unit. The control circuit 950 of the bottom bar module 940 may be configured to collect data from the sensor circuit 954 and report the data to the motor drive unit 910. For example, the control circuit 950 of the bottom bar module 940 may be configured to collect solar data from a photosensor of the sensor circuit 954 and report the solar data to the motor drive unit 910.

What is claimed is:

1. A covering system comprising:
a covering assembly comprising a covering material that extends from a top end to a bottom end, the covering assembly further comprising a bottom bar comprising a main housing element attached to the bottom end of the covering material and attached to a bottom bar module, wherein the bottom bar module is configured to be removably detached from the main housing element, the bottom bar module comprising one or more solar cells and one or more first energy storage elements configured to be charged from the one or more solar cells;
a motor drive unit comprising a motor configured to adjust the covering material;
one or more second energy storage elements for powering the motor; and
a dock comprising a base portion electrically coupled to the one or more second energy storage elements;
wherein the bottom bar is configured to be positioned adjacent to the base portion of the dock when the bottom bar is in a docked position, such that the one or more first energy storage elements can discharge through the base portion of the dock into the one or more second energy storage elements.

2. The covering system of claim 1, wherein the bottom bar module further comprises a support element to support the one or more solar cells and the one or more first energy storage elements.

3. The covering system of claim 2, wherein the bottom bar module further comprises a printed circuit board assembly comprising a printed circuit board that is supported by the support element, and wherein the one or more solar cells are electrically coupled to the printed circuit board via two or more first electrical conductors, and the one or more first energy storage elements are electrically coupled to the printed circuit board via two or more second electrical conductors.

4. The covering system of claim 3, wherein the bottom bar module comprises at least one solar cell module comprising at least a portion of the one or more solar cells mounted to a respective substrate, and wherein the support element of the bottom bar module comprises a recess in which the at least one solar cell module and the printed circuit board are received.

5. The covering system of claim 4, wherein the support element of the bottom bar module comprises an upper rear wall above the recess and a lower rear wall below the recess, the support element further comprising an upper flange extending from the upper rear wall into the recess and a lower flange extending from the lower rear wall into the recess, the upper and lower flanges retain the at least one solar cell module within the recess, and wherein the support element of the bottom bar module defines a gap between the upper and lower flanges, and wherein the one or more solar cells are located within the gap between the upper and lower flanges.

6. (canceled)

7. The covering system of claim 5, wherein the recess extends from a first end to a second end of the support element, the support element further comprising one or more ribs extending along a rear wall of the recess from the first end to the second end of the support element, the one or more ribs defining grooves within the recess for receiving the two or more first electrical conductors connected between the one or more solar cells and the printed circuit board, and wherein the one or more ribs allow the support element to flex for widening the gap to allow the at least one solar cell module to be removed from the recess through the gap.

8. (canceled)

9. The covering system of claim 4, wherein the support element comprises a cavity that is oriented parallel to the recess and receives the one or more first energy storage elements.

10. The covering system of claim 3, wherein the printed circuit board assembly comprises two or more first electrical contacts that are arranged on the printed circuit board and are configured to be electrically connected to respective second electrical contacts of the dock when the bottom bar is in the docked position, and wherein the printed circuit board assembly comprises a charging circuit mounted to the printed circuit board and electrically coupled between the two or more first electrical contacts and the one or more first energy storage elements.

11. (canceled)

12. The covering system of claim 3, wherein the printed circuit board assembly comprises a solar cell management circuit mounted to the printed circuit board and electrically coupled between the one or more solar cells and the one or more first energy storage elements, the solar cell management circuit configured to charge the one or more first energy storage elements from the one or more solar cells.

13. The covering system of claim 3, wherein the main housing element comprises a first housing portion attached to the covering material, wherein the support element comprises a second housing portion, and wherein the second housing portion is attached to the first housing portion.

14. The covering system of claim 13, further comprising first and second covers for housing the printed circuit board, wherein the first cover is received in a recess of the second housing portion, and the second cover is coupled to the second housing portion with the printed circuit board captured between the first and second covers.

15. (canceled)

16. The covering system of claim 14, wherein the second housing portion comprises first and second attachment members that extend from the second housing portion and that have first and second channels, respectively, and the second cover is received in the first and second channels of the respective first and second attachment members.

17. The covering system of claim 16, wherein the second cover comprises a first projection that extends from an upper wall of the second cover and is received in the first channel of the first attachment member and a second projection that extends from a lower wall of the second cover and is received in the second channel of the second attachment member; and
wherein the second housing portion comprises an interior wall within the recess, and wherein the interior wall defines one or more cutouts through which electrical conductors between at least one solar cell module and the printed circuit board extend, wherein the at least one solar cell module comprises the one or more solar cells.

18. (canceled)

19. The covering system of claim 17, wherein the second cover is secured to the first cover via a fastener received through an opening in the second cover, an opening in the printed circuit board, and an opening in the first cover, the fastener also extending through at least one of the cutouts in the interior wall of the second housing portion.

20. The covering system of claim 17, wherein the printed circuit board assembly comprises two or more electrical contacts arranged on an outer surface of the printed circuit board, the electrical contacts comprising respective arms that extend through respective openings in the first cover, the electrical contacts also extending through at least one of the cutouts in the interior wall of the second housing portion.

21. The covering system of claim 16, wherein the second attachment member comprises a support arm that contacts an inner surface of the printed circuit board.

22. The covering system of claim 16, wherein the first and second attachment members engage with the first housing portion for coupling the second housing portion to the first housing portion.

23. The covering system of claim 14, wherein the first cover comprises one or more ribs that contact an outer surface of the printed circuit board, and the second cover comprises one or more ribs that contact an inner surface of the printed circuit board.

24. The covering system of claim 13, wherein the bottom bar module comprises a third housing portion attached to the first housing portion.

25. (canceled)

26. The covering system of claim 24, further comprising:
a first end cap connected to a first end of the bottom bar; and
a second end cap connected to a second end of the bottom bar;
wherein the third housing portion is located between the first end cap and the second housing portion, and wherein the printed circuit board of the printed circuit board assembly is supported by the third housing portion.

27. The covering system of claim 13, wherein the second housing portion comprises a releasable attachment structure that is configured to detach the second housing portion from the first housing portion when actuated.

28. The covering system of claim 27, wherein the second housing portion comprises a catch that is located at an upper end of the second housing portion and that attaches to a lip at an upper end of the first housing portion, and wherein the releasable attachment structure is located at a lower end of the second housing portion; and
wherein the releasable attachment structure comprises a clip attached to a lower rear wall of the second housing portion, wherein the clip engages an indentation of the first housing portion to attach the second housing portion to the first housing portion.

29. (canceled)

30. The covering system of claim 28, wherein the clip comprises a wedge portion received in the indentation of the first housing portion when the second housing portion is attached to the first housing portion, the clip further comprising an actuation portion configured to, when actuated by a user, cause the lower rear wall of the second housing portion to flex and the wedge portion of the clip to be removed from the indentation of the first housing portion, such that the second housing portion is detached from the first housing portion; and
wherein the lip of the first housing portion is a rear lip, the first housing portion further comprising a front lip and a slot, wherein the slot receives the covering material, and wherein the front and rear lips are located on both sides of the slot.

31. (canceled)

32. The covering system of claim 27, wherein the releasable attachment structure comprises first and second attachment members that extend from the second housing portion and engage with the first housing portion for coupling the second housing portion to the first housing portion.

33. The covering system of claim 32, wherein the first attachment member comprises a spring arm received in and engage with a first channel of the first housing portion, and wherein the second attachment member comprises an engagement portion received in and engage with a second channel of the first housing portion for attaching the second housing portion to the first housing portion; and
wherein the second housing portion further comprises an actuation portion configured to, when actuated by a user, cause the spring arm of the first attachment member of the second housing portion to flex and the engagement portion of the second attachment member to be removed from the second channel of the first housing portion, such that the second housing portion is detached from the first housing portion.

34. (canceled)

35. The covering system of claim 2, wherein the support element of the bottom bar module comprises a releasable attachment structure that is configured to detach the support element from the main housing element when actuated; and
wherein the support element of the bottom bar module comprises a catch that is located at an upper end of the support element and that attaches to a lip at an upper end of the main housing element, and wherein the releasable attachment structure is located at a lower end of the support element.

36. (canceled)

37. The covering system of claim 35, wherein the releasable attachment structure comprises a clip attached to a lower rear wall of the support element of the bottom bar module, wherein the clip engages an indentation of the main housing element to attach the support element to the main housing element; and
wherein the clip comprises a wedge portion received in the indentation of the main housing element when the support element is attached to the main housing element, the clip further comprising an actuation portion configured to, when actuated by a user, cause the lower rear wall of the support element to flex and the wedge portion of the clip to be removed from the indentation of the main housing element, such that the support element detaches from the main housing element.

38. (canceled)

39. The covering system of claim 35, wherein the lip of the main housing element is a rear lip, the main housing element further comprising a front lip and a slot, wherein the slot receives the covering material, and wherein the front and rear lips are located on both sides of the slot.

40. The covering system of claim 2, wherein the main housing element comprises a first housing portion of the bottom bar and the support element comprises a second housing portion of the bottom bar, and wherein the first housing portion is attached to the second housing portion to form a housing of the bottom bar.

41. The covering system of claim 2, wherein the one or more solar cells are supported by the support element of the bottom bar module such that the one or more solar cells are oriented at an angle from a vertical axis of the covering system.

42. The covering system of claim 1, wherein the covering assembly further comprises a roller tube that extends from a first end to a second end, the roller tube rotatably supported by a first mounting bracket at the first end of the roller tube and by a second mounting bracket at the second end of the roller tube;
wherein the top end of the covering material is attached to the roller tube and the bottom end of the covering material is attached to the bottom bar; and
wherein the motor drive unit is received in the roller tube at the second end of the roller tube and is supported by the first mounting bracket, the motor drive unit configured to rotate the roller tube to adjust the covering material.

43. The covering system of claim 1, wherein, when the bottom bar module is detached from the main housing element, the main housing element remains attached to the covering material.

44. The covering system of claim 1, wherein the bottom bar module further comprises a printed circuit board assembly comprising a printed circuit board, and wherein the printed circuit board assembly comprises two or more first electrical contacts that are arranged on the printed circuit board and are configured to be electrically connected to respective second electrical contacts of the dock when the bottom bar is in the docked position.

45. (canceled)

46. The covering system of claim 44, wherein the two or more first electrical contacts are accessible at an exterior surface of the bottom bar.

47. The covering system of claim 44, wherein the two or more first electrical contacts are plates.

48. The covering system of claim 47, wherein the two or more first electrical contacts are arranged in recesses formed in a surface of the bottom bar.

49. The covering system of claim 48, wherein the two or more first electrical contacts each comprise a respective pin that extends through the bottom bar, and wherein the respective pin of each of the two or more first electrical contacts extends through a respective recess in the cover and into a respective opening in the printed circuit board when the two or more first electrical contacts are received in the recesses in the surface of the bottom bar.

50.-242. (canceled)
